(19) United States
(12) Patent Application Publication
(10) Pub. No.: US 2011/0028339 A1
(43) Pub. Date: Feb. 3, 2011

(54) METHODS AND COMPOSITIONS RELATED TO MICROSCALE SAMPLE PROCESSING AND EVALUATION

(76) Inventors: Richard Jones, Chicago, IL (US); Mark Ciaccio, Chicago, IL (US)

Correspondence Address: FULBRIGHT & JAWORSKI L.L.P., 600 CONGRESS AVE., SUITE 2400, AUSTIN, TX, 78701, US

(21) Appl. No.: 12/745,407

(22) PCT Filed: Dec. 1, 2008
(86) PCT No.: PCT/US08/85198

§ 371 Date: Oct. 6, 2010

Related U.S. Application Data
(60) Provisional application No. 60/991,563, filed on Nov. 30, 2007.

(51) Int. Cl. C40B 30/04; C40B 40/10

(52) U.S. Cl. 506/9; 506/18

(57) ABSTRACT

Embodiments of the invention include gels and blots comprising electrophoretically separated samples amenable to scanning at 20 micron resolution and methods of using such compositions.

This application claims priority to U.S. Provisional Patent Ser. No. 60/991,563 filed Dec. 3, 2007, which is incorporated herein by reference in its entirety.

### BACKGROUND OF THE INVENTION

I. Field of the Invention

Embodiments of the present invention relate generally to the fields of biochemistry and immunology. In certain aspects the invention relates to a highly sensitive and selective microblot compositions and methods, in certain aspects microwestern blots.

II. BACKGROUND

Because proteins comprise the majority of the cellular wiring apparatus, knowledge of cell state-specific protein abundance and activation state is of critical importance in building models of the cellular networks that underlie higher-order biological processes. Unfortunately very few economical and scalable methods exist that can provide a quantitative, unbiased readout of the abundance, modification state, and interaction potential of hundreds of proteins in a cell. This is an especially important obstacle in defining the nodes and edges of dynamic signaling networks responsible for human diseases like cancer, diabetes, etc. While cell signaling through canonical signaling pathways like phospholipase C gamma and the phospho-inositide kinase (PI3) generally are not described in a cell specific manner, the timing of kinase substrate phospho-relay and phospho-recognition is likely to be very dependent on the specific cellular architecture and cadre of signaling modules present in a given cell under a given condition. Each tissue and cellular subtype is therefore likely to utilize distinct network tuning parameters in order to carry out its normal function.

Several techniques have been employed to analyze the abundance and post-translational modification state of proteins in complex mixtures: each with their strengths and weaknesses. Mass spectrometry (MS) is extremely powerful at identifying proteins and more recently in identifying post-translational modifications in complex mixtures following enrichment of phosphopeptide fractions. However, MS requires access to a sophisticated instrument and relatively large amounts of cells and total protein per experiment. Because the mass spectrometry approach relies on enrichment methodologies prior to performing an analysis and because even a fast-scanning instrument is only able to collect sequence-based information on a small proportion of eluting peptides in a given time, many low-abundance proteins are missed from run-to-run.

The western blotting approach is the standard work-horse approach for examining the changes in abundance and post-translational modification of cellular proteins (Burnette, 1981). The power of the western blot approach lies in the unparalleled ability of an antibody to specifically recognize a particular antigen of interest in the presence of thousands of other antigens. Unfortunately the western blotting approach requires a relatively large amount of lysate and antibody for each experiment as well as a substantial input of skilled human intervention. Recently, several approaches have attempted to leverage the reagent savings and multiplexing capabilities of microarrays with the power of the western blot.

Protein microarrays are measurement devices used in biomedical applications to determine the presence and/or amount of proteins in biological samples. They have the potential to be an important tool for biomedical research. Usually a multitude of different capture agents, most frequently monoclonal antibodies, are deposited on a chip surface (glass or silicon) in a miniature array. This format is often referred to as a microarray. A protein microarray can be a piece of glass on which different protein molecules have been affixed at separate locations in an ordered manner thus forming a microscopic array. These are used to identify protein-protein interactions, to identify the substrates of protein kinases, or to identify the targets of biologically active small molecules. The lysate proteins are labeled or a secondary antibody is then added in order to quantify the abundance or post-translational modification of the captured protein. The weakness of the approach is that a very low percentage of antibodies are able to immuno-precipitate 100% of a protein from a complex mixture (Nielsen, 2003).

Tissue microarrays (also TMAs) consist of paraffin blocks having tissue cores assembled in an array to allow simultaneous histological analysis. The major limitations in molecular clinical analysis of tissues include the cumbersome nature of procedures, limited availability of diagnostic reagents and limited patient sample size. Multi-tissue blocks were first introduced by Battifora in 1986 with his so called “multitumor (sausage) tissue block” and modified in 1990 with its improvement, “the checkerboard tissue block”. In 1998 Kononen and collaborators developed a technique that uses a sampling approach that produce tissues of regular size and shape that can be more densely and precisely arrayed.

Reverse phase lysate arrays have been described by Liotta and colleagues (Paweletz, 2001) and relies on the immobilization of cell lysates directly onto the surface of nitrocellulose coated glass slides. Proteins contained in the lysate are then detected with pan or modification-specific antibodies in an analogous manner to a western blot. Unfortunately, as was pointed out more recently by MacBeath and colleagues, very few antibodies have the ability to recognize a single epitope from a complex lysate mixture (Sevecka, 2006). Chong et al. described a non-porous reverse phase method that would allow for the separation of complex lysates (Chong, 1999) but the chromatographic method has not proved to be sufficiently parallel or scalable to leverage the multiplexing capability of the microarray approach.

Presently, most macroscopic systems analyze gene expression, and especially differential gene expression. However, systems for the macroscopic analysis of gene products, proteins, or poly-peptides, are less developed. The need exists for additional compositions and methods for analyzing complex protein mixtures and the post-translational modification of proteins in such mixtures.

### SUMMARY OF THE INVENTION

In general, the cellular signaling networks responsible for disease, e.g., cancer, are complex and our understanding of them would benefit from a systems-level examination of the abundance and modification state of the protein components that comprise the machinery for signal relay or the expression levels of mRNA encoding protein components distinct to a particular state or organism. Unfortunately, the highly-parallel DNA sequencing and microarray technologies that have allowed for the systematic description of gene expression at the mRNA level have not translated into a comprehensive understanding of the protein machines that ultimately carry out cellular functions. Herein, methods and compositions are described that provide, but are not limited to one or more of the following attributes: (1) small sample and antibody requirements and (2) scalable and amenable to robotic automation and multiplexing. Expression and post-translational modifications of signaling proteins can be probed on a single support yielding quantitative expressional data on distinct proteins and the phosphorylation levels of unique modification sites.

Embodiments of the invention include compositions and methods related to a microwestern or microsouthem or micronorthern or other microblot that provides a scalable way to separate cell lysates or other samples (e.g., protein, nucleic acid, or other charged biological molecules) following spotting and prior to probing with affinity agents, such as aptamers, pan-specific antibodies, phospho-specific antibodies or other binding moieties that bind specifically or selectively to peptide, polypeptide, carbohydrate, lipid, phospholipid and/or other components of a cell, thus allowing for the ability to monitor the abundance, activity, and/or modification of component of a sample.

Embodiments of the invention allow for the separation of complex cell lysates or other samples following microarray deposition on the surface of a gel or other electrophoretic medium. In certain aspects, a gel is cast on a gel backing or includes a gel support. Following transfer of cell lysates from the gel to a blotting substrate or membrane, such as nitrocellulose or PVDF membrane, and following the addition of a microtiter gasket that separates the separated lysates into different sample wells (See U.S. Patent Publication 20080118983 as an example of separation apparatus, which is incorporated in its entirety herein by reference), the proteins are detected with antibodies conjugated to a detectable marker/reporter, such as infrared dye molecules, and scanned. In certain aspects the blots are scanned using an infrared imaging scanner. The invention thus may allow for the use of at least or about a 100, 200, 500, 1000 or more fold less lysate, including all values and ranges there between, and a 50, 100, 200 or more fold less antibody, including all values and ranges there between, as compared to traditional blotting or western blotting. Additionally, the microtiter spacing allows for the invention to be compatible with liquid handling robots used in industry. In certain embodiments, the methods and compositions can be used for screening antibodies and evaluating the specificity and sensitivity of antibodies as well as evaluation of various signaling networks or pathways, and/or physiologic or biologic states. These methods and compositions may be used in a format that provides a more rapid and/or comprehensive interrogation method.

Embodiments of the invention include a microwestern blot comprising at least one protein sample “electrophoretically resolved” to a resolution of 1, 2, 3, 4, 5, 6, 7, 8, 9, 10 or more kDa per 50, 100, 200, 300, 400 μm or less including all values and ranges there between. “Electrophoretic resolution” is the process in which sample components are separated based partly on charge by exposure to an electric current. The electrophoretically resolved sample forms a sample lane that is a column of resolved proteins along the direction of migration. One or more sample lanes can be grouped to form a sample block. In certain aspects, a second sample lane or block can be positioned below a first sample lane or block, i.e. forming a two row column of sample lanes or blocks. Two or more sample lanes may be positioned beside (parallel to) each other forming a first sample row. The microwestern blot can comprises at least, at most or about 1, 2, 3, 4, 5, 6, 7, 8, 9, 10, 11, 12, 13, 14, 15, 16, 17, 18, 19, 20, 25, 30, 35, 40, 45, 50, 100, 150, 200, 300, 400, 500, 1,000, 10,000 or more protein samples, including all values and ranges there between. In a further aspect, two or more protein samples are grouped in a sample block. A sample block can be replicated at least 1, 2, 3, 4, 5, 6, 7, 8, 9, 10, 11, 12, 13, 14, 15, 16, 17, 18, 19, 20, 24, 48, 50, 96, 100 or more times, including all values and ranges there between.

The samples can be arranged perpendicular to the electrophoretic direction at a density of 1, 2, 3, 4, 5, 6, 7, 8, 9, 10, 11, 12, 13, 14, 15, 16, 17, 18, 19, 20 or protein samples per centimeter, including all ranges there between. The protein samples can further comprise one or more rows of protein samples (at least a second row) electrophoretically resolved above or below the first sample row substantially perpendicular to the direction of electrophoresis. Samples can be grouped in sets of samples that reflect particular comparisons to be made between samples of interest.

In certain embodiments, the protein samples comprise proteins from cancer cell lysates. In a further embodiment, the cancer cells are a cancer cell line or from a clinical sample. The cells may have also been treated or exposed to a drug or condition.

In other aspects, a device can be used to divide the microwestern blot into discrete wells. A device includes any gasket or other device that fluidically isolates one or more samples on a substrate. In certain aspects, one well is formed around at least one protein sample. In a further aspect, the gasket forms at least 2, 8, 12, 24, 48, 96, or more wells, including all values and ranges there between.

In still further aspects, a substrate, such as a gel or blot, can comprise at least a first protein sample forming a first sample row and second protein sample forming a second sample row, wherein the first sample row and second sample row are stacked substantially parallel to each other.

In certain aspects, sample components are operably coupled to or associated with a substrate. The substrate can be a gel, a surface or a membrane. In a further aspect, the substrate is an electrophoretic gel, e.g., a polyacrylamide gel.

In certain aspects, a sample can be replicated at least 12, 24, 48, or 96 times, including all values and ranges there between.

In still further aspects, an electrophoretic gel can comprise at least, at most, or about 1, 2, 3, 4, 5, 6, 7, 8, 9, 10, 50, 100, 200, 500, 1,000, 10,000 or more protein samples, including all values and ranges there between electrophoretically separated in a first direction at a resolution of at least, at most, or about 1, 2, 3, 4, 5, 10 kDa or more per 10, 50, 100, 200, 300, 400 μm or more, including all values and ranges there between. That is, a component of the specified molecular weight will be at least a certain distance from a component differing by a designated molecular weight. For example, two components differing in 5 kDa will be at least or at most 200 μm apart and can be detected individually.

In other aspects, an electrophoretic gel comprises at least two protein samples electrophoretically separated in a first direction and positioned substantially aligned in the direction of electrophoresis forming two rows of samples.

In certain embodiments, methods include evaluating a sample comprising the steps of: (a) obtaining a substrate having at least one sample electrophoretically resolved to a resolution of 5 kDa per 200 μm forming a sample lane; (b) dividing the substrate into discrete wells; (c) contacting a portion of the substrate defined by a well with a binding moiety of interest; and (d) analyzing the binding of the moiety to the sample. In certain aspects the binding moiety is an antibody. In still further aspects, analyzing comprises laser scanning of the sample lane. Detection methods, such as laser scanning, can be conducted at least, at most or at a resolution of 1, 5, 10, 20, 50, 100 μm, including all values and ranges there between. The methods may further comprise selecting one or more binding moieties having an appropriate binding profile or specificity.

In yet further aspects, a method can include preparing a gel by spotting droplets of sample comprising the steps of (a) obtaining a sample; (b) spotting at least, at most or about 300 pL of the sample on a separation medium; and (c) separating the components of the sample in a first direction to a resolution of at least 5 kDa per 200 μm forming the microgel. The method may further comprise transferring the separated sample to a second substrate producing a microwestern blot. Spotting is typically performed at 60, 70, 80, 90, or 95% humidity, including all values and ranges there between. Spotting may also include applying 1, 2, 3, 4, 5, 6, 7, 8, 9, 10, 11, 12, 13, 14, 15, 16, 17, 18, 19 to 20 droplets of sample at each location on the separation medium. Spotting may be repeated 2, 3, 4, 5, 6, 7, 8, 9 or more times.

In still further aspects, a sample array prepared using a process comprising the steps of: (a) obtaining at least two samples; (b) spotting the samples on a separation medium in increments of about 300 pL in parallel rows; (c) separating the sample in a direction substantially perpendicular to the rows (an electrophoretic direction) in certain aspects the separation will at a resolution of at least or at most 5 kDa per 200 μm; and (d) transferring the separated protein to a second substrate producing a microwestern blot.

Certain embodiments include a microarray comprising a horizontal and/or a vertical arrangement of sample blocks, each block comprising at least one sample lane, wherein the sample lane contains sample components electrophoretically separated at a resolution of at least or at most 5 kDa per 200 μm.

Other embodiments include methods of assessing or characterizing a sample or a binding moiety using the compositions and methods of the invention. Also contemplated are kits comprising one or more of the components needed to prepare or use the gels or blots of the invention.

In other embodiments the sample can comprise target molecules other than proteins, such as nucleic acid, polysaccharides and the like. An electrophoretic gel can comprise at least, at most, or about 1, 2, 3, 4, 5, 6, 7, 8, 9, 10, 50, 100, 200, 500, 1,000, 10,000 or more nucleic acid or similar samples, including all values and ranges there between electrophoretically separated in a first direction at a resolution of at least, at most, or about 10, 20, 30, 40, 50, 100 by or more per 10, 50, 100, 200, 300, 400 μm or more, including all values and ranges there between. That is, a component of the specified molecular weight will be at least a certain distance from a component differing by a designated molecular weight. For example, two components differing by 50 by will be at least or at most 200 μm apart and can be detected individually.

Other embodiments of the invention are discussed throughout this application. Any embodiment discussed with respect to one aspect of the invention applies to other aspects of the invention as well and vice versa. The embodiments in the Example section are understood to be embodiments of the invention that are applicable to all aspects of the invention.

The use of the word “a” or “an” when used in conjunction with the term “comprising” in the claims and/or the specification may mean “one,” but it is also consistent with the meaning of “one or more,” “at least one,” and “one or more than one.”

It is contemplated that any embodiment discussed herein can be implemented with respect to any method or composition of the invention, and vice versa. Furthermore, compositions and kits of the invention can be used to achieve methods of the invention.

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 Microwestern Array (MWA) procedure. (FIG. 1A) A431 Skin Carcinoma cells were stimulated with Epidermal Growth Factor (2 ng/mL, 50 ng/mL, 100 ng/mL, and 200 ng/mL) and lysed at 0, 1, 5, 15, 30, and 60 min after stimulation. (FIG. 1B) Six lysates and the Licor Odyssey protein marker were transferred using an automated transfer file from a 384 well plate using a GeSim Nanoplotter 2.1 Non-Contact Arrayer on to an acrylamide gel, repeating the same seven samples 96 times across the area of the gel. The samples are printed along the top edge of a 9 mm by 9 mm block repeated in an 8 by 12 block configuration identical to that of a standard 96-well microtiter plate (FIG. 1C) The acrylamide gel underwent semi-dry electrophoresis until the loading dye from each spot of protein marker migrated 9 mm to the edge of the next line of printed samples. The protein samples were then transferred from the acrylamide on to a nitrocellulose membrane using a Biorad Criterion transfer apparatus. (FIG. 1D) The nitrocellulose was clamped within a 96-well gasketing device so that each block of samples was isolated in a single 9 sq mm chamber. 96 distinct antibodies were then added to each chamber. Secondary antibody tagged with a fluorescent conjugate was subsequently added to each chamber and the membrane scanned using a Licor Odyssey dual-color imager.

FIGS. 2A-2E MWA Validation. (FIG. 2A) 5 uL of a series of 1/2 Dilutions of Licor Protein Marker were run using traditional 10% SDS-PAGE. 60 mL of the identical samples were run in the microwestern format for comparison. The difference in scale is noted below the figure. (FIG. 2B) The median net signal intensity was quantified for three bands (150 kd, 50 kD, and 25 kD) of the Licor Protein Marker in the traditional Western Blot as shown in part A. The intensity vs. concentration of proteins shows a linear relationship for all protein bands quantified. (FIG. 2C) The median net signal intensities as quantified from microwestern dilution series. The intensity vs. concentration shows a similar linear relationship as that from the traditional western. (FIG. 2D) A comparison of three traditional western blots compared to the identical samples run in microwestern format. Samples are of A431 cells stimulated with EGF (200 ng/mL) and lysed at 0, 1, 5, 15, 30, and 60 minutes after stimulation and probed with anti-tubulin (top), anti-p-EGFR(Y1086) (middle), or p-Stat6(Y641) (bottom) primary antibodies. (FIG. 2E) A complete scan of nitrocellulose membrane showing the 96-block format of the Microwestern Array. The red channel shows the stimulation of A431 cells probed with a panel of rabbit anti-human polyclonal antibodies. (FIG. 2F) The green channel reflects a scan of the samples probed with mouse monoclonal anti-human β-actin antibody showing the consistency of printing across the area of the membrane.

FIGS. 3A-3B (FIG. 3A) A general illustration of 2-D representation of fold change of phophosite antibody binding as a function of time after EGF stimulation. (FIG. 3B) 2D representation of phosphosites dynamics illustrate the Fold Change of antibody binding (y-axis) as a function of time (x-axis).

FIGS. 4A-4B (FIG. 4A) A general illustration of a 3D topology of phosphosites dynamics. 3D graphs demonstrate the Fold Change of quantified antibody bands (z-axis) as a function of time (x-axis) and EGF concentration (y-axis). (FIG. 4B) 3-D topology of Fold Change of phosphorylation and abundance of proteins as measured by the Microwestern Array. Time after stimulation is shown on the x-axis, concentration of EGF stimulation is on the y-axis, and fold change is shown on the z-axis. All fold changes are set to zero at time of stimulation.

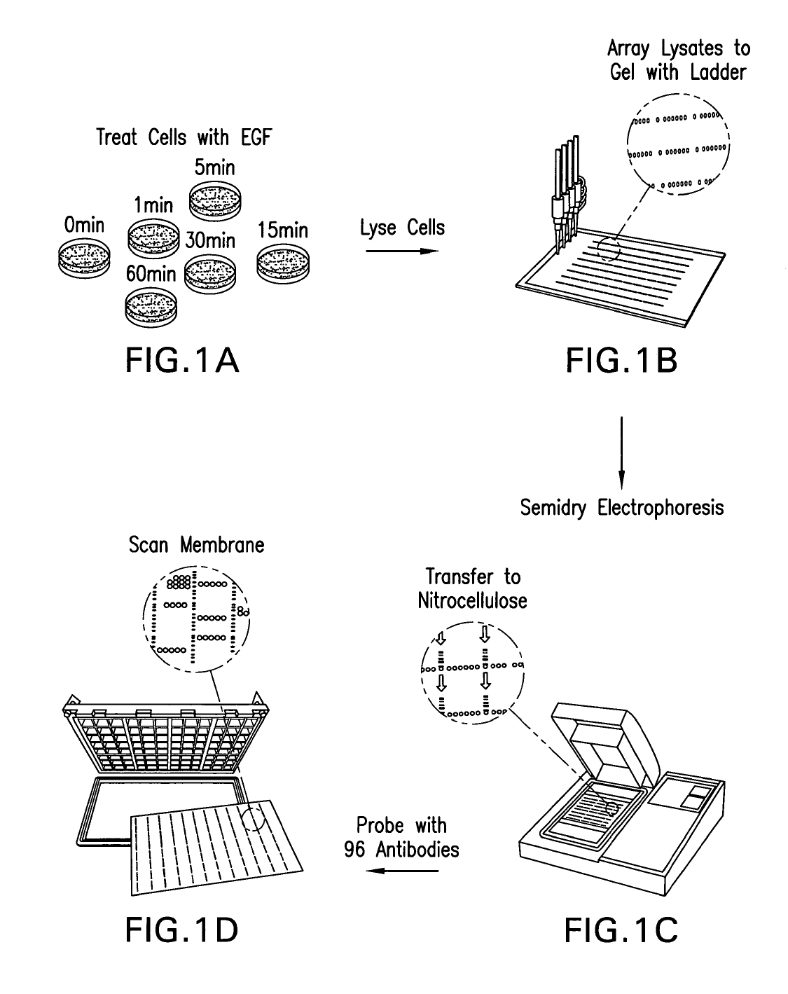

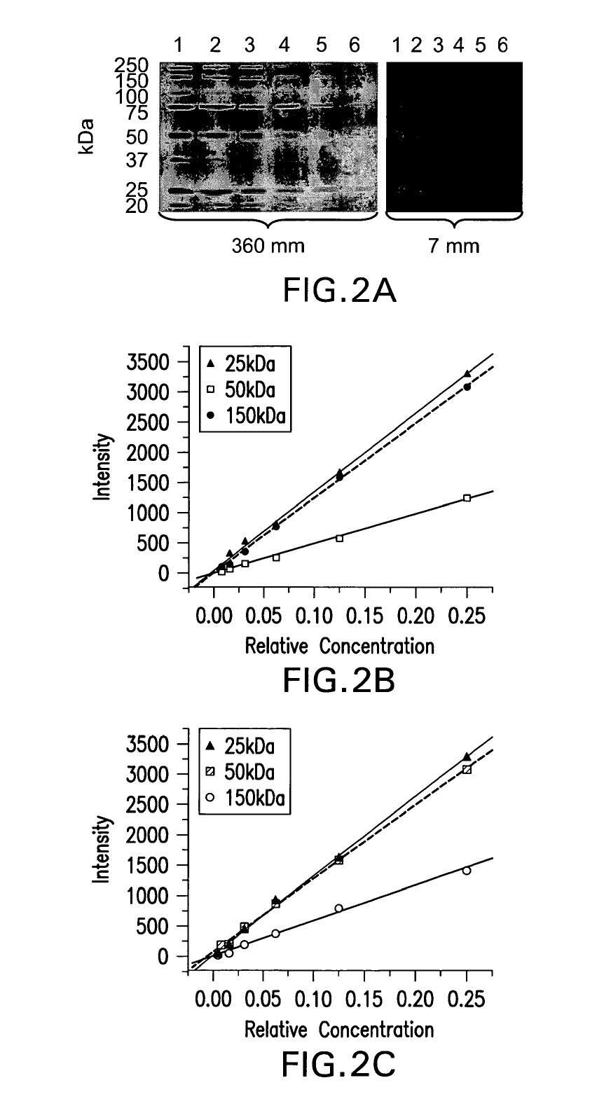

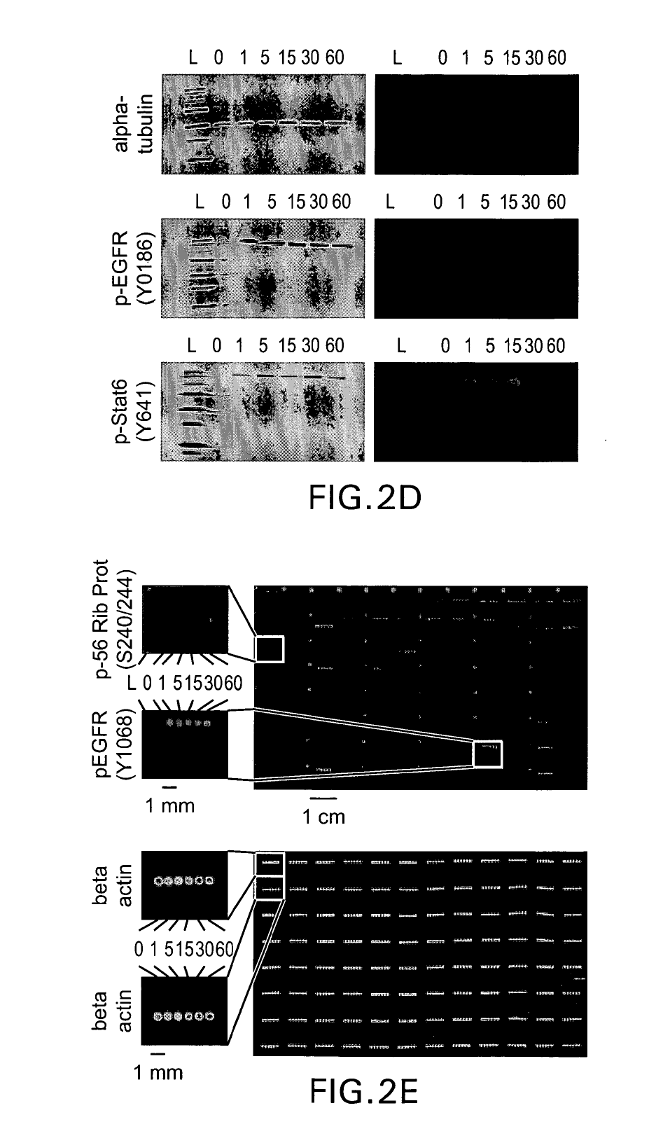

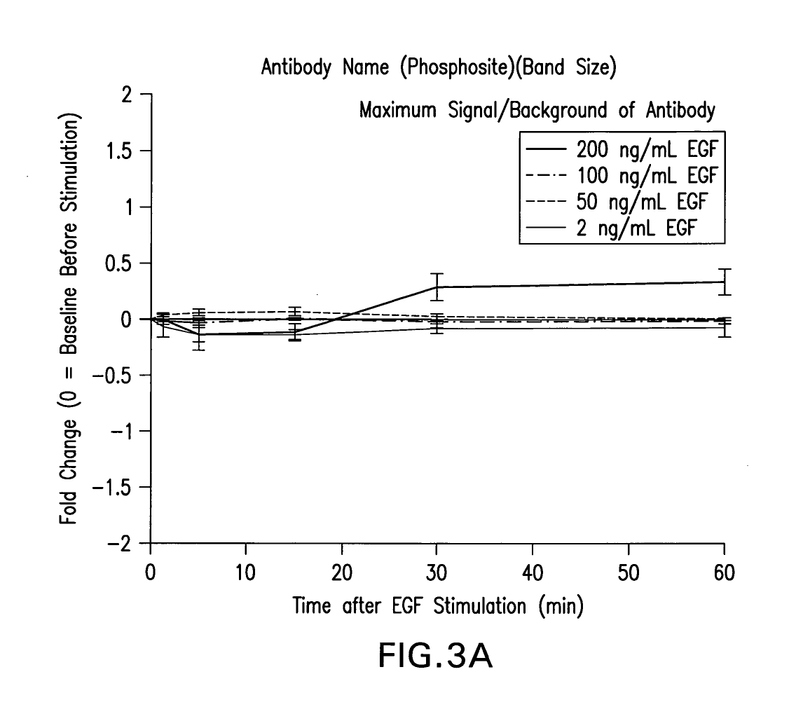

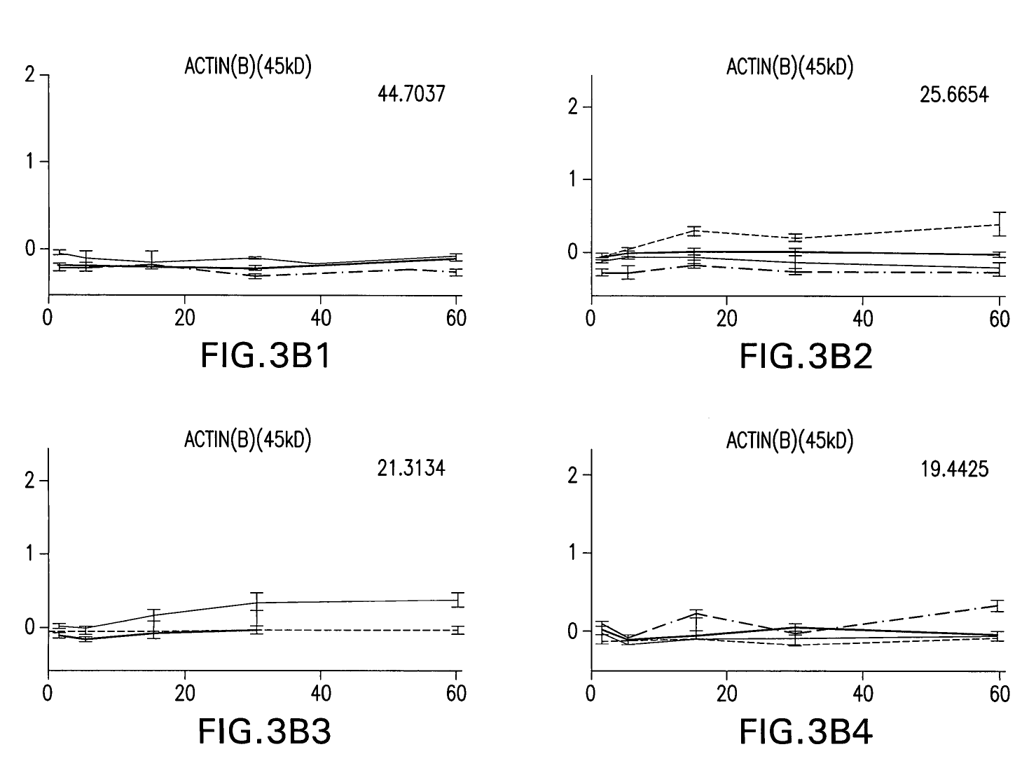

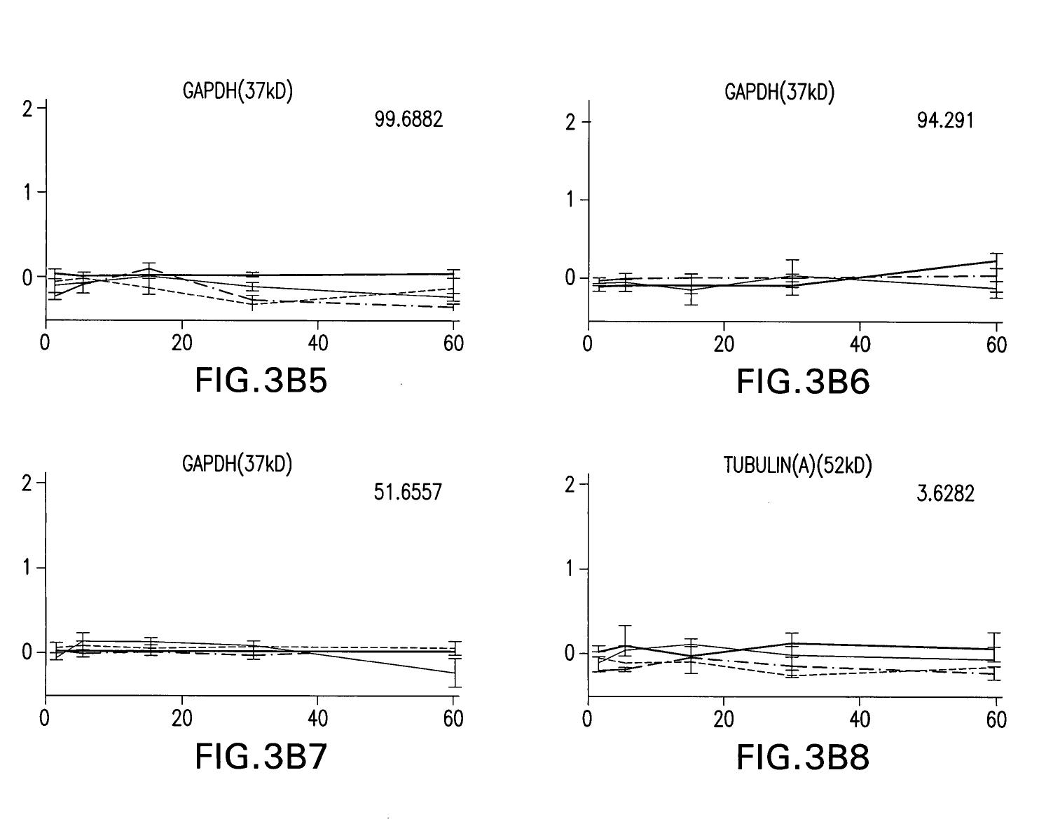

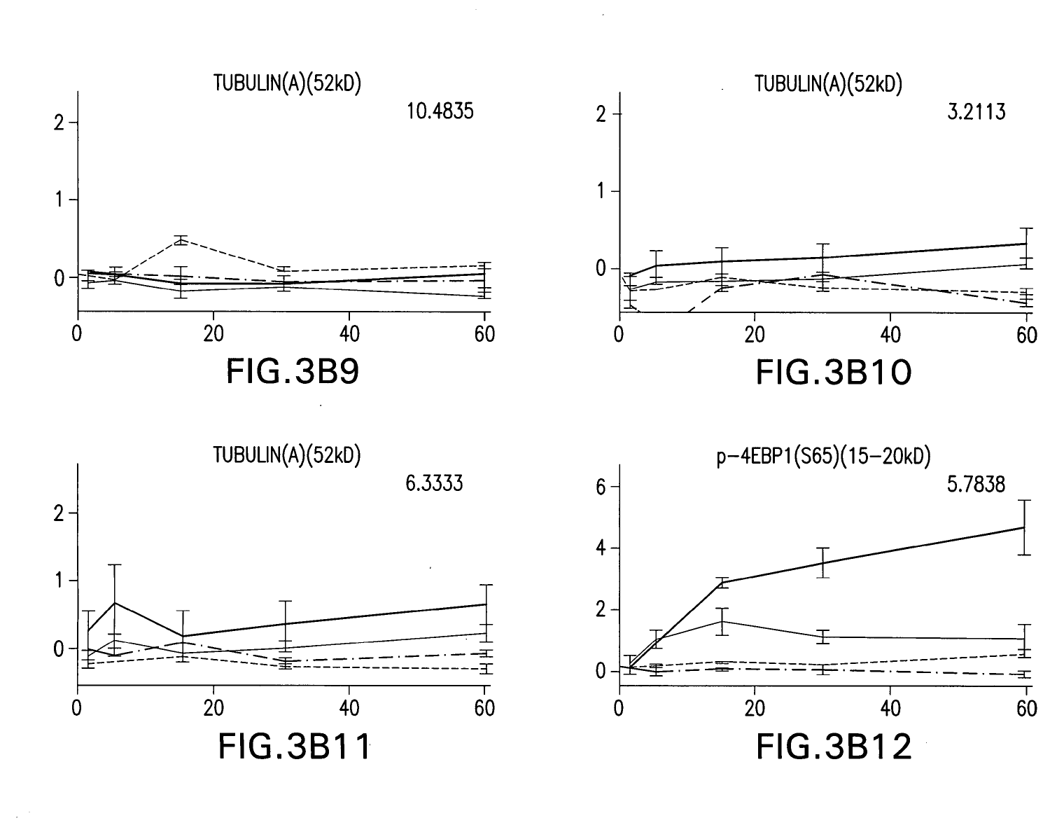

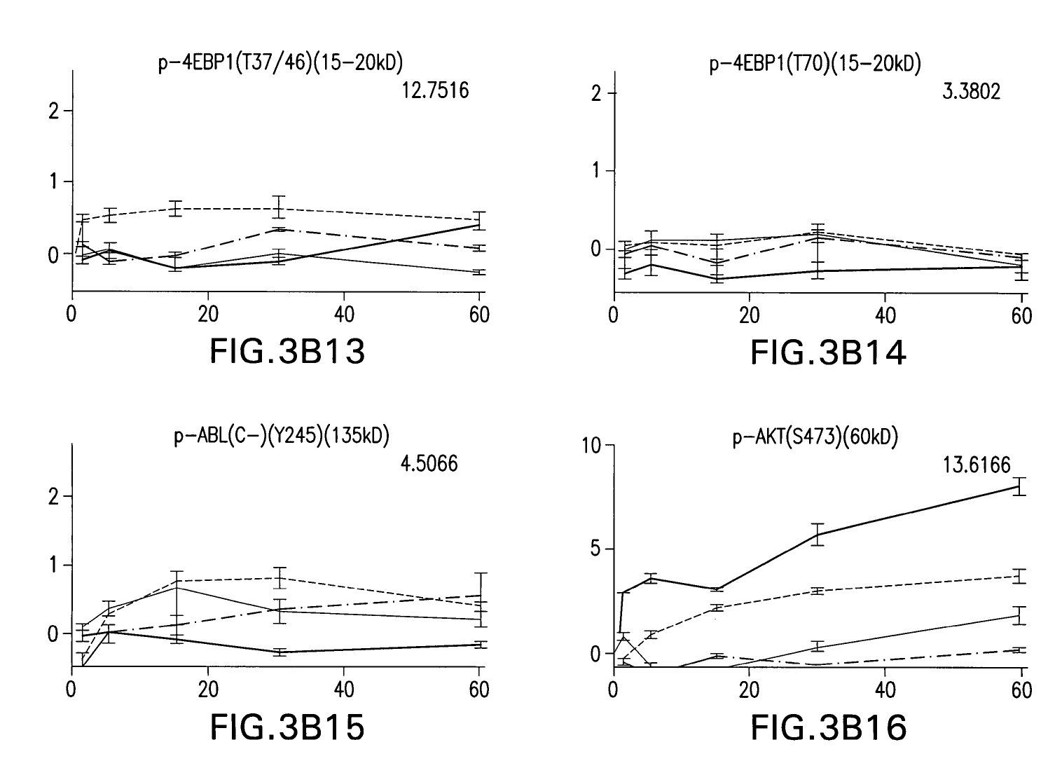

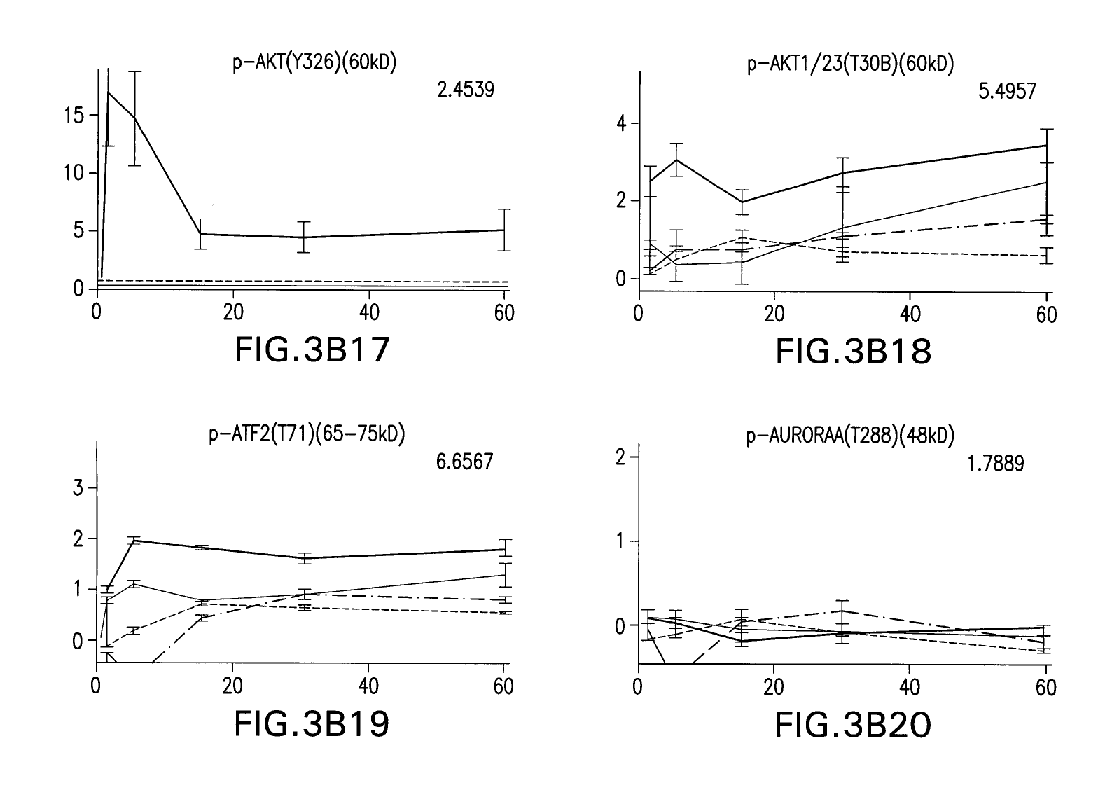

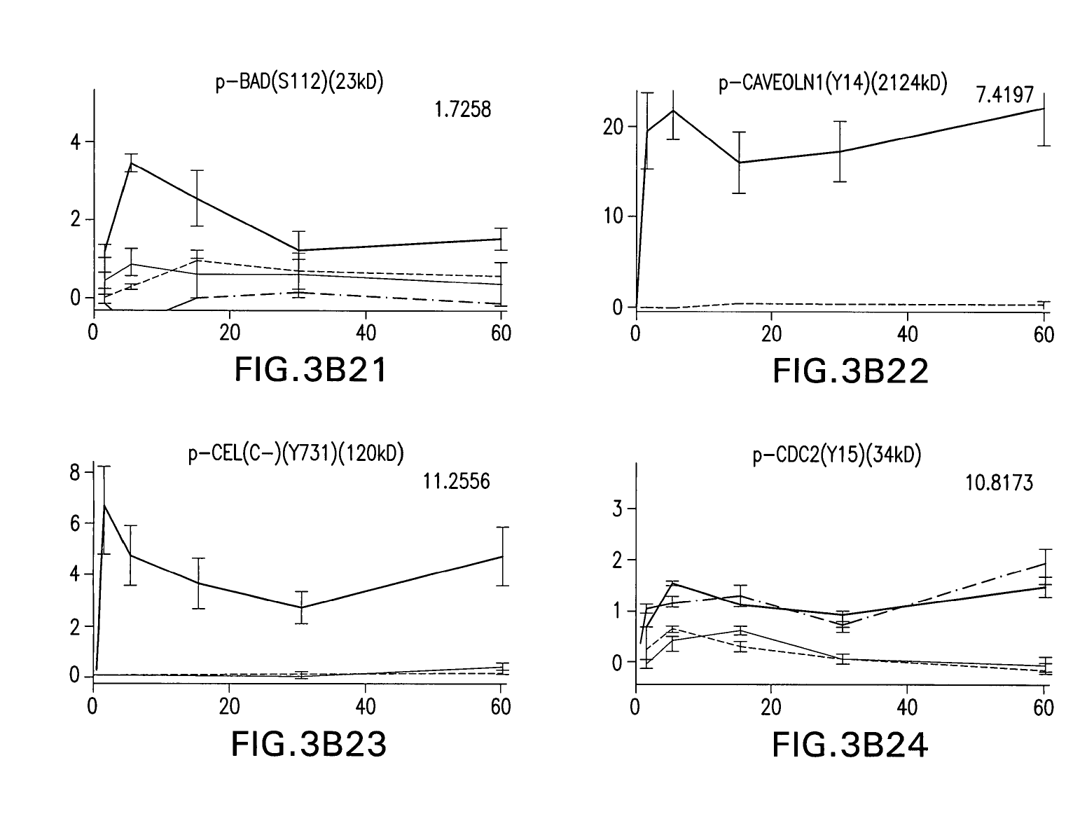

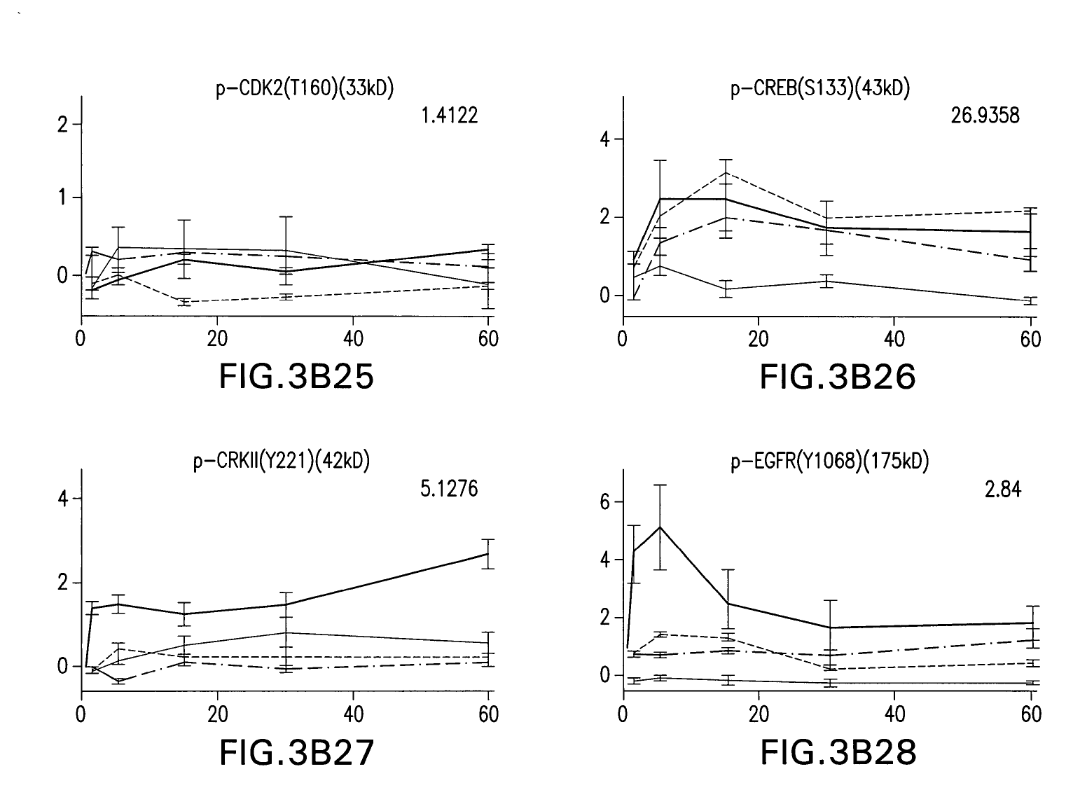

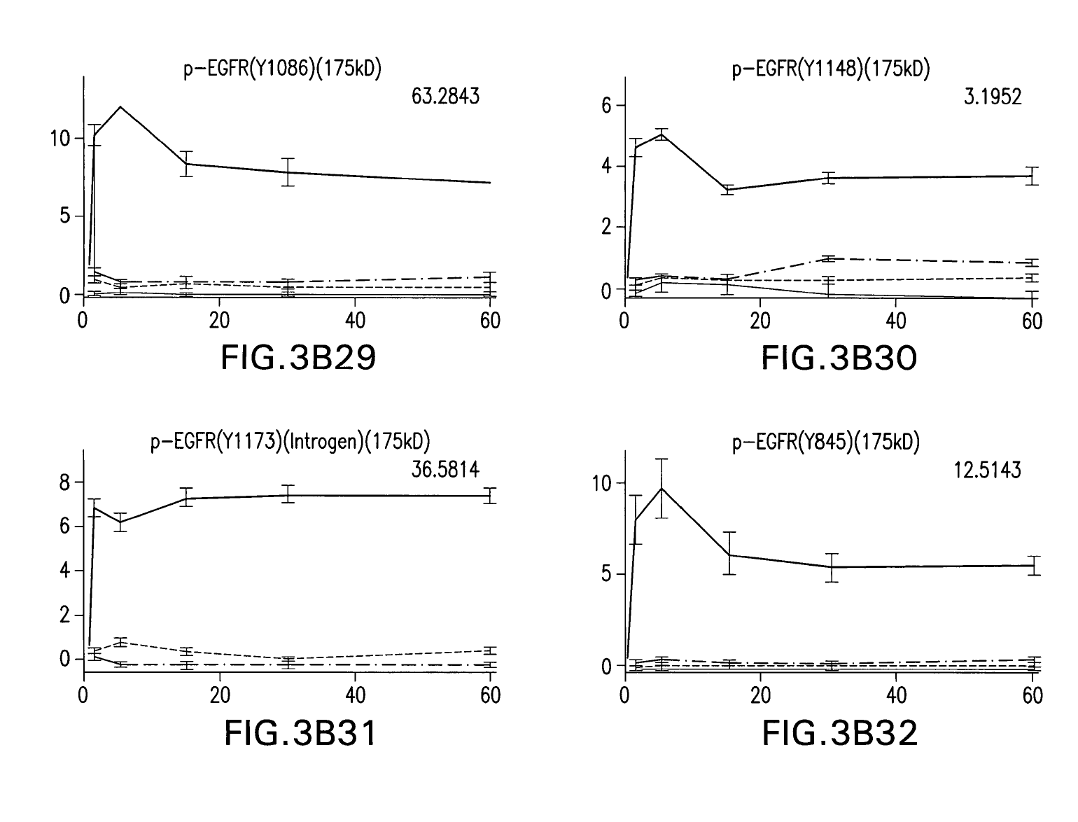

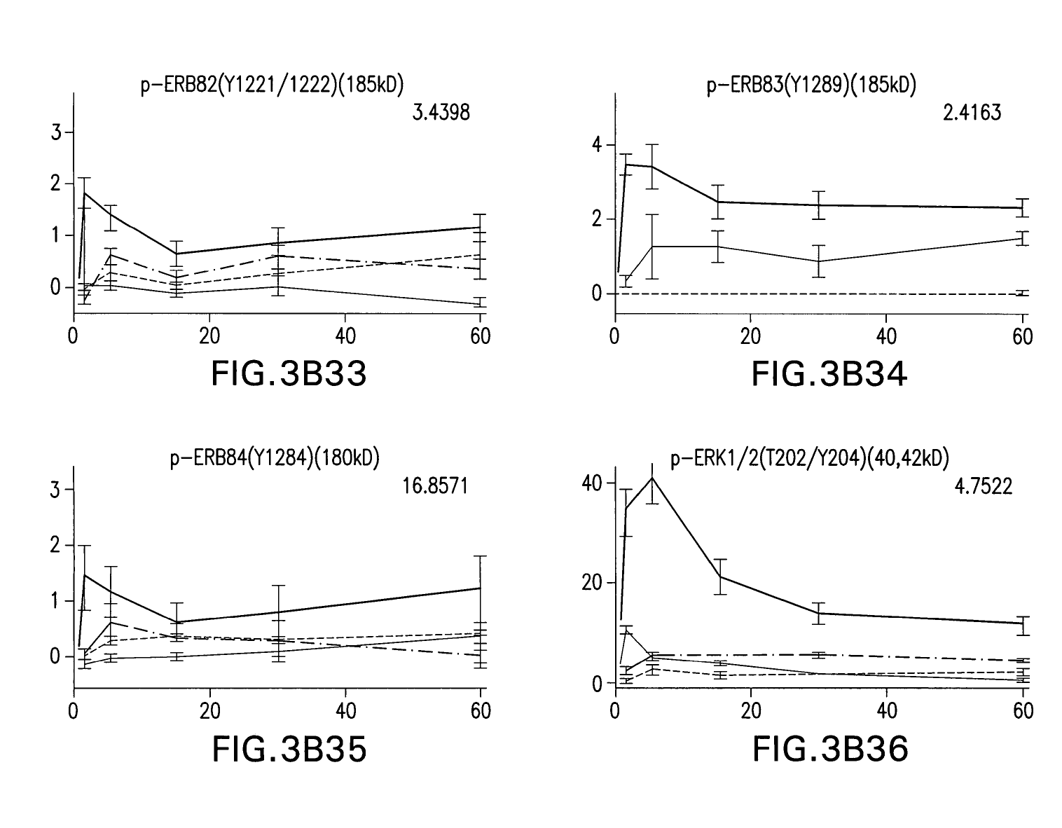

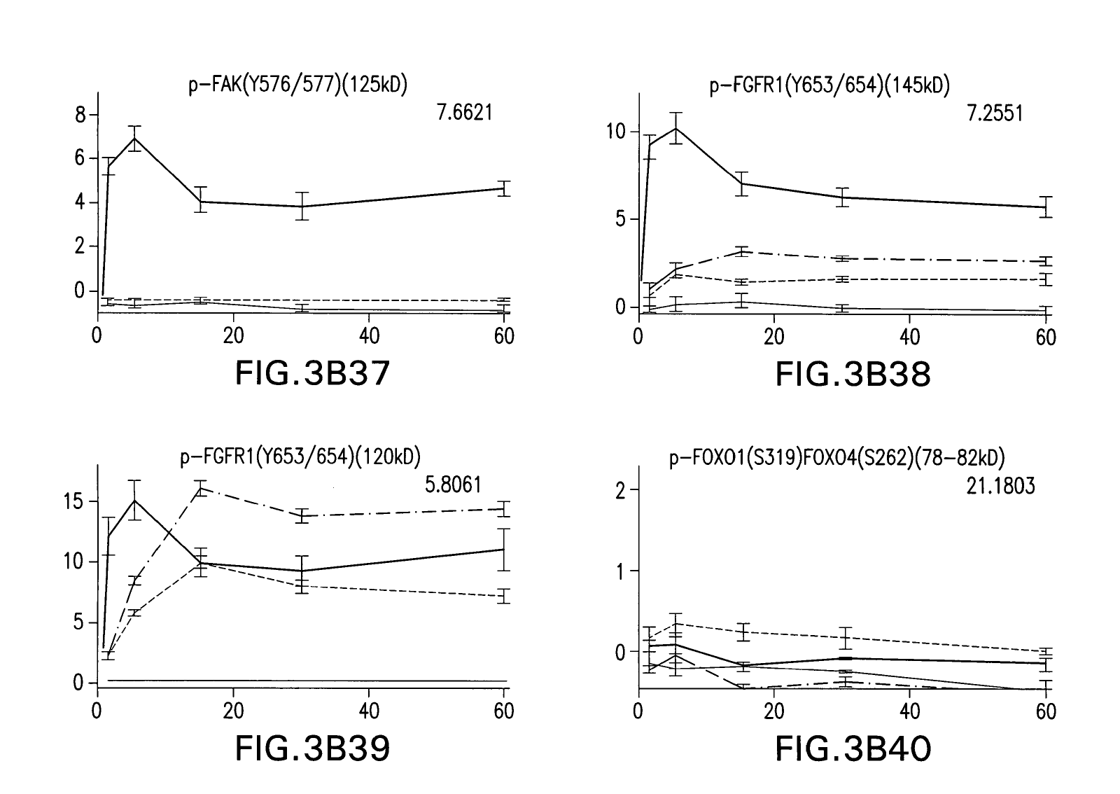

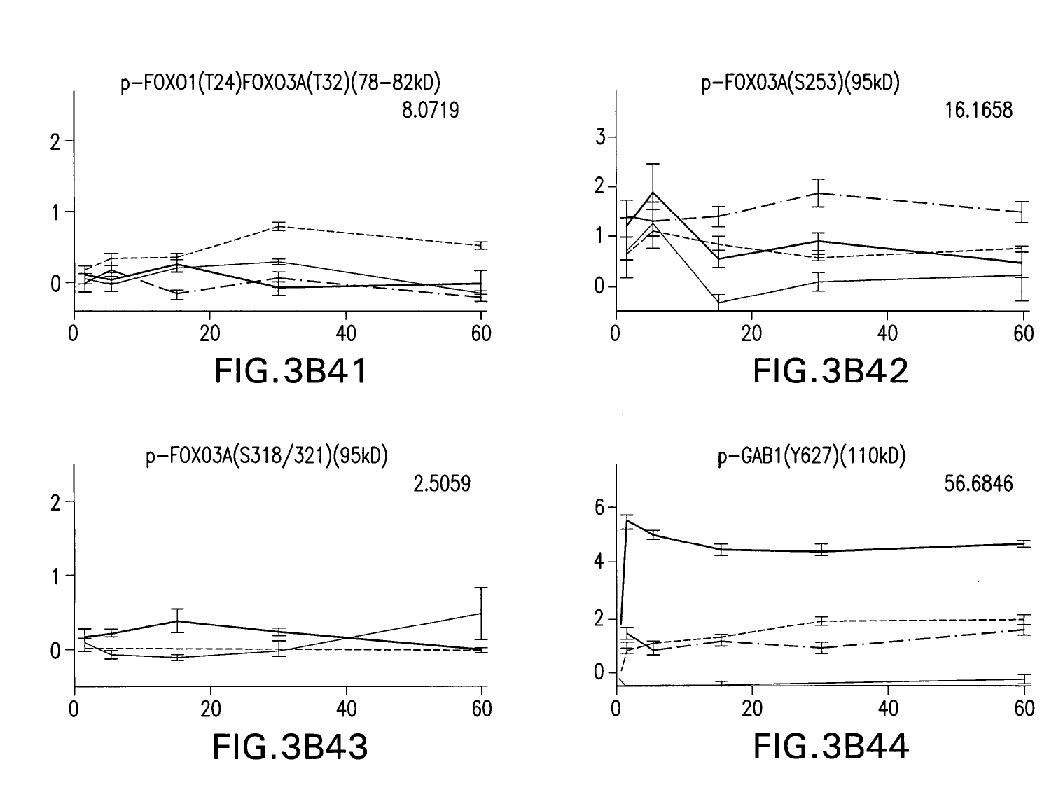

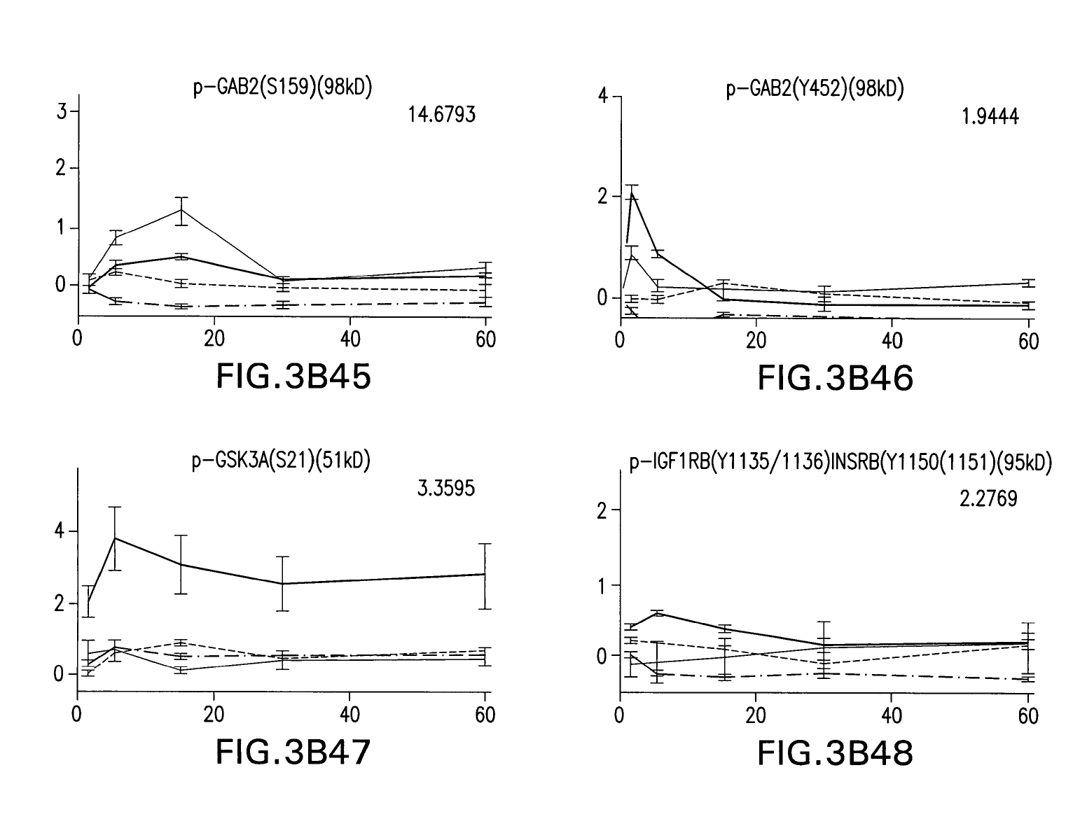

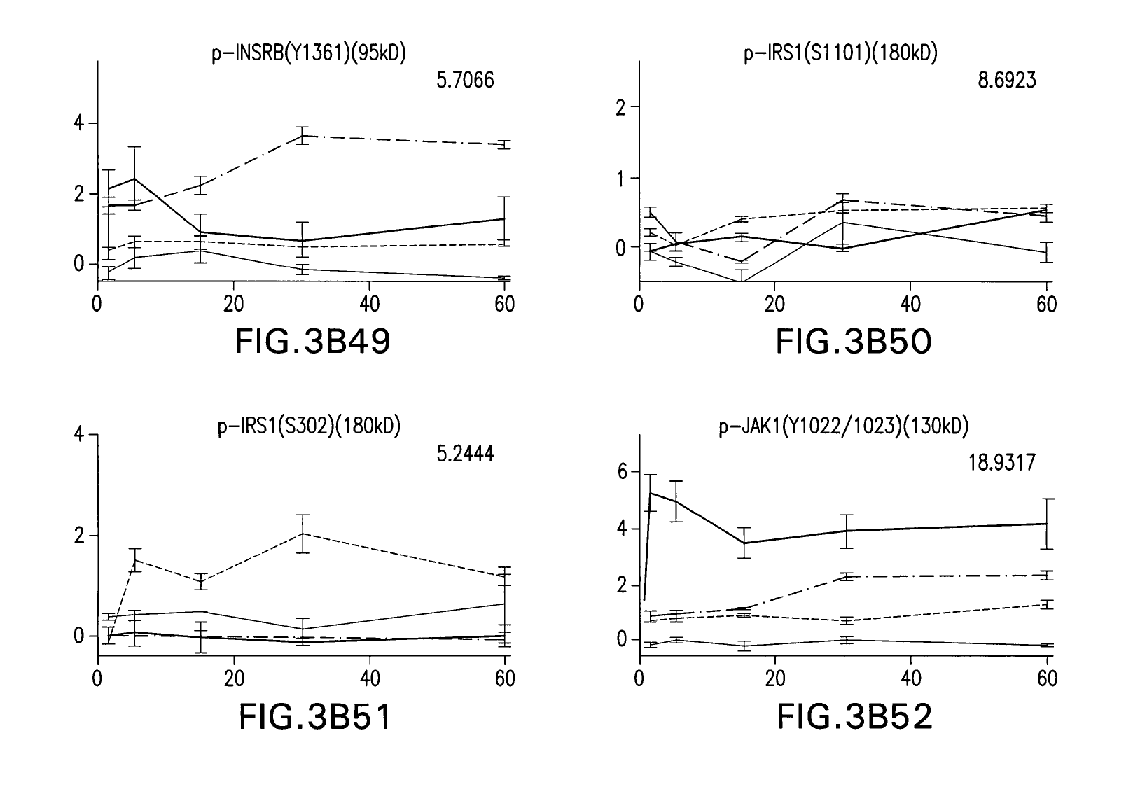

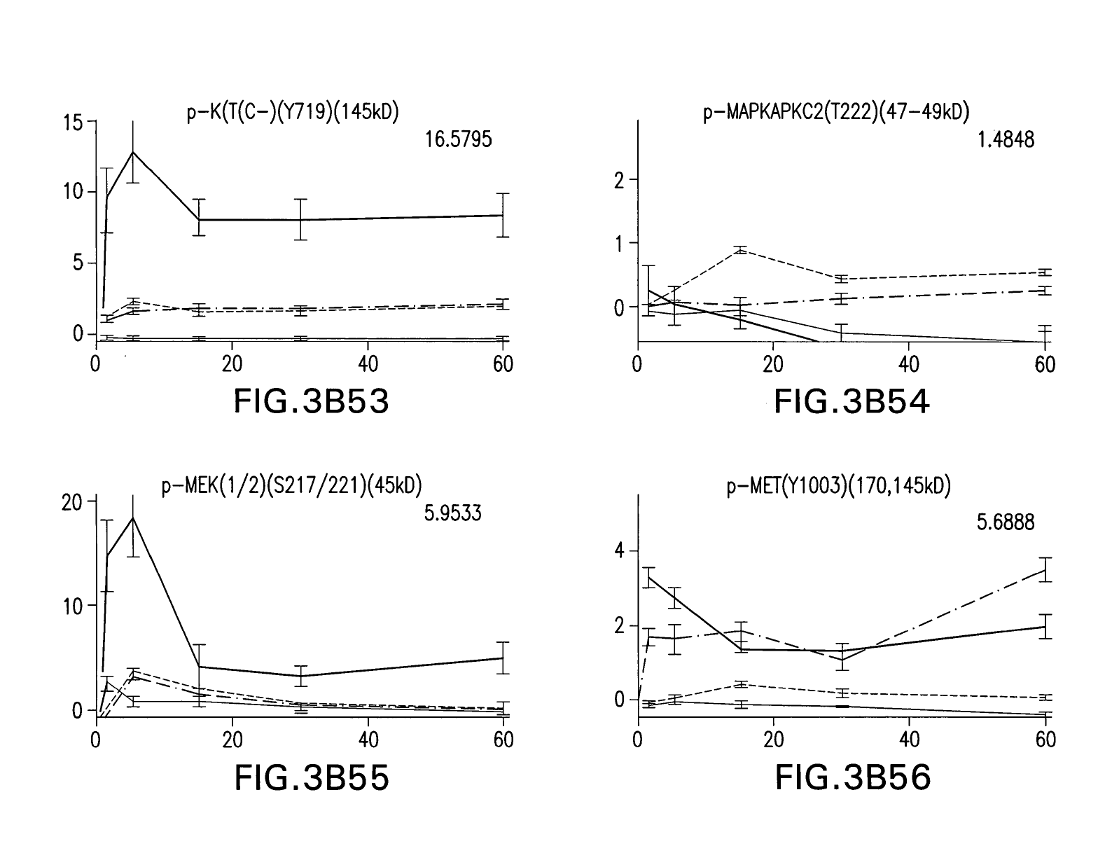

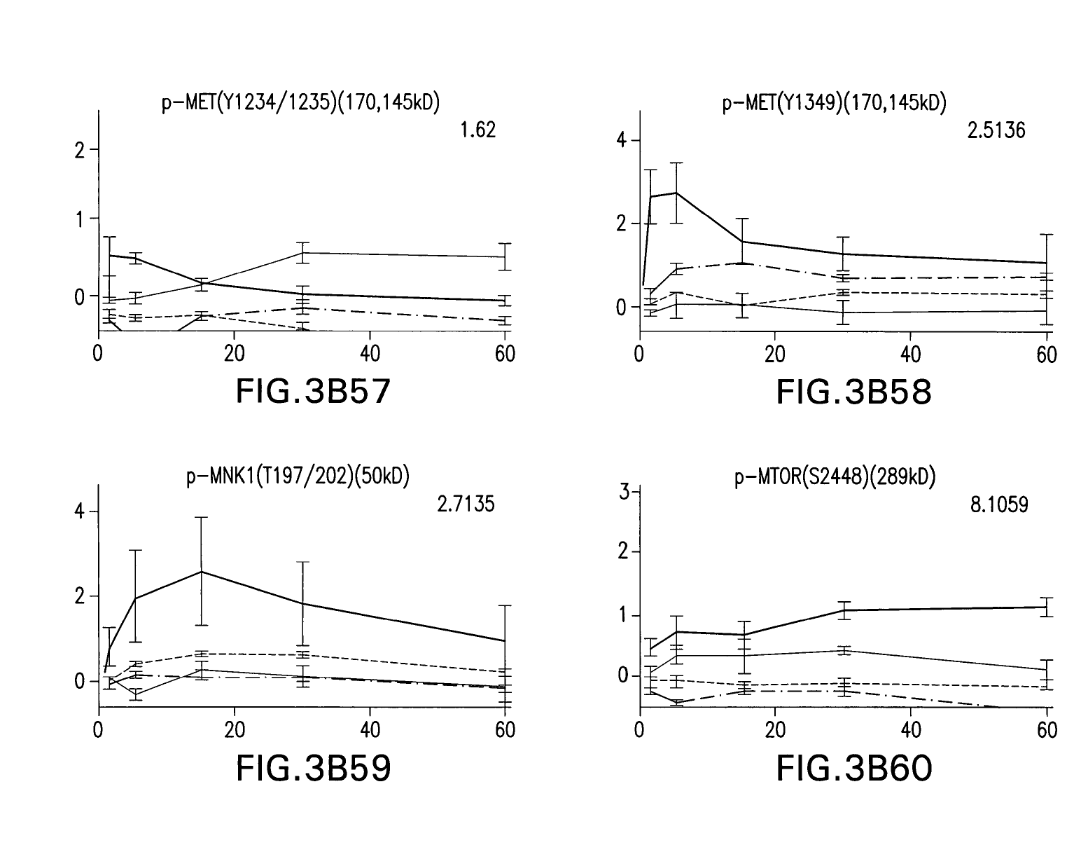

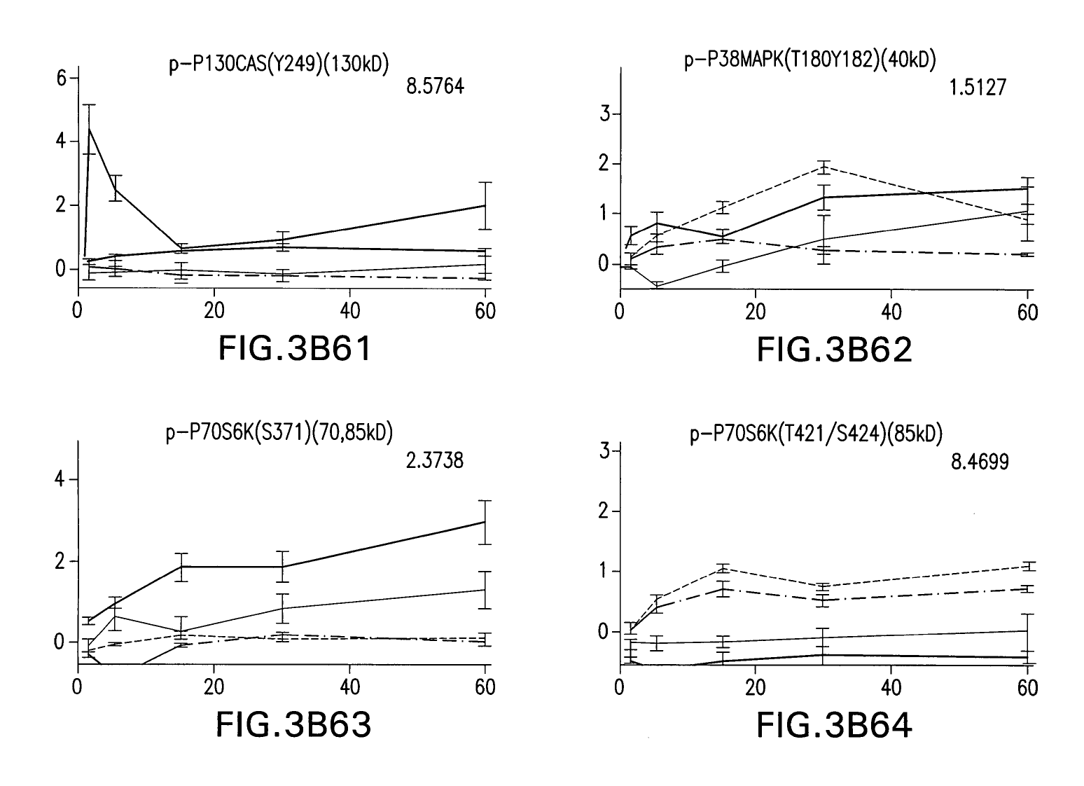

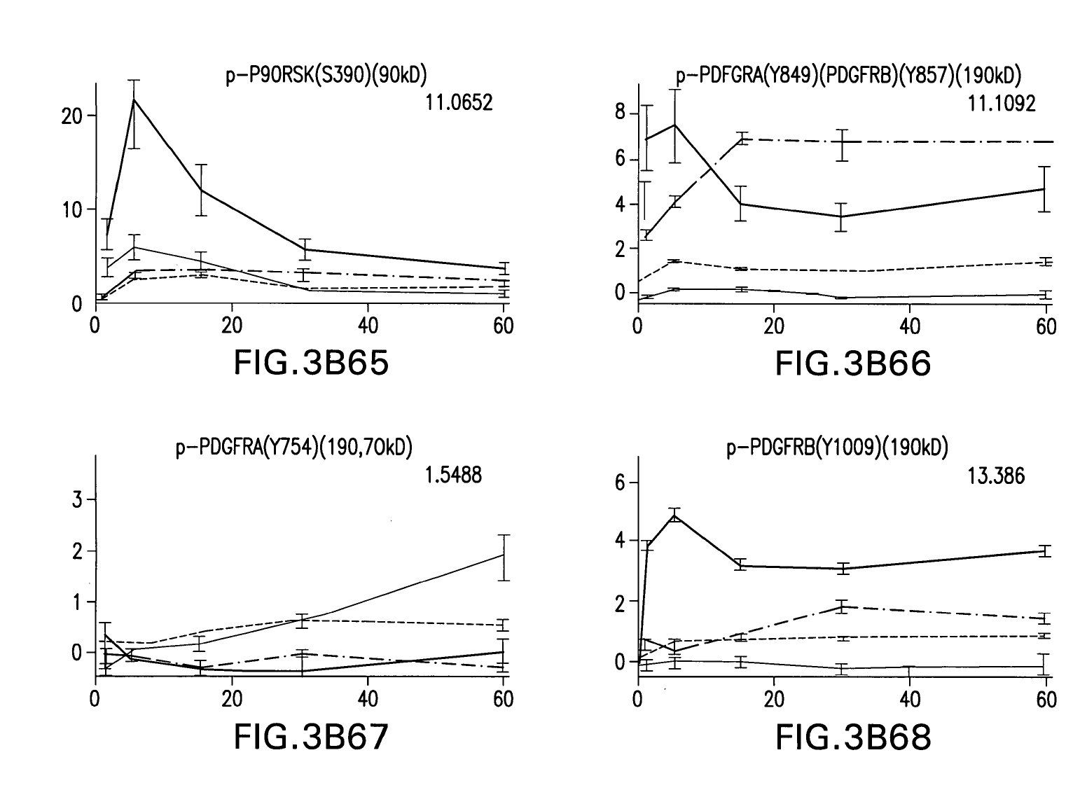

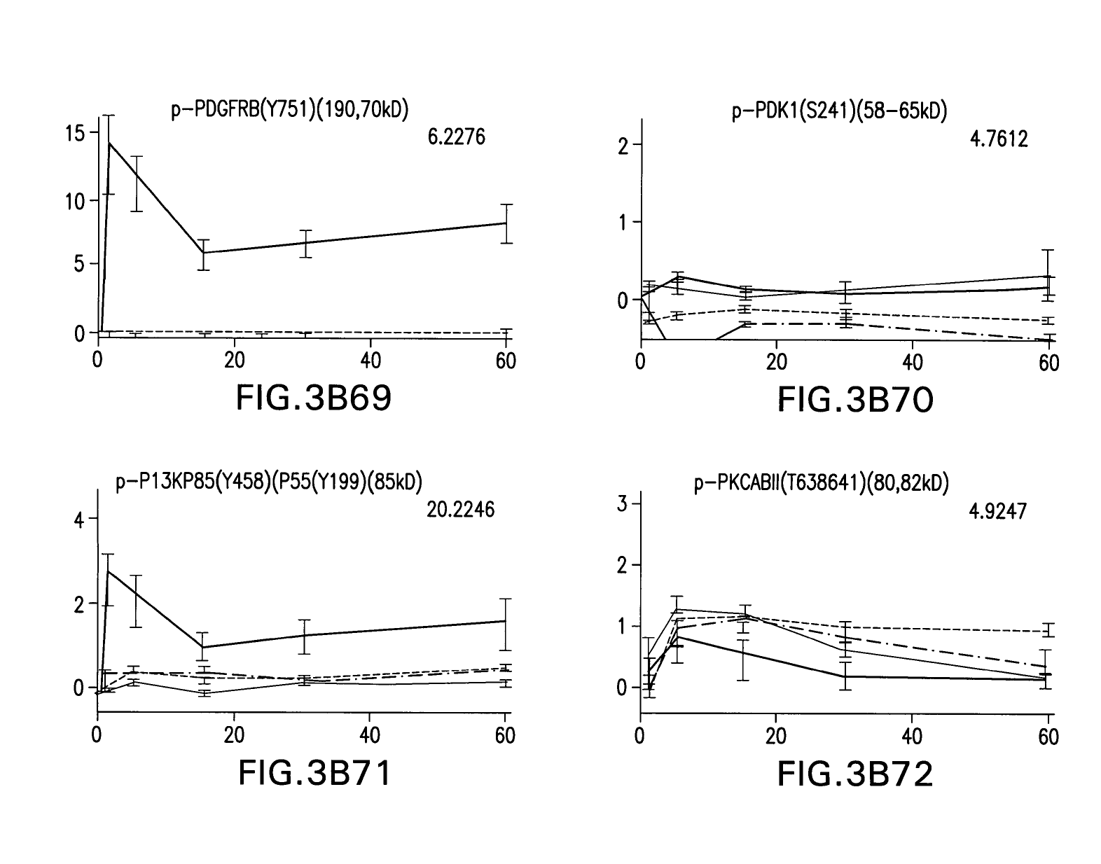

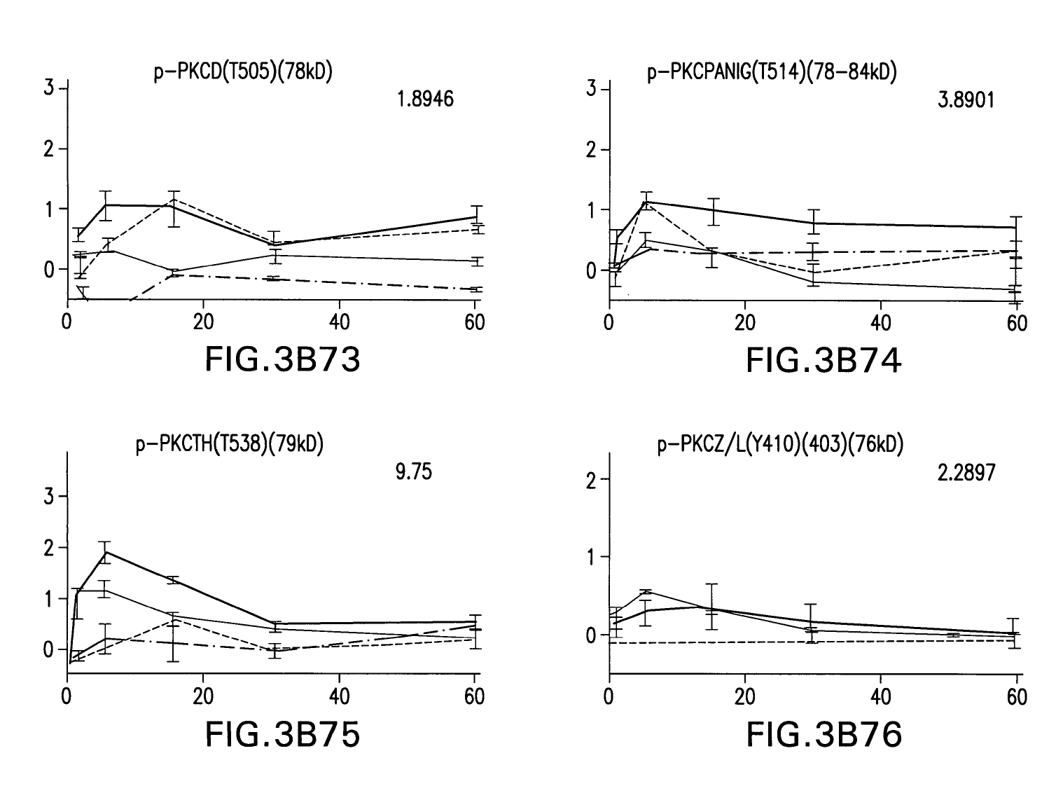

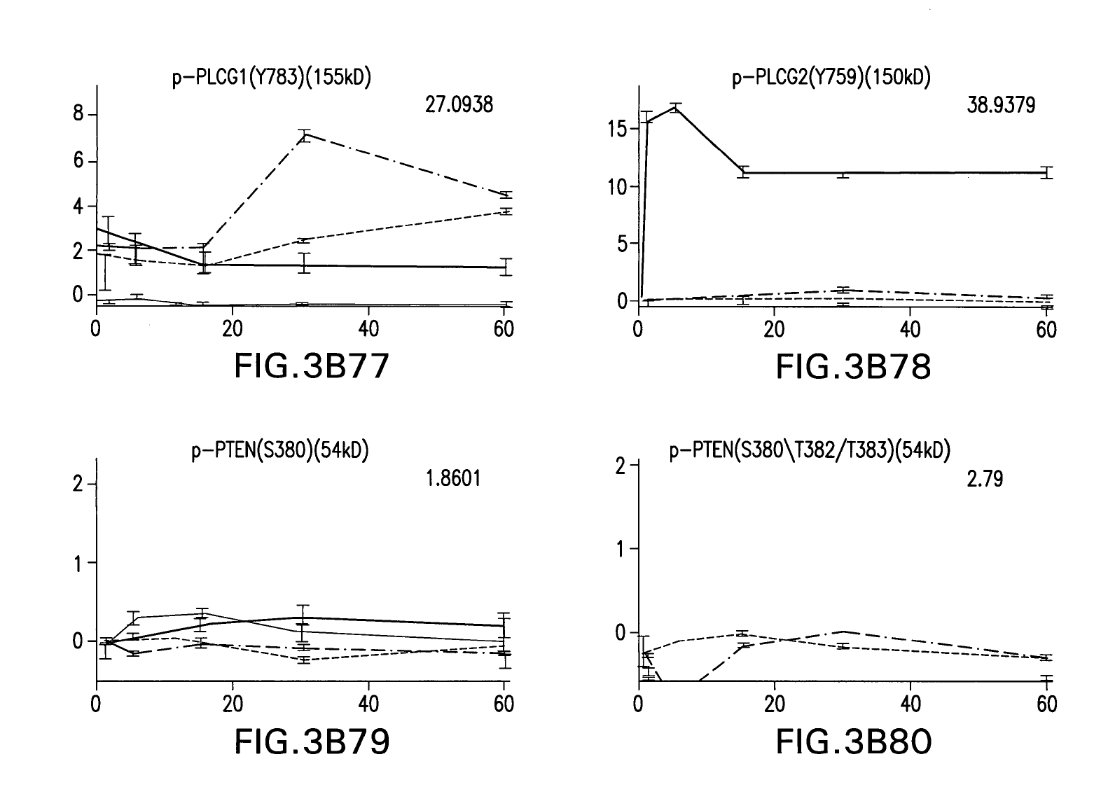

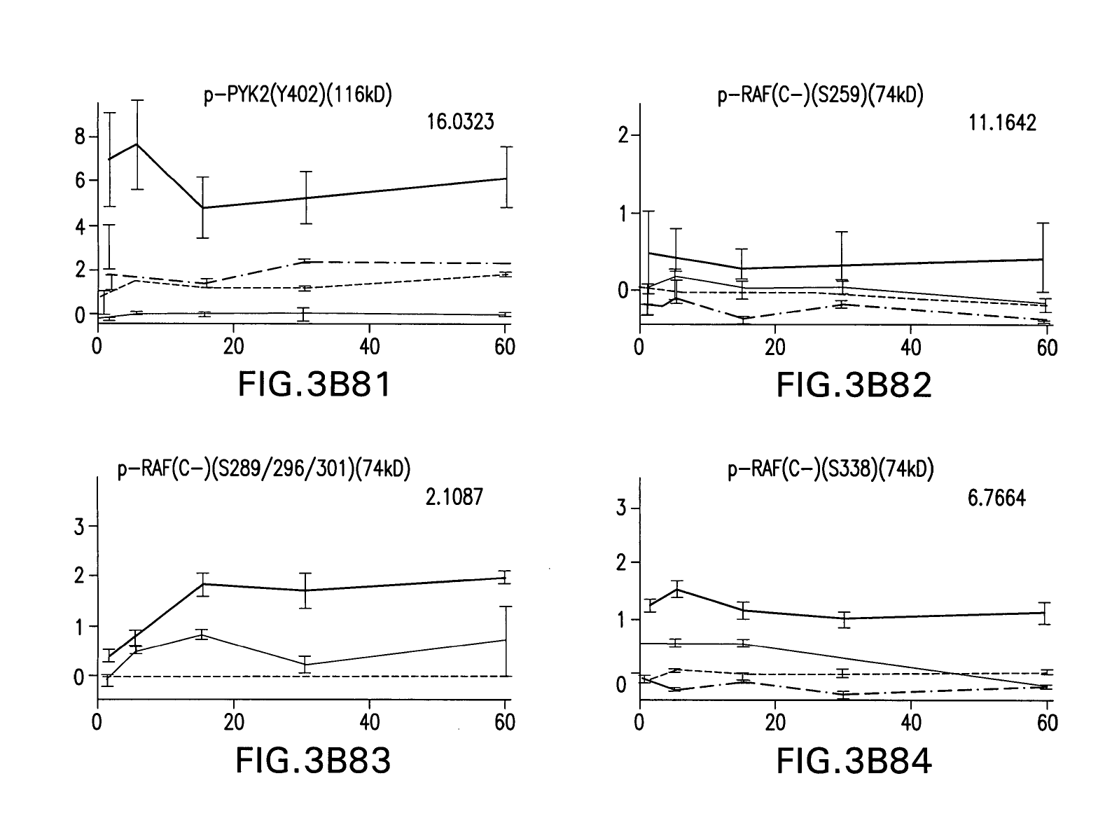

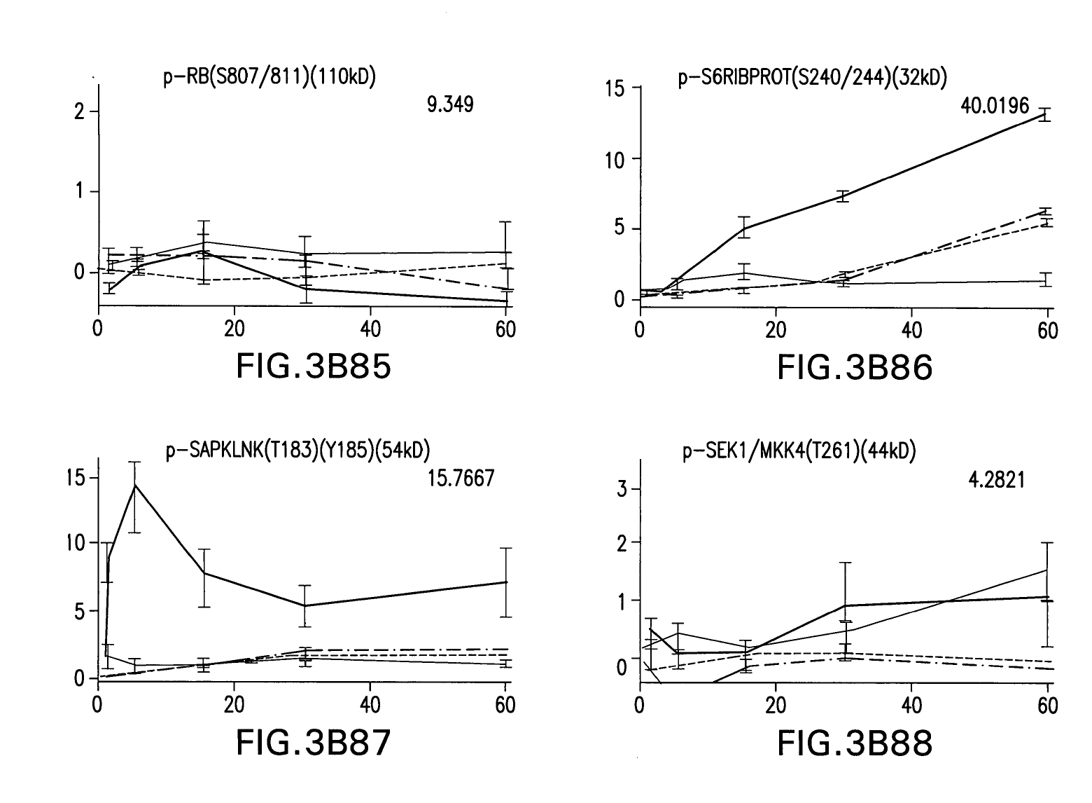

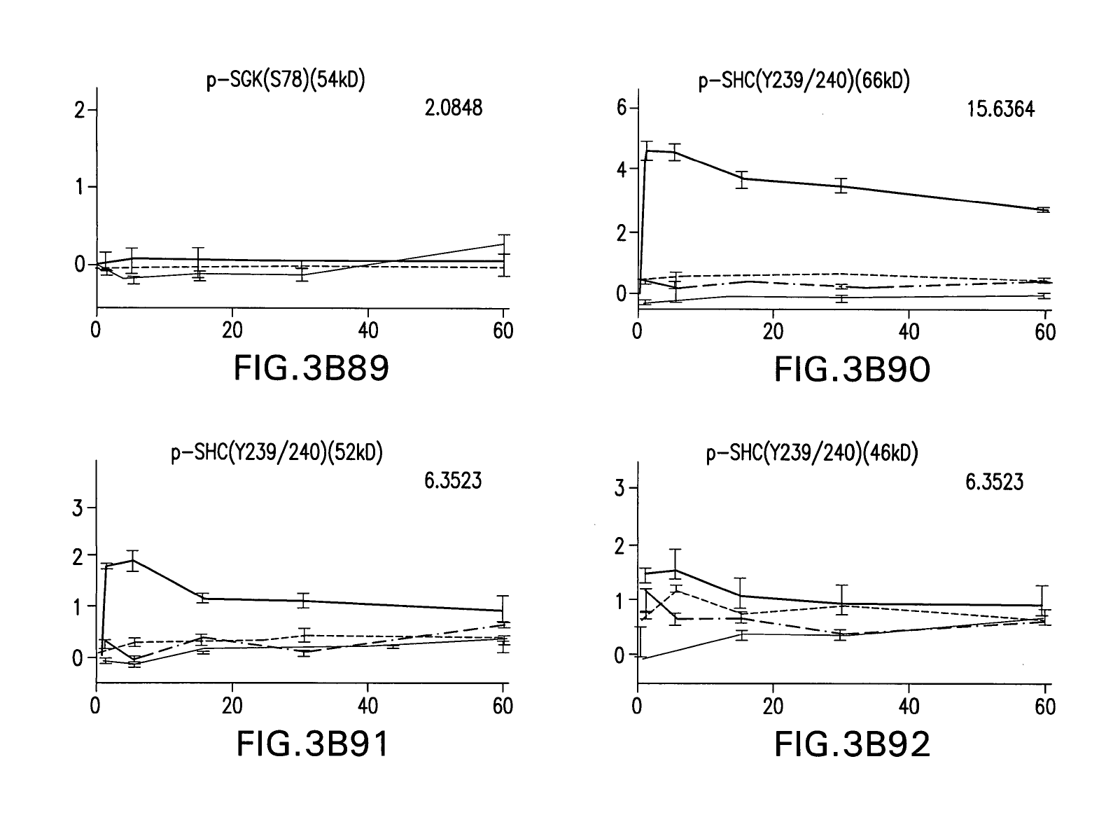

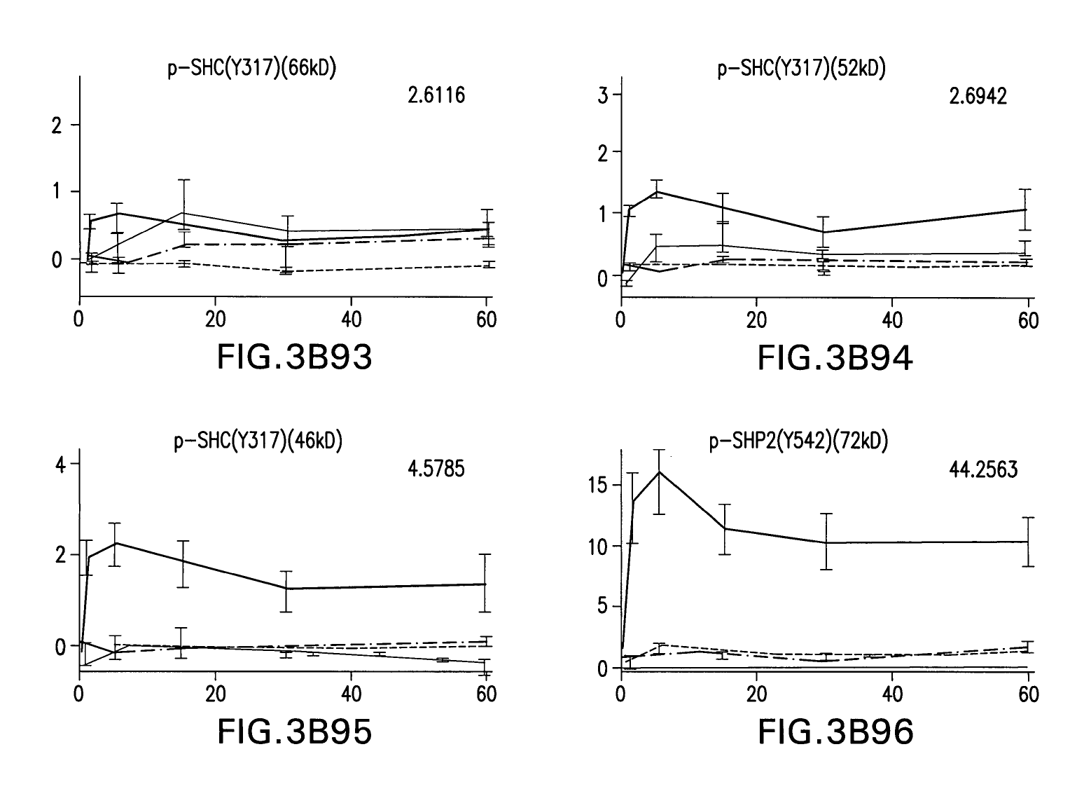

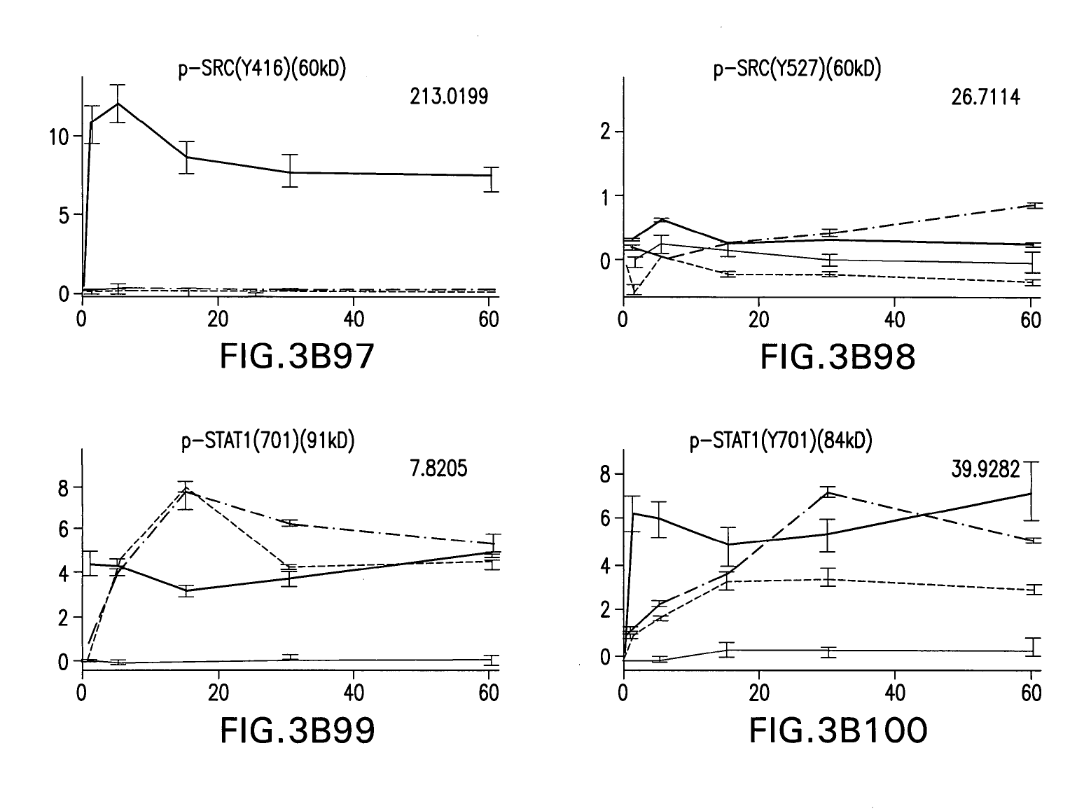

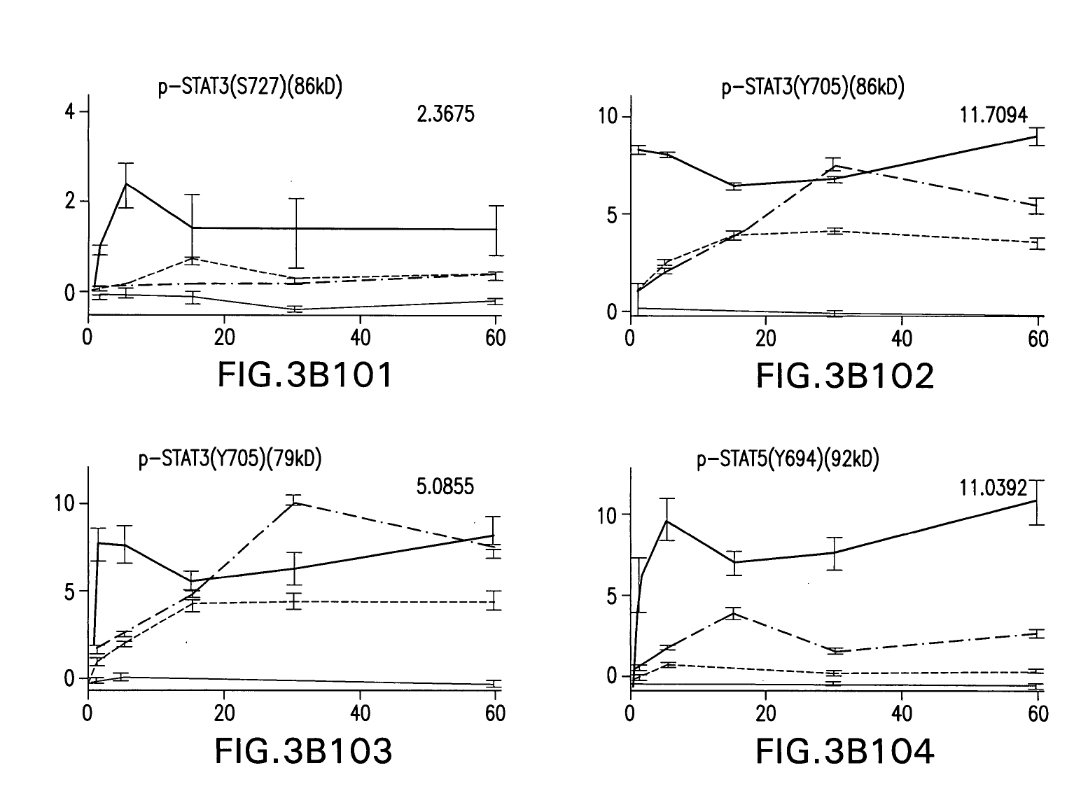

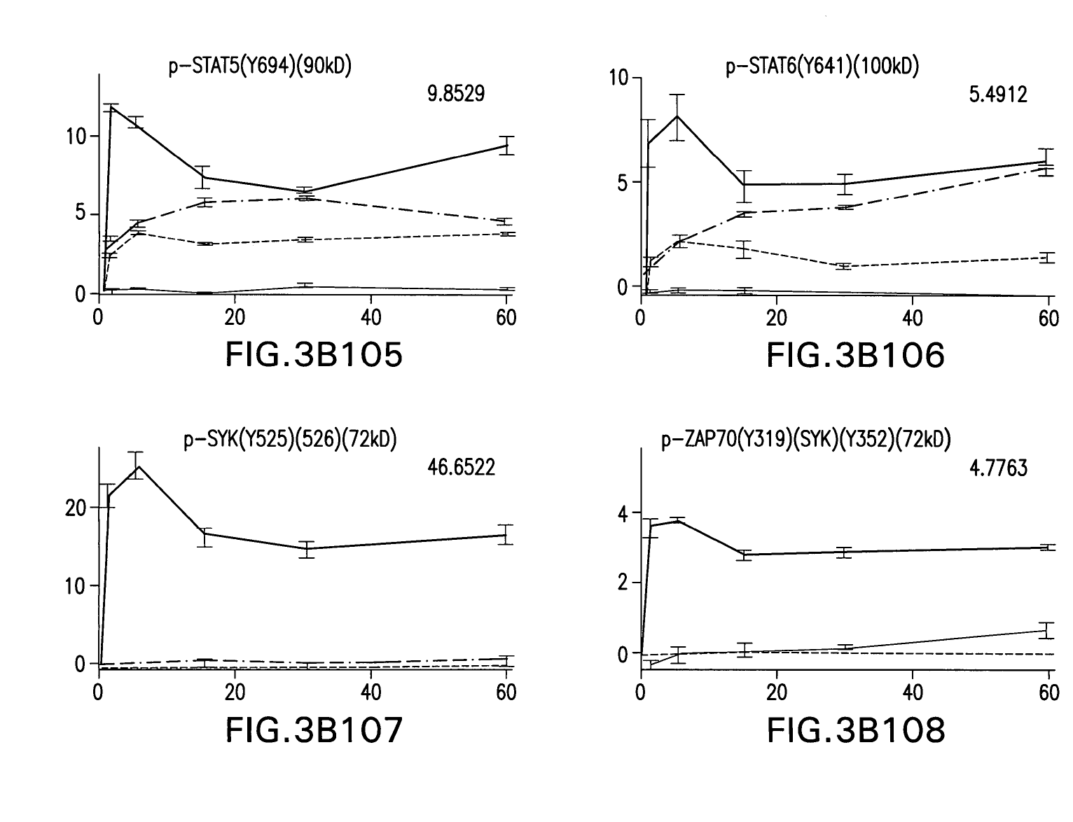

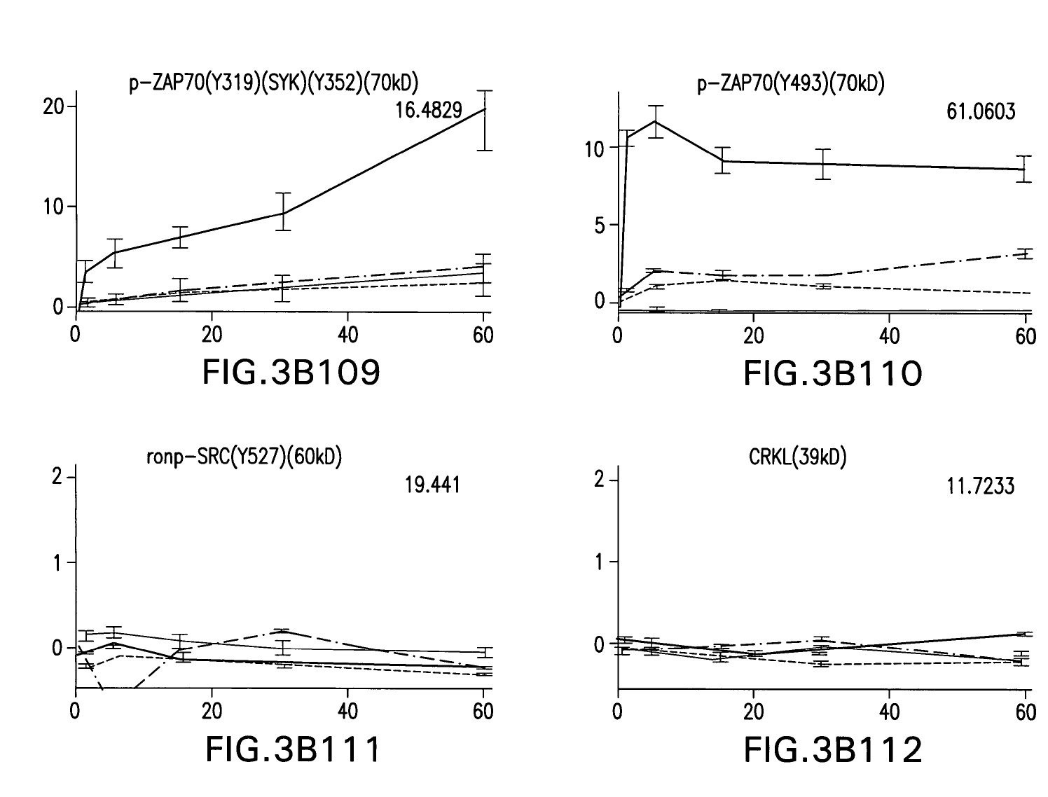

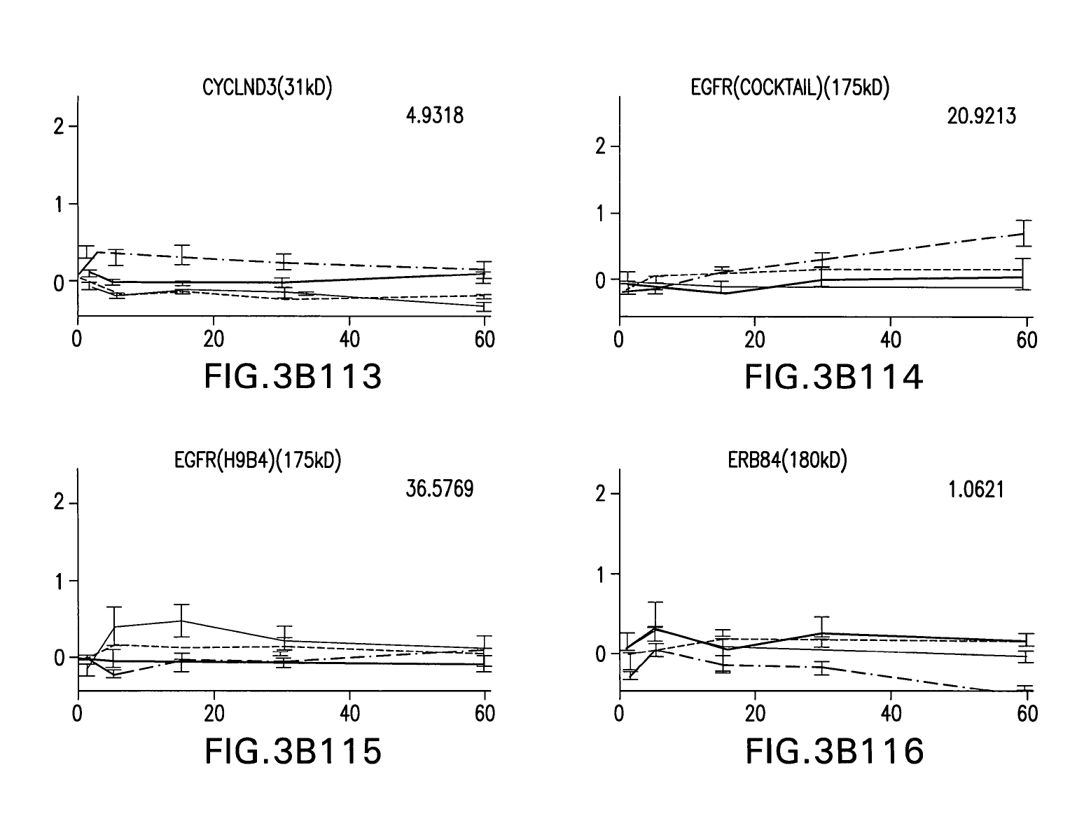

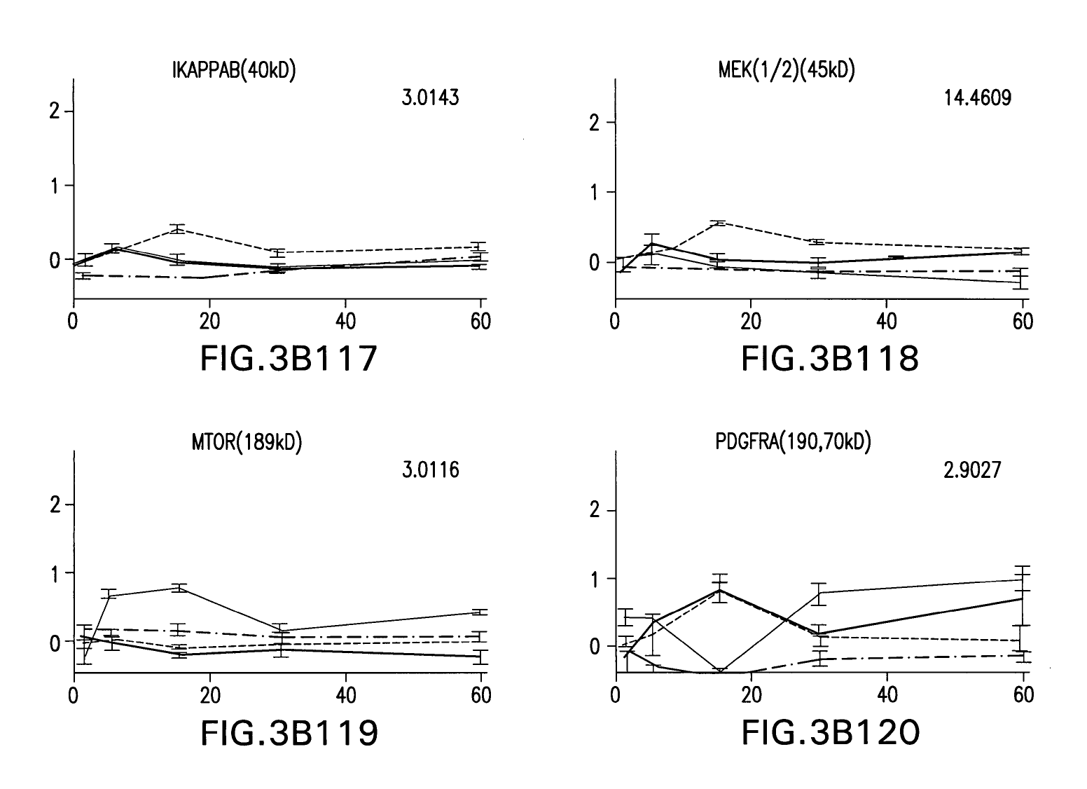

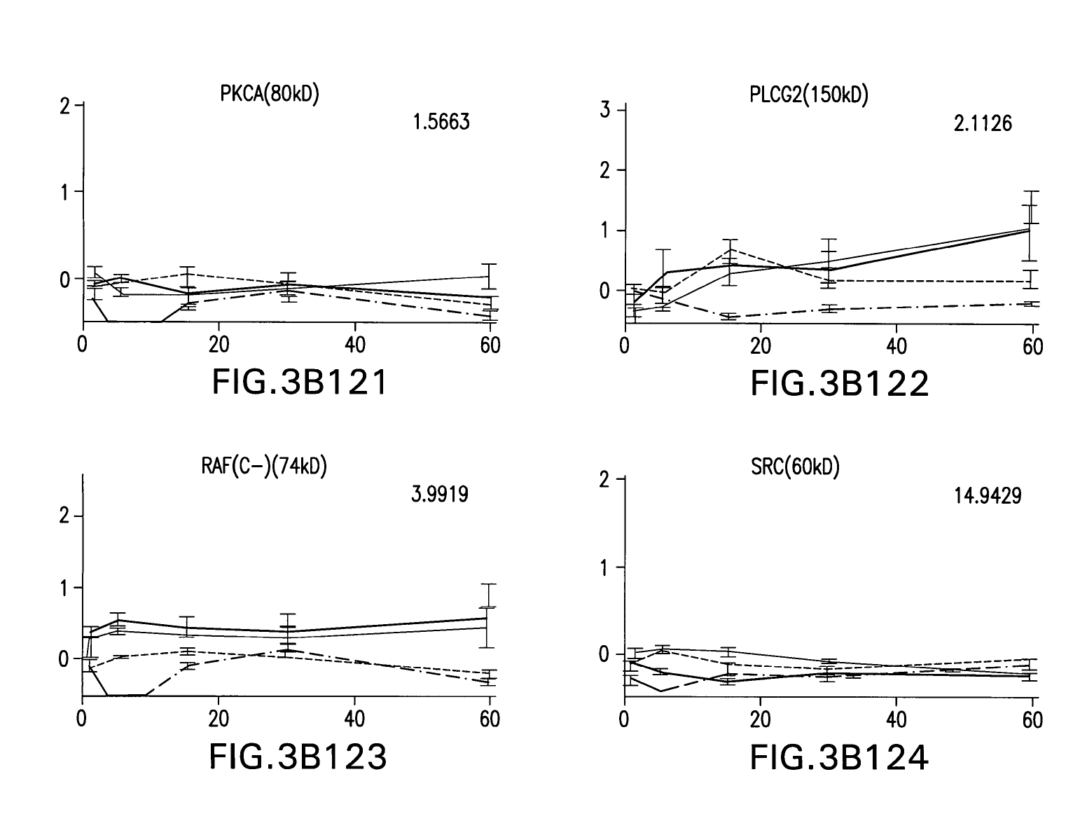

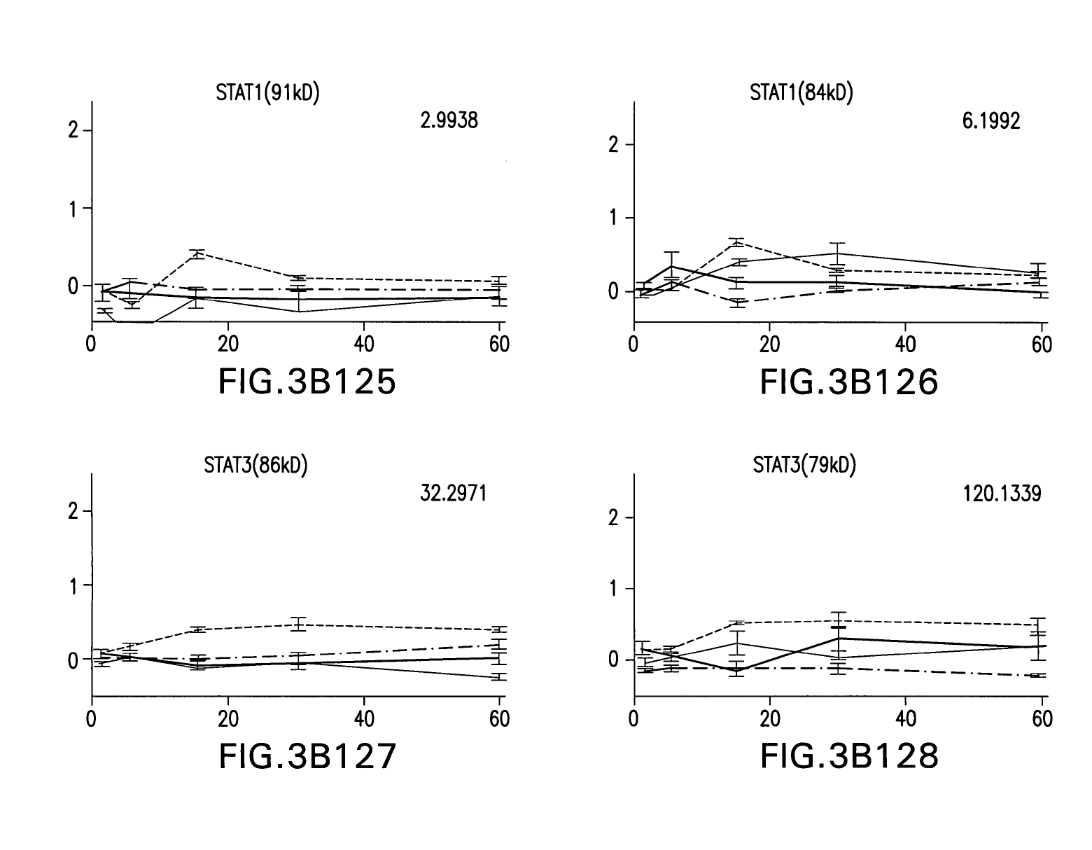

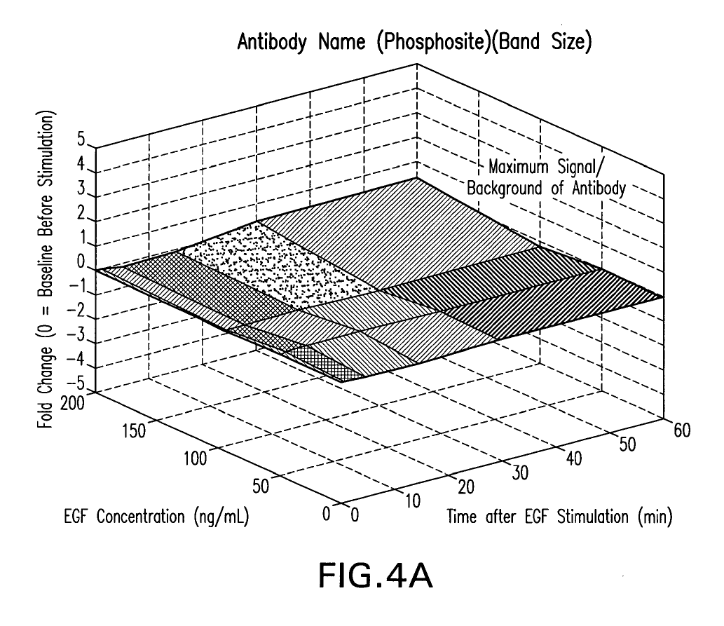

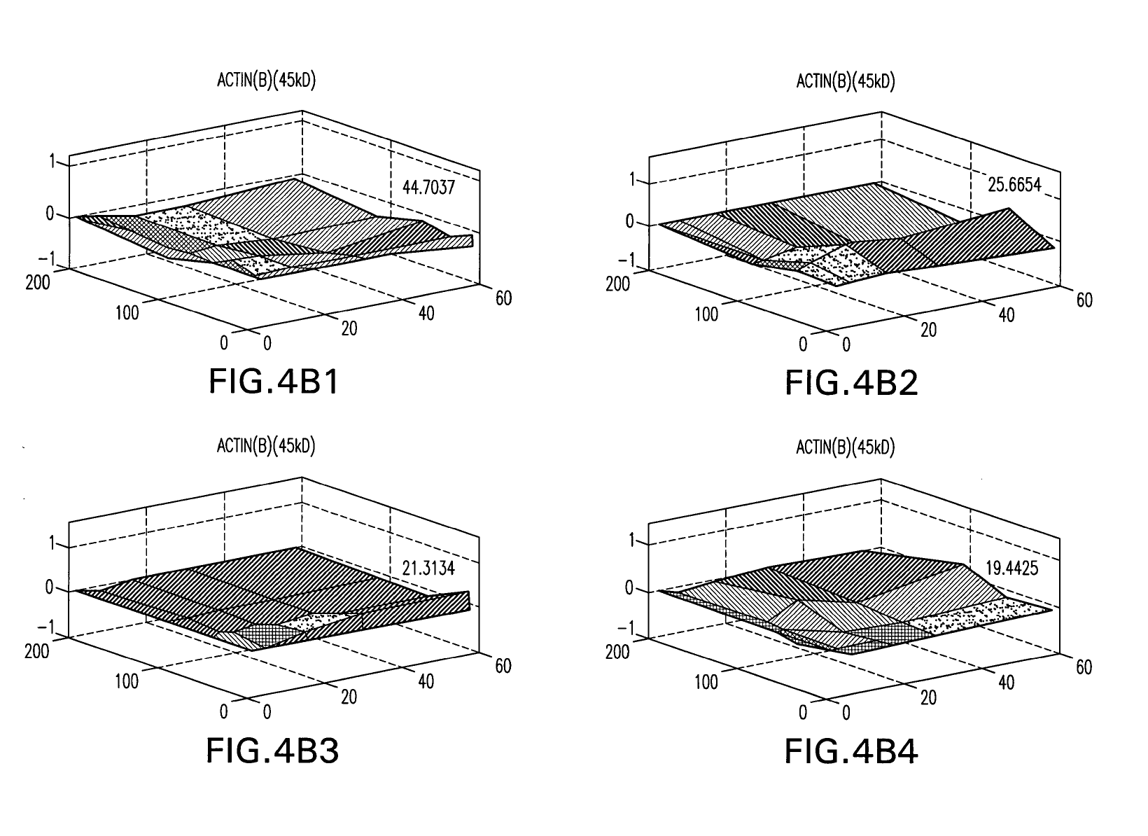

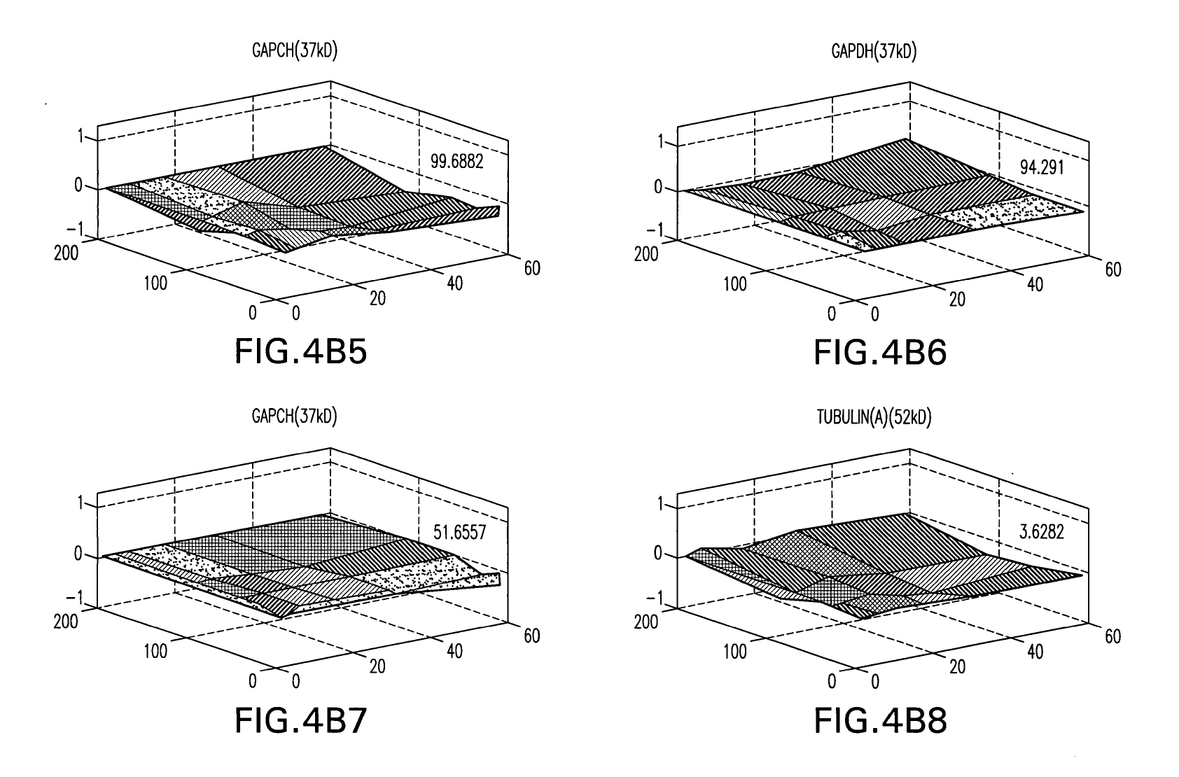

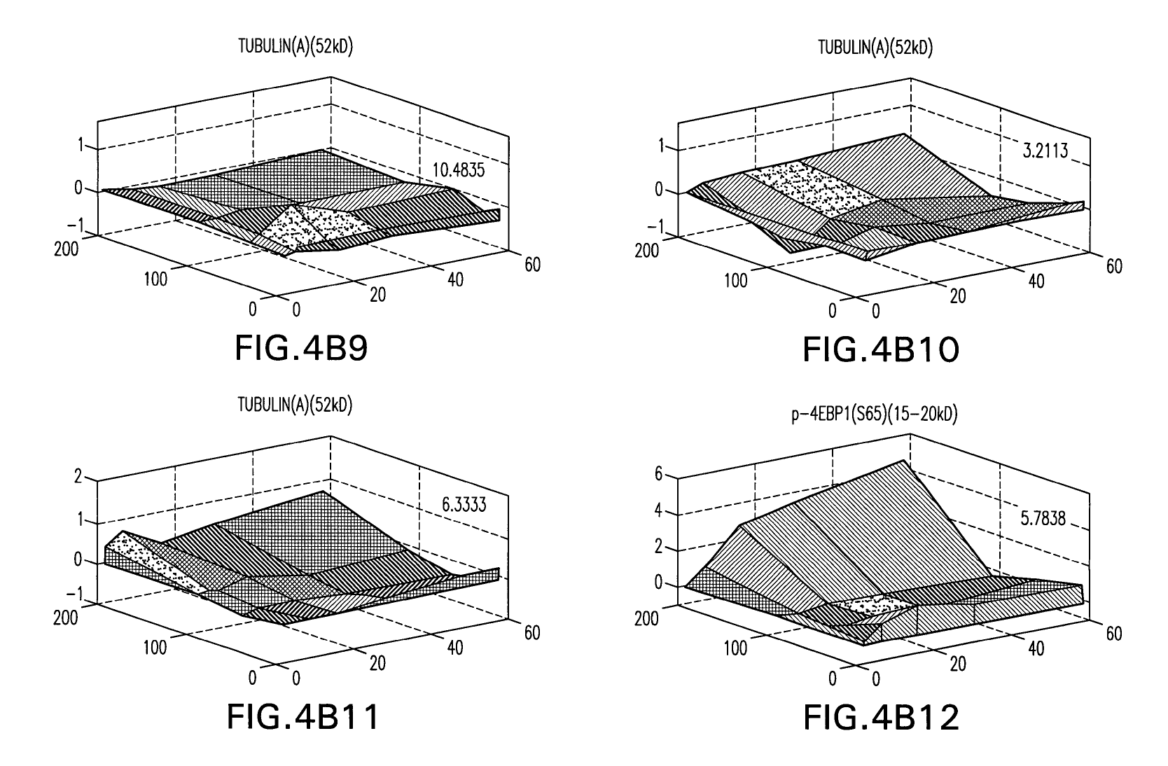

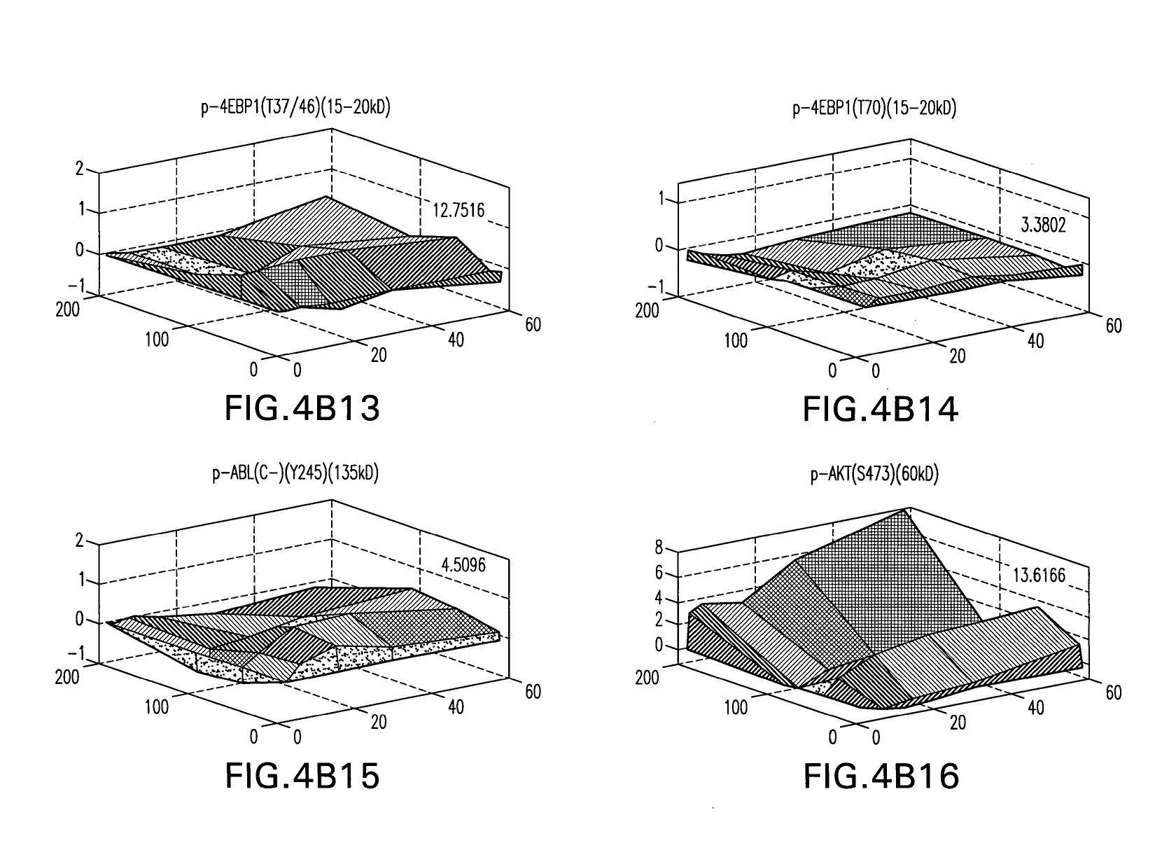

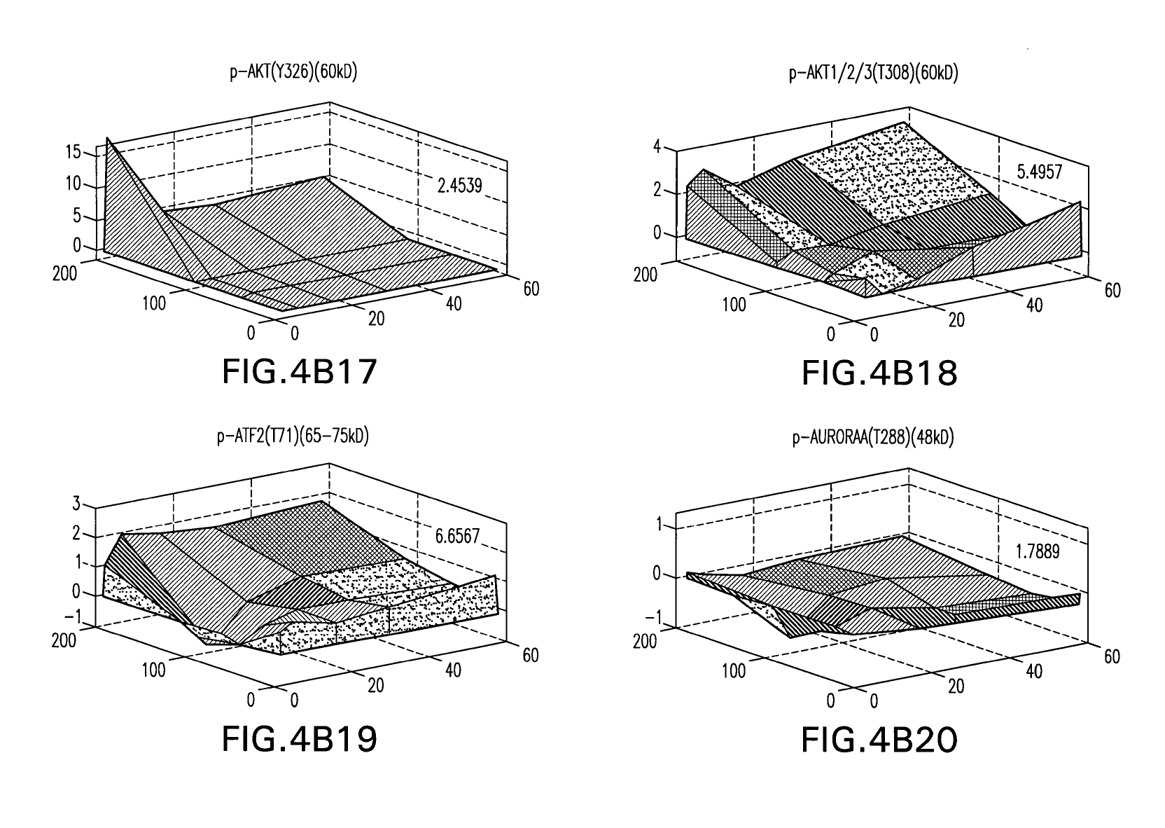

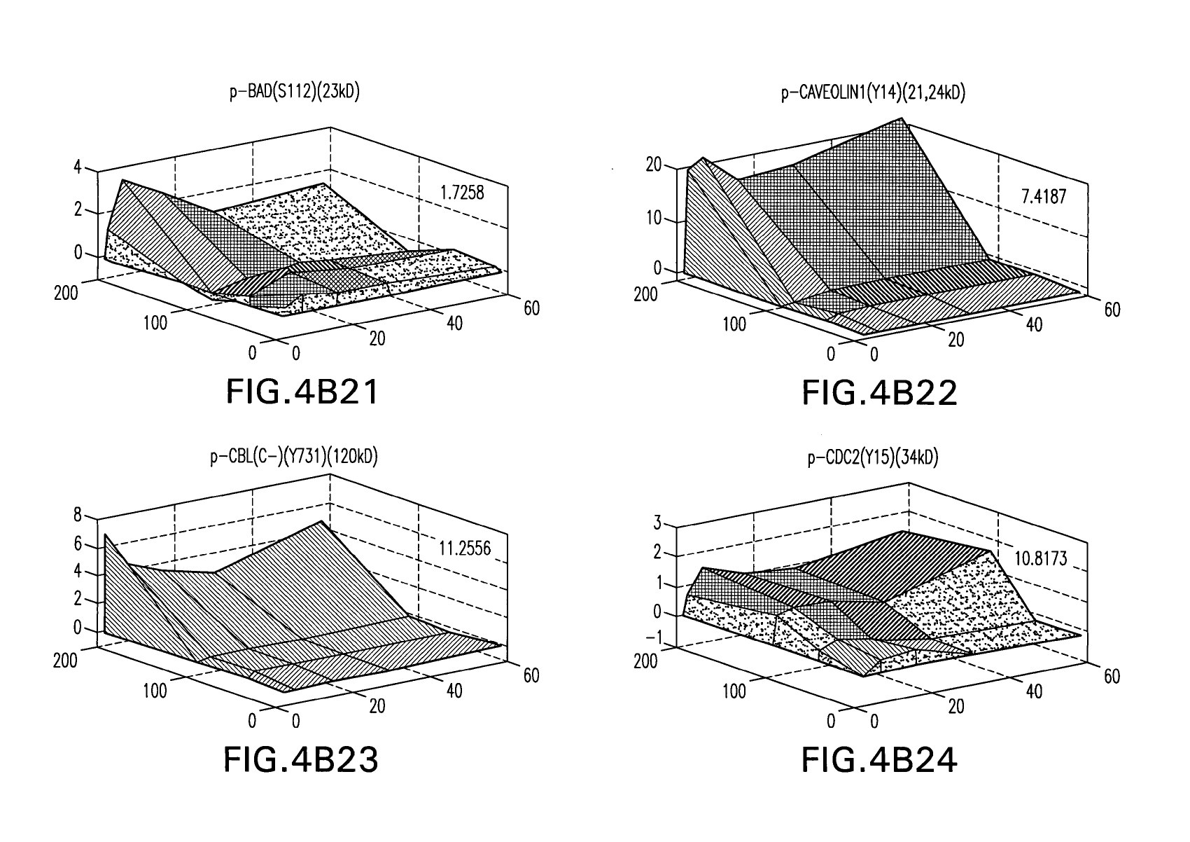

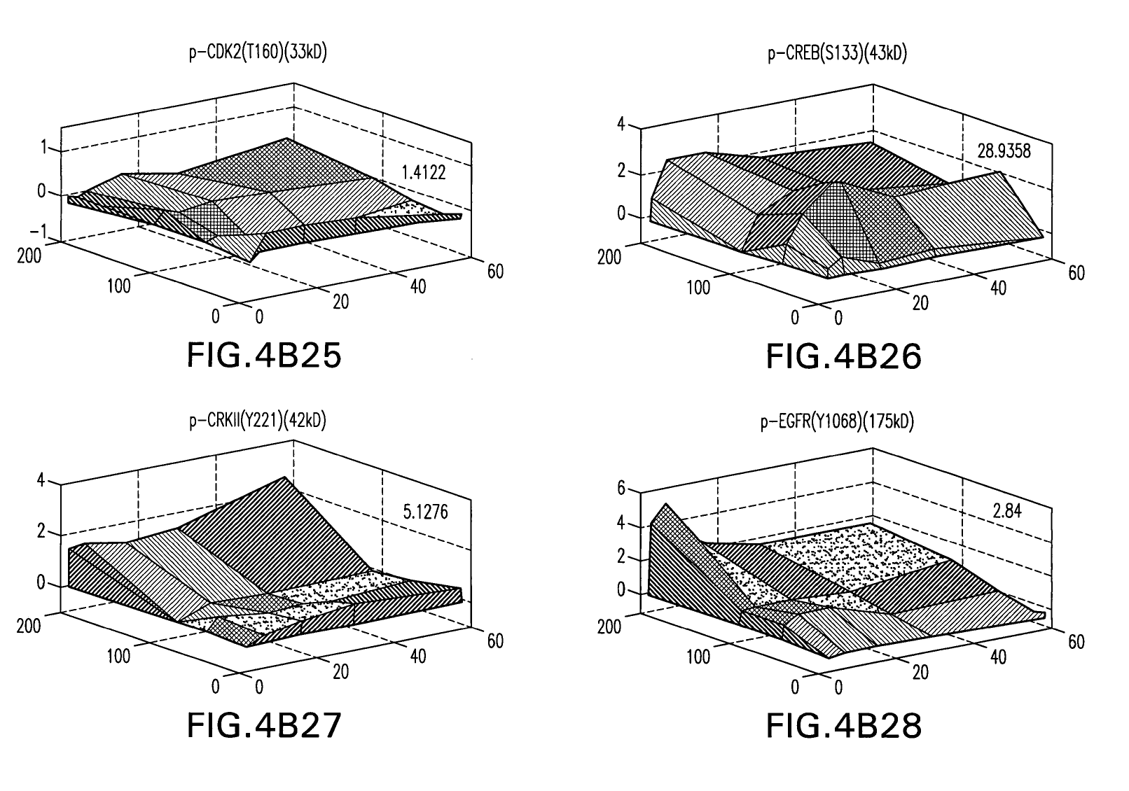

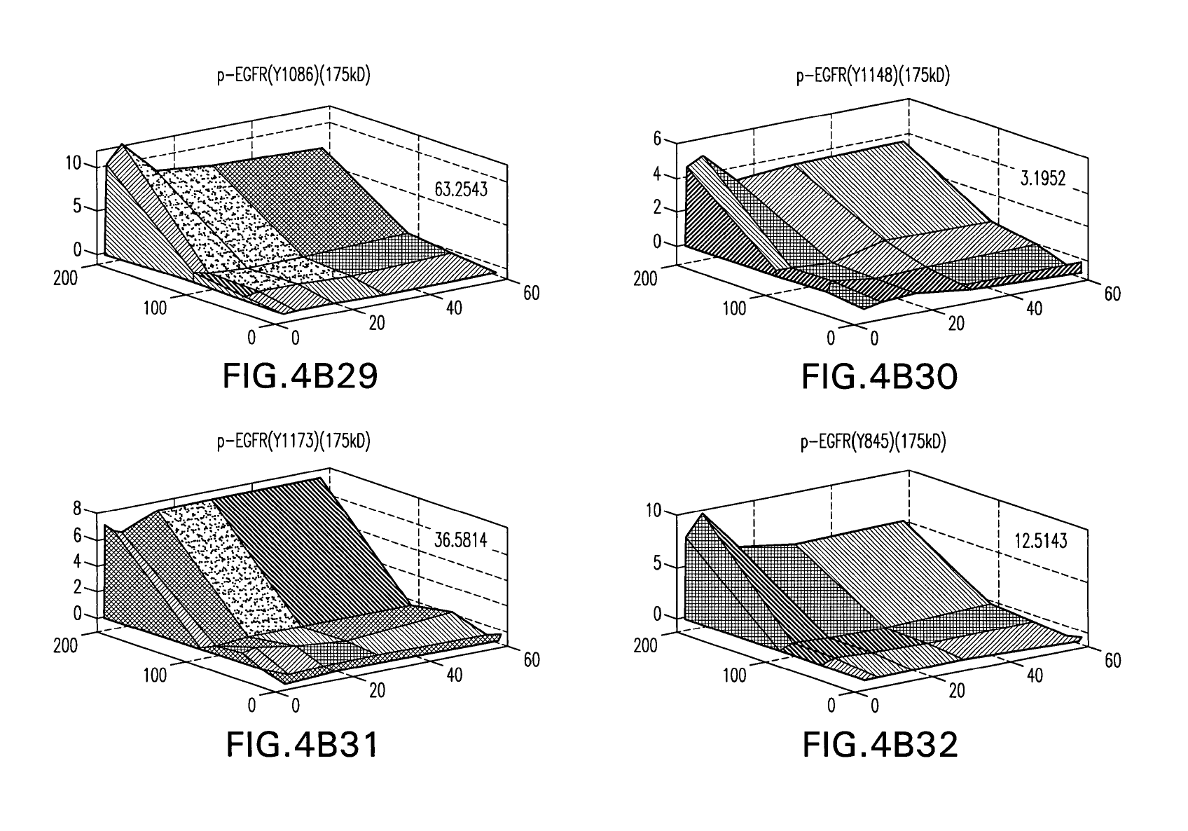

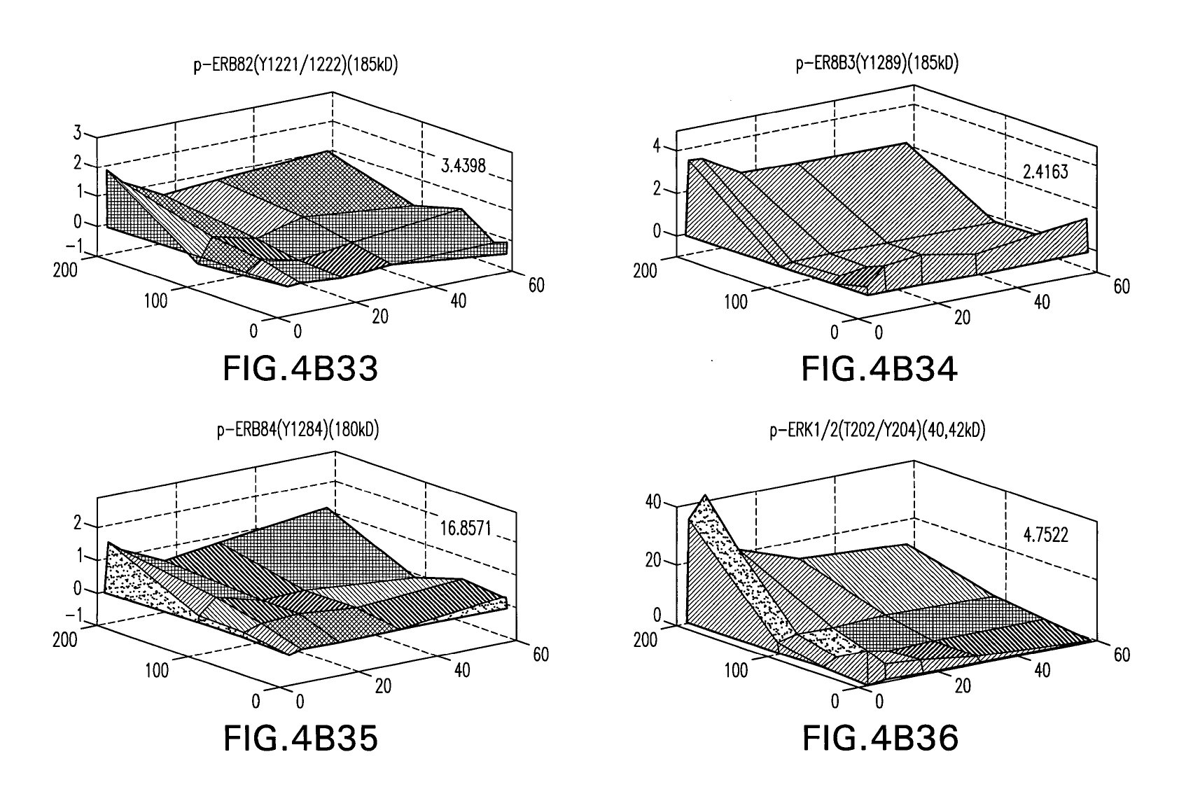

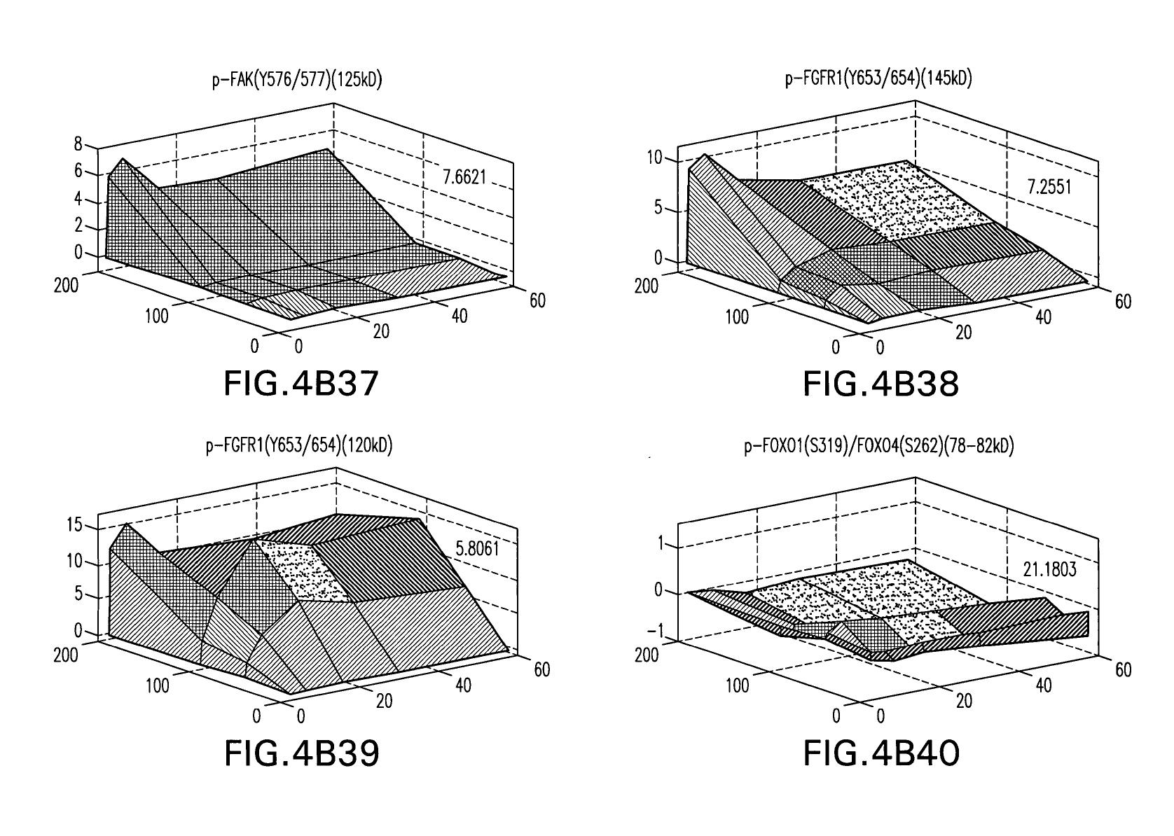

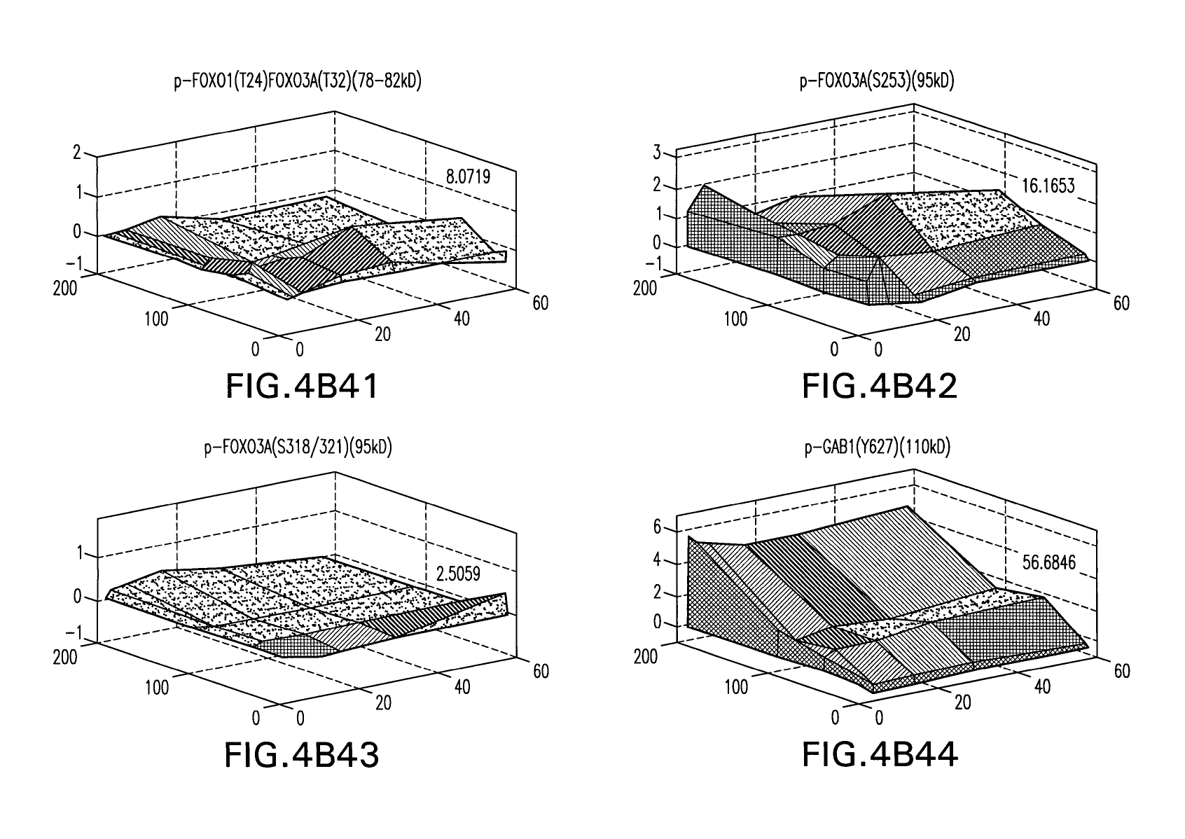

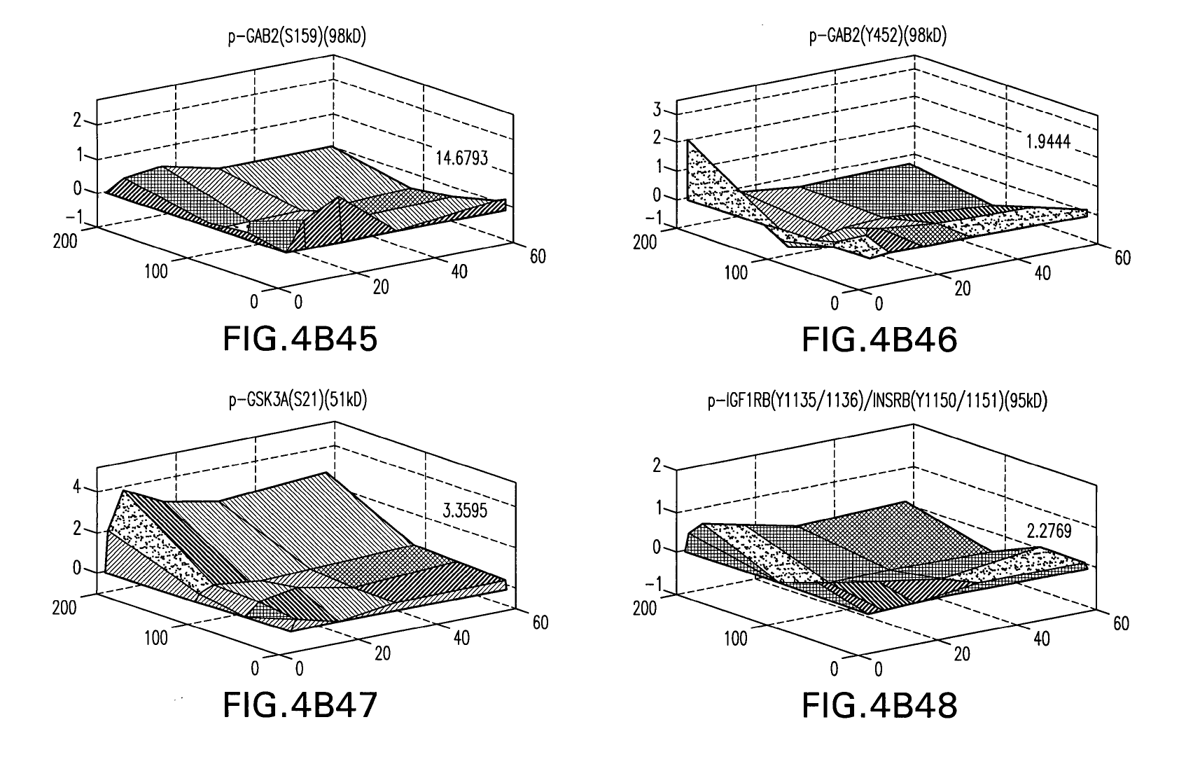

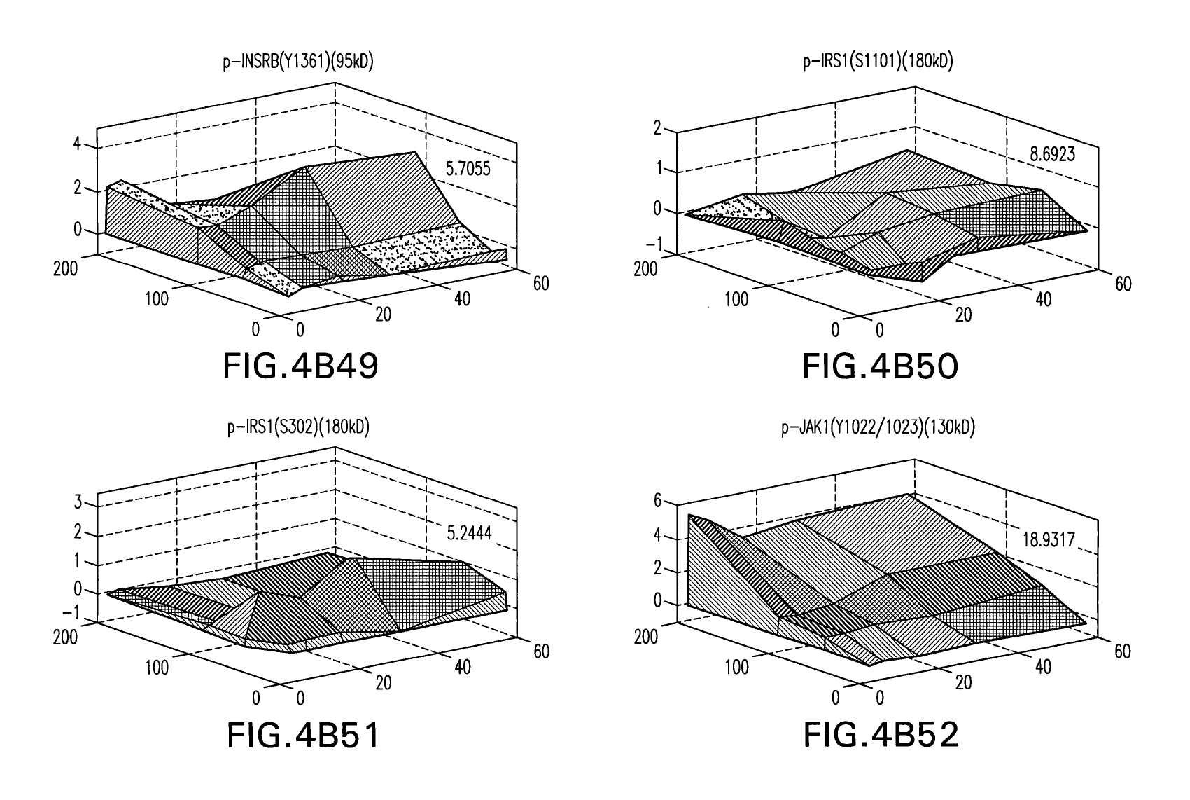

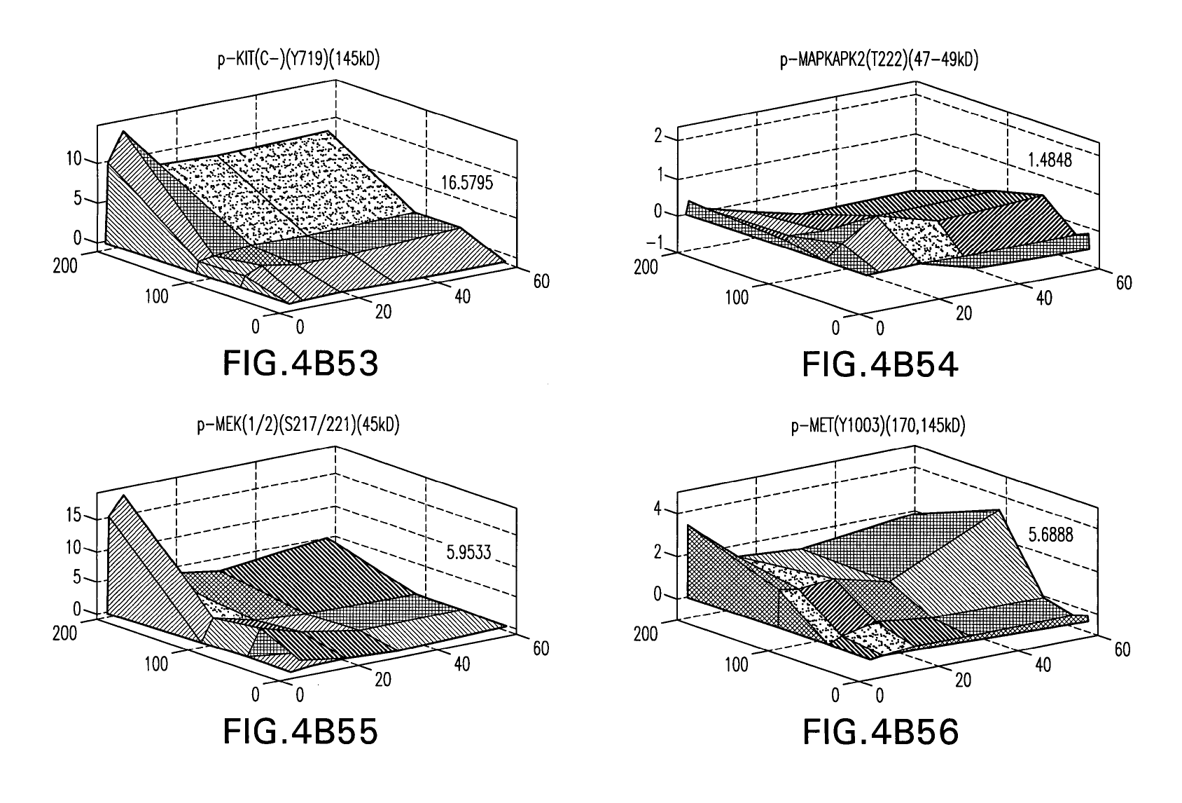

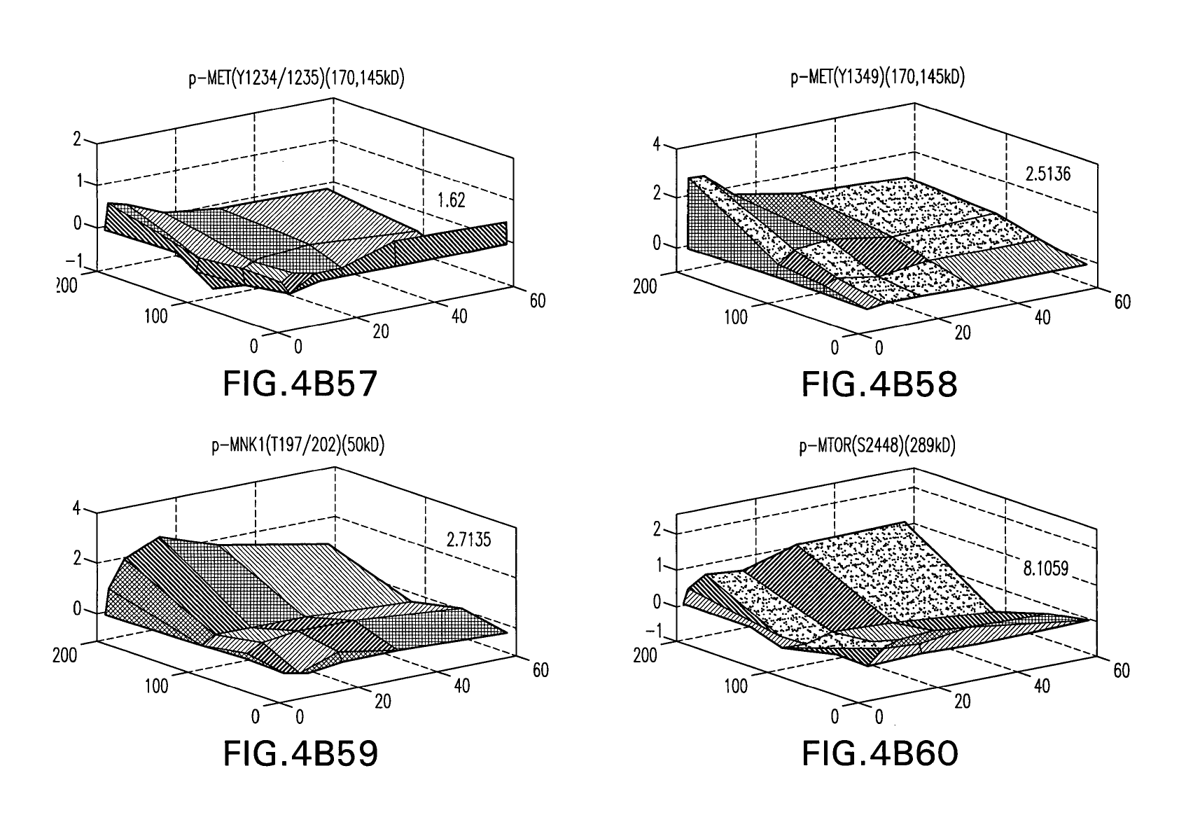

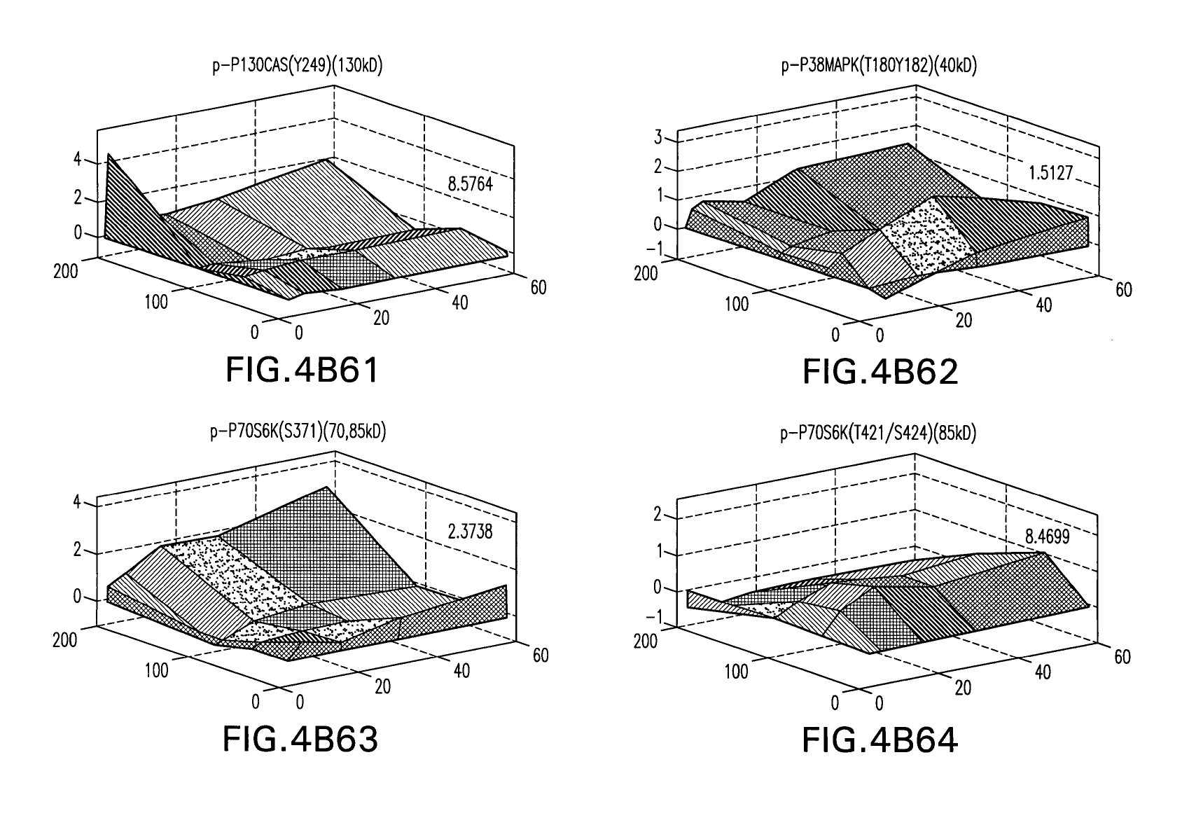

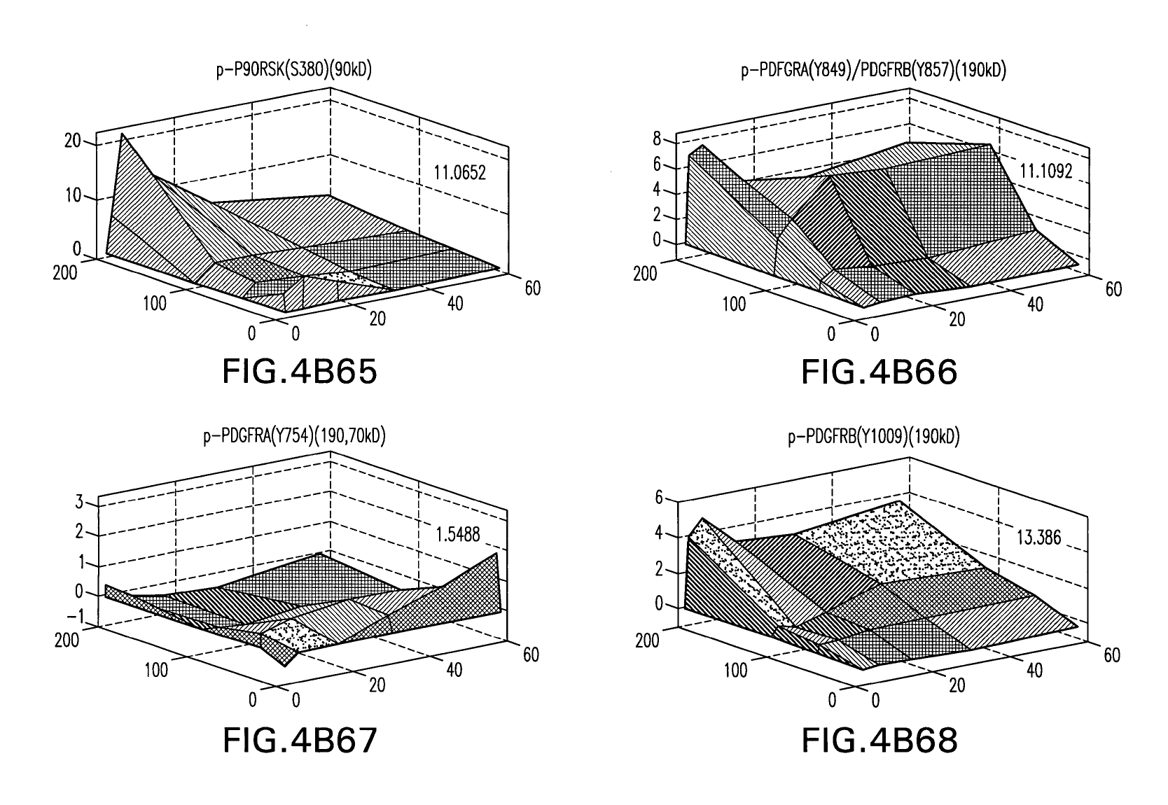

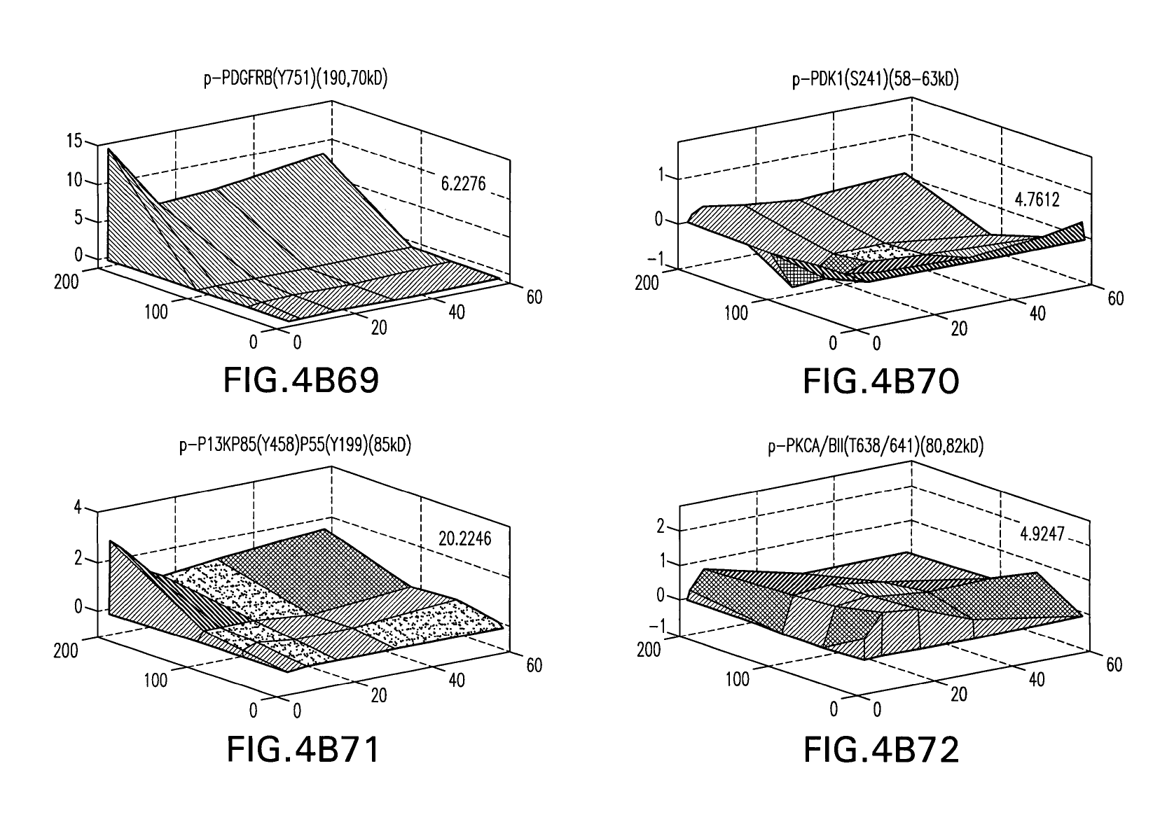

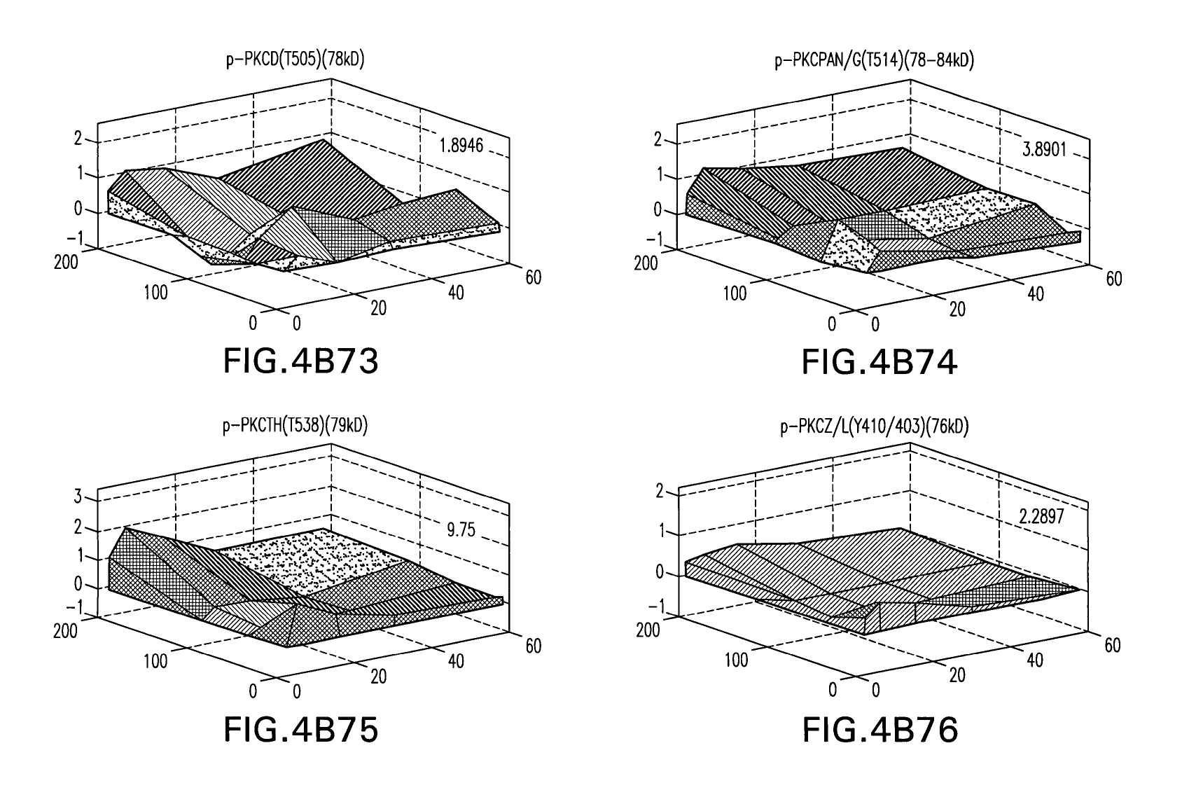

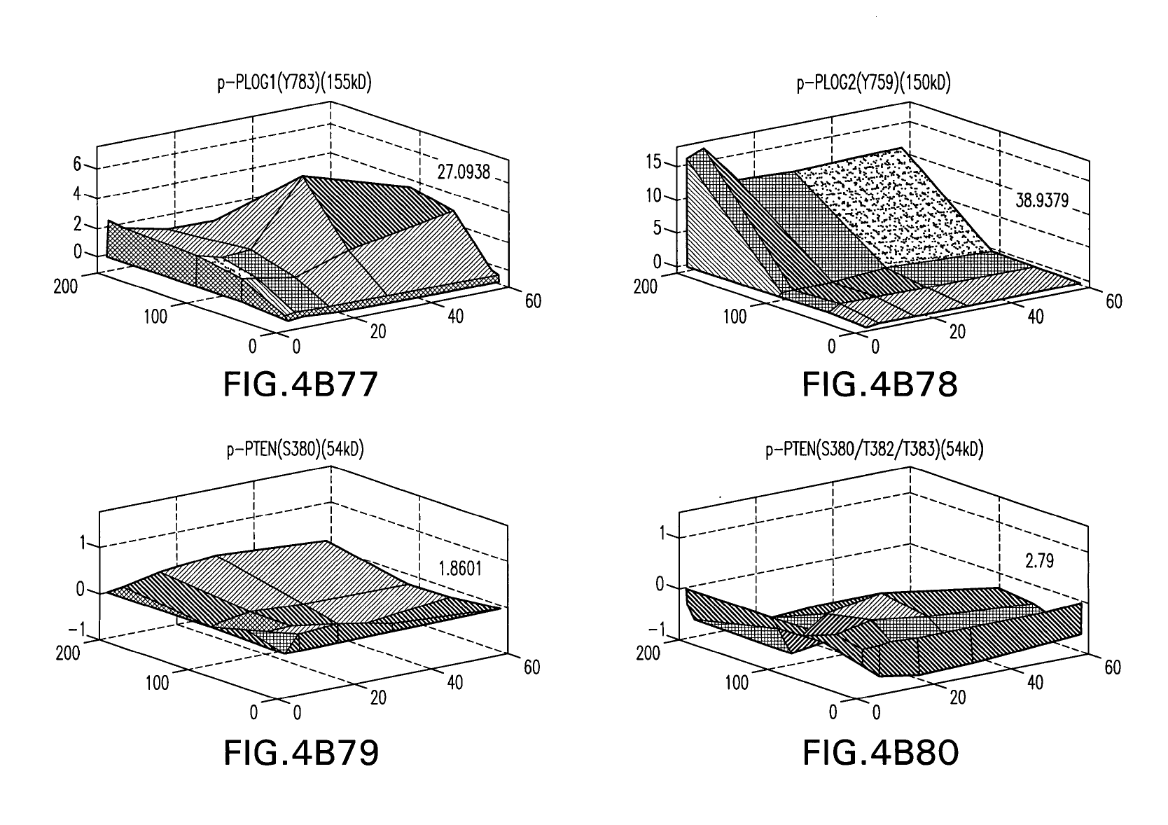

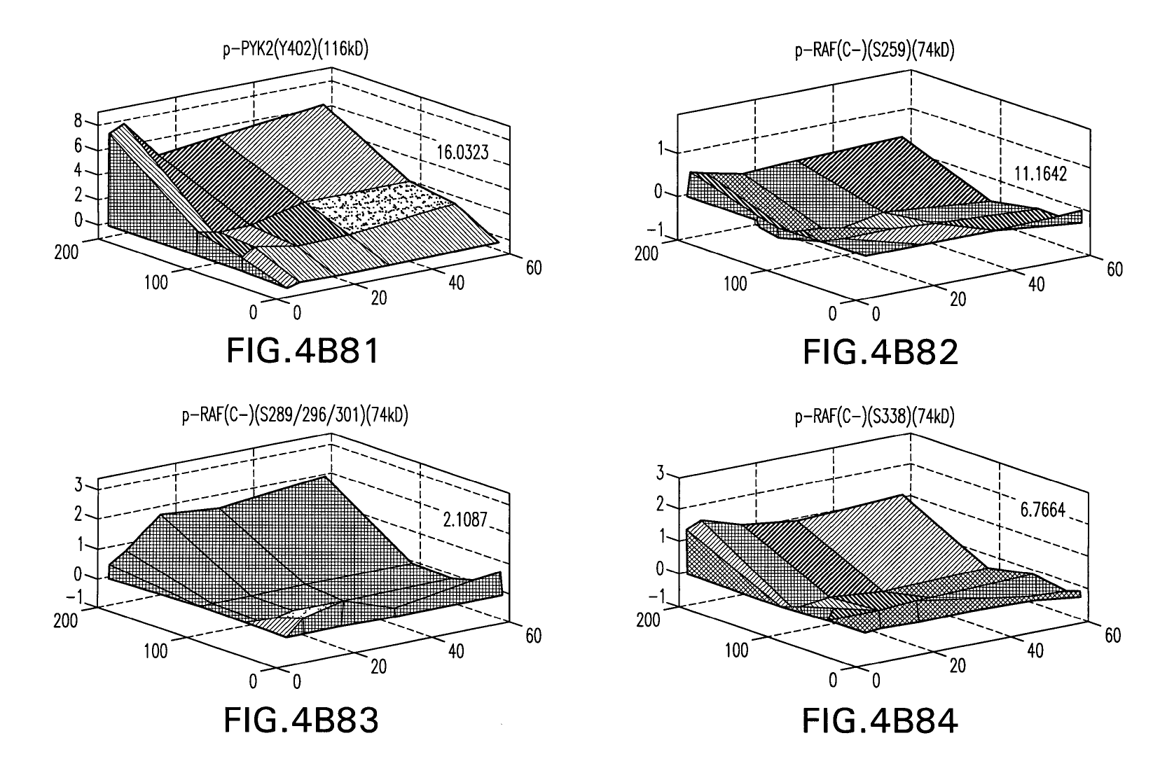

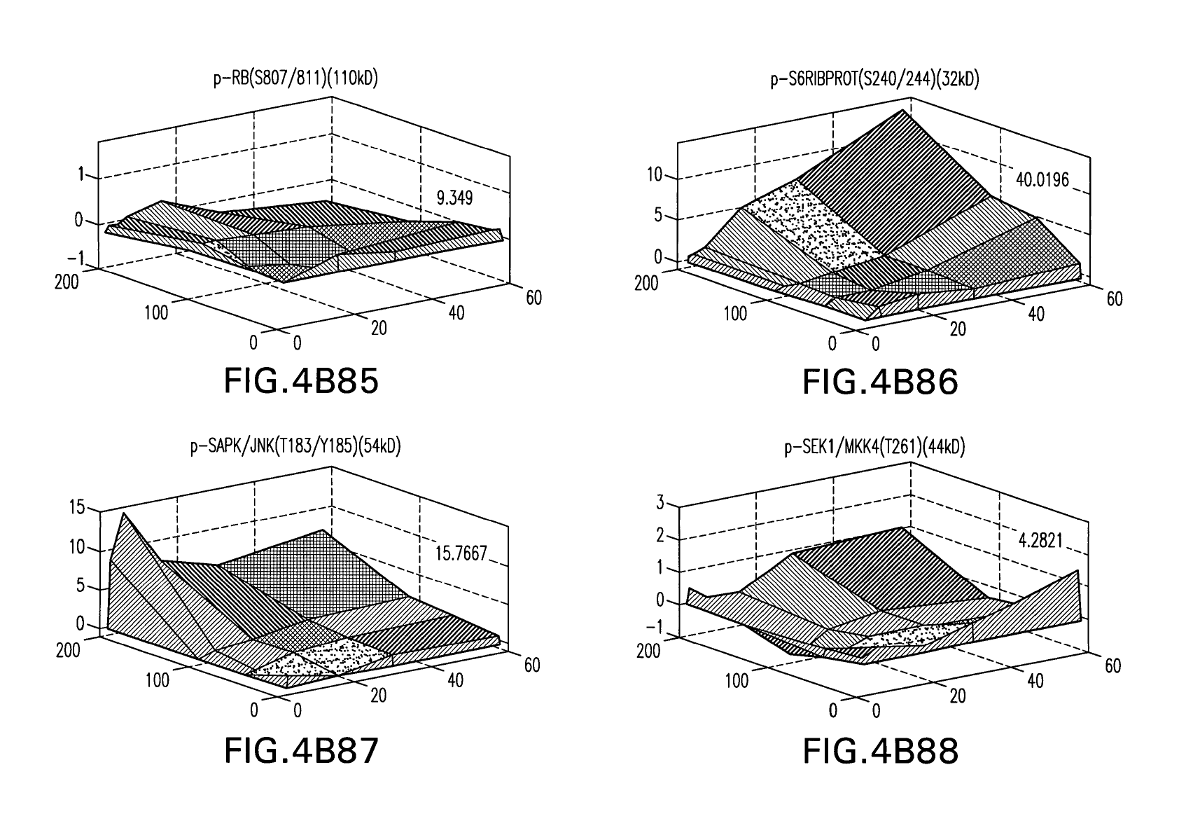

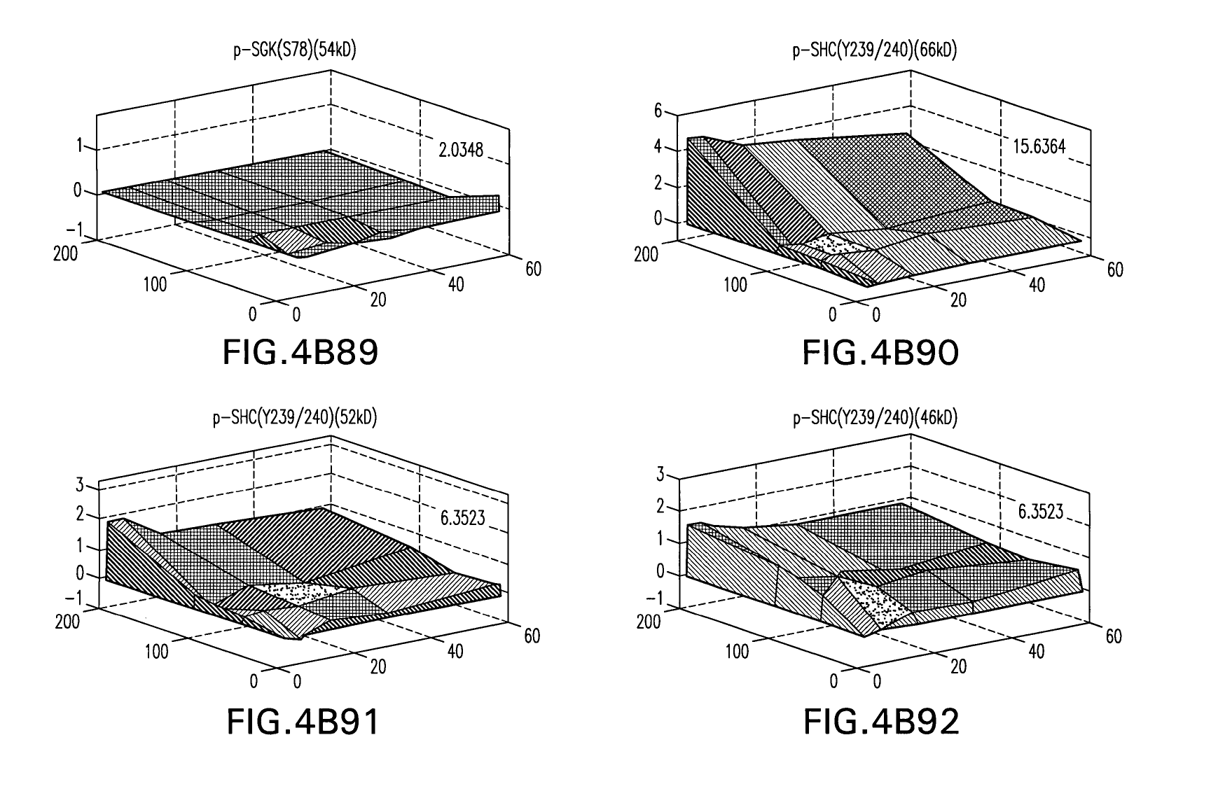

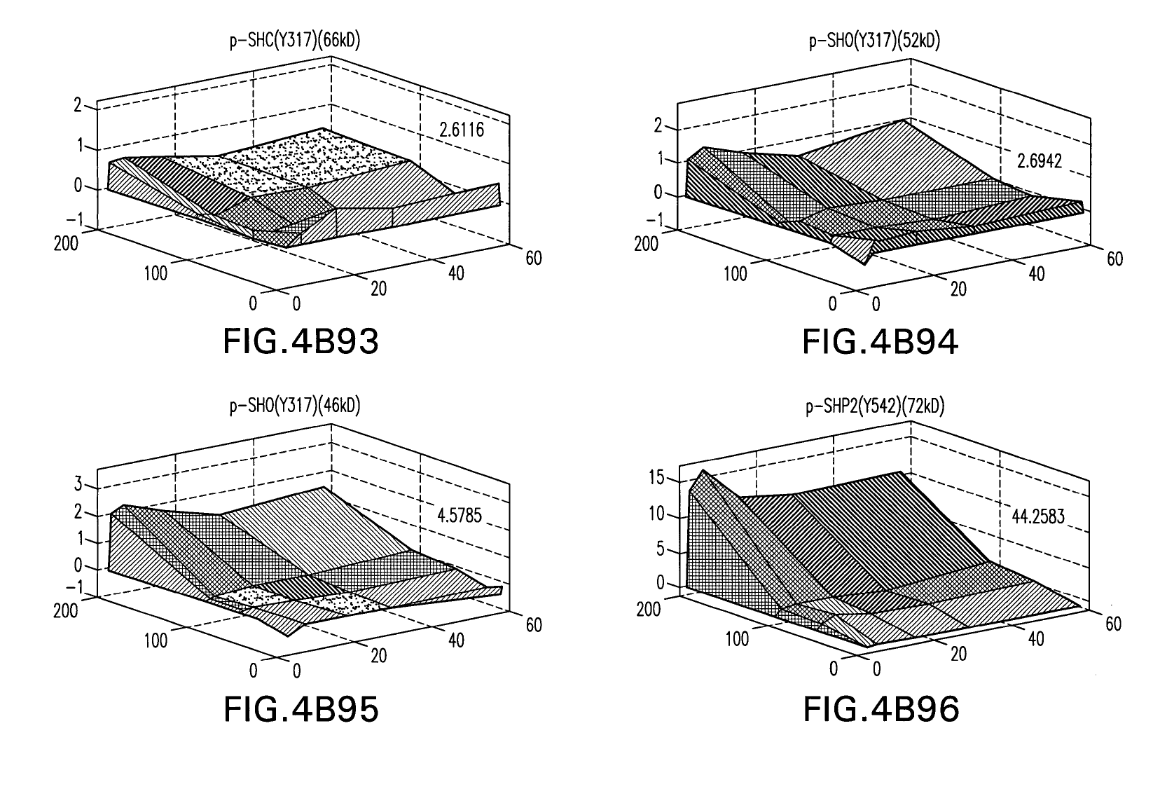

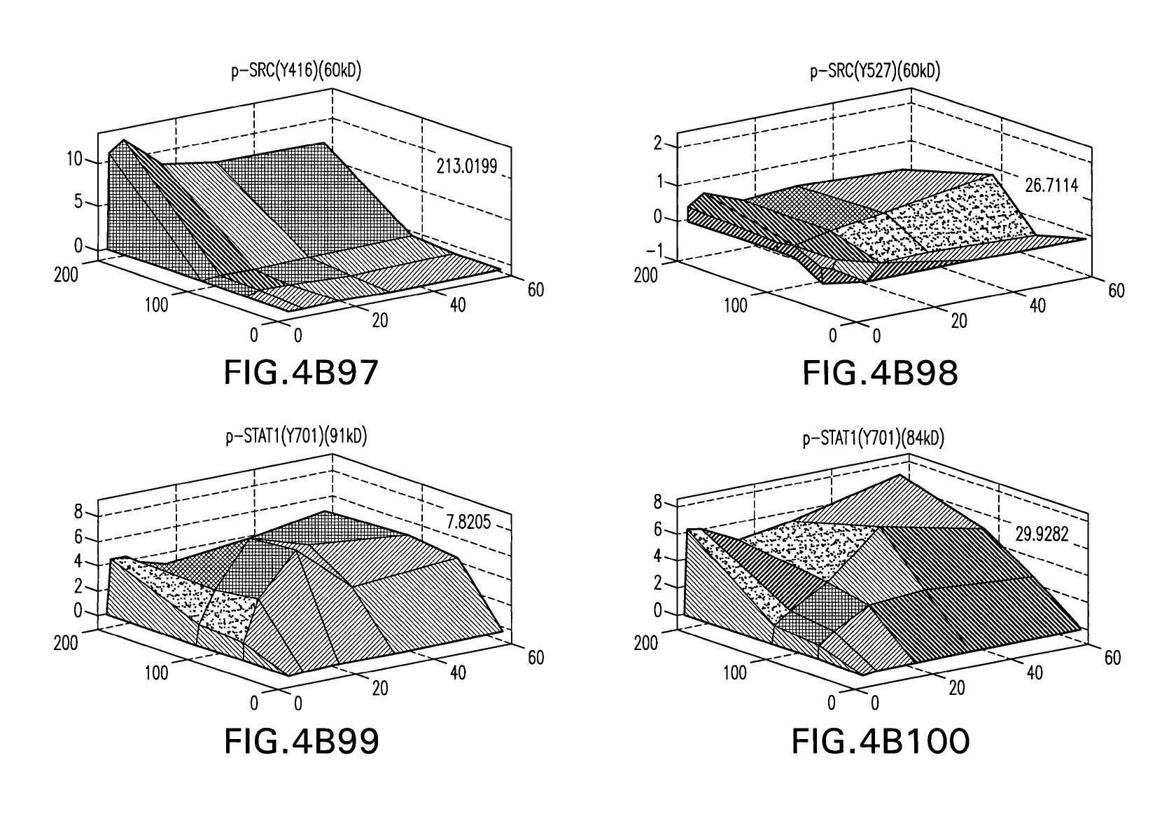

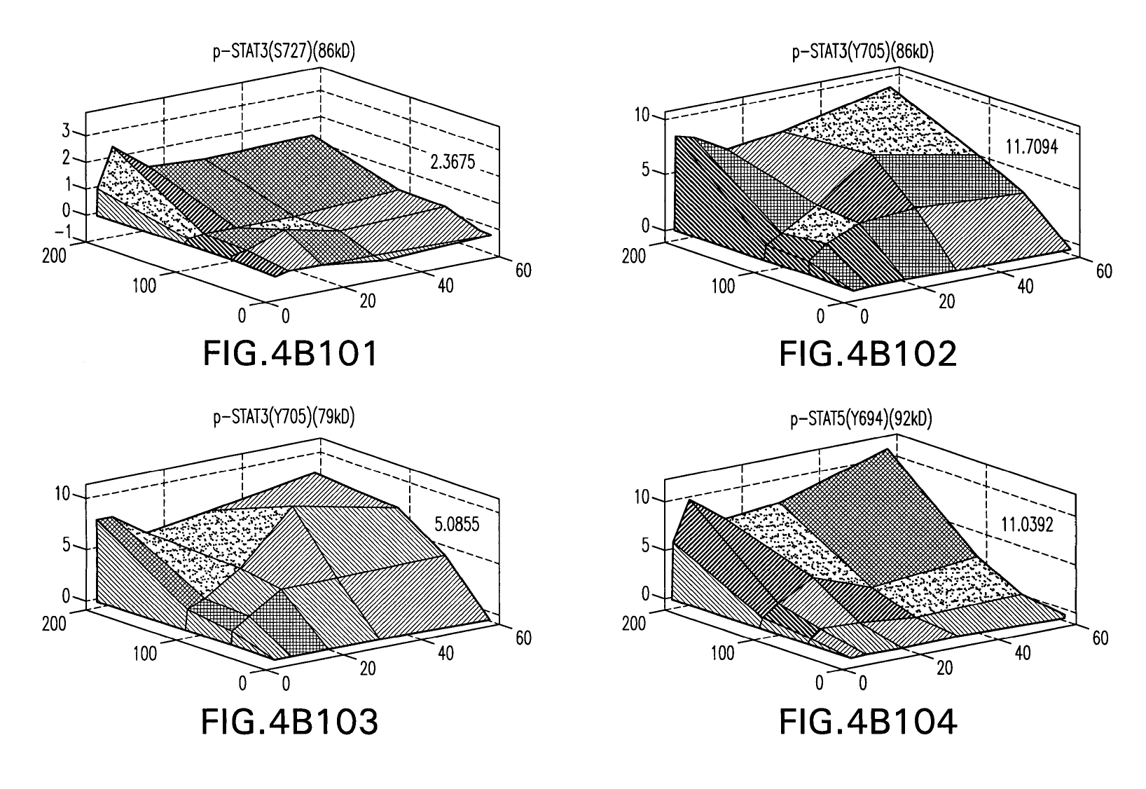

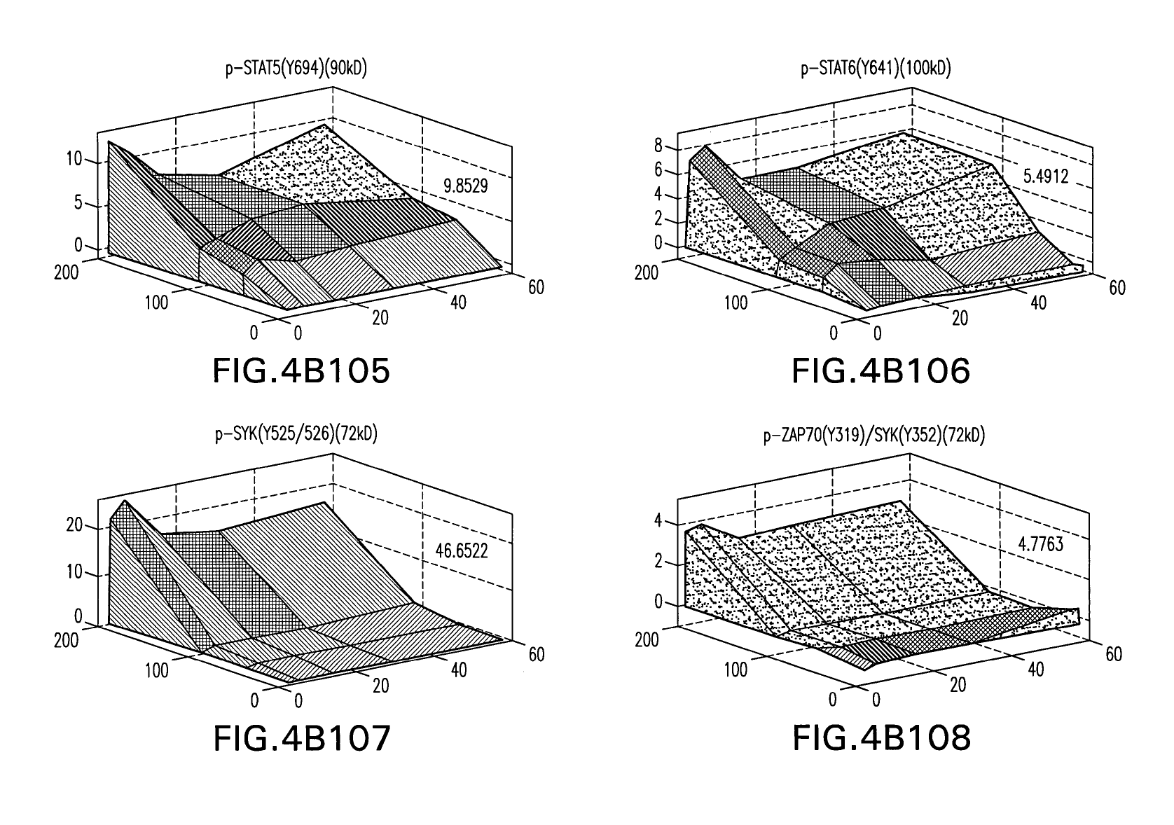

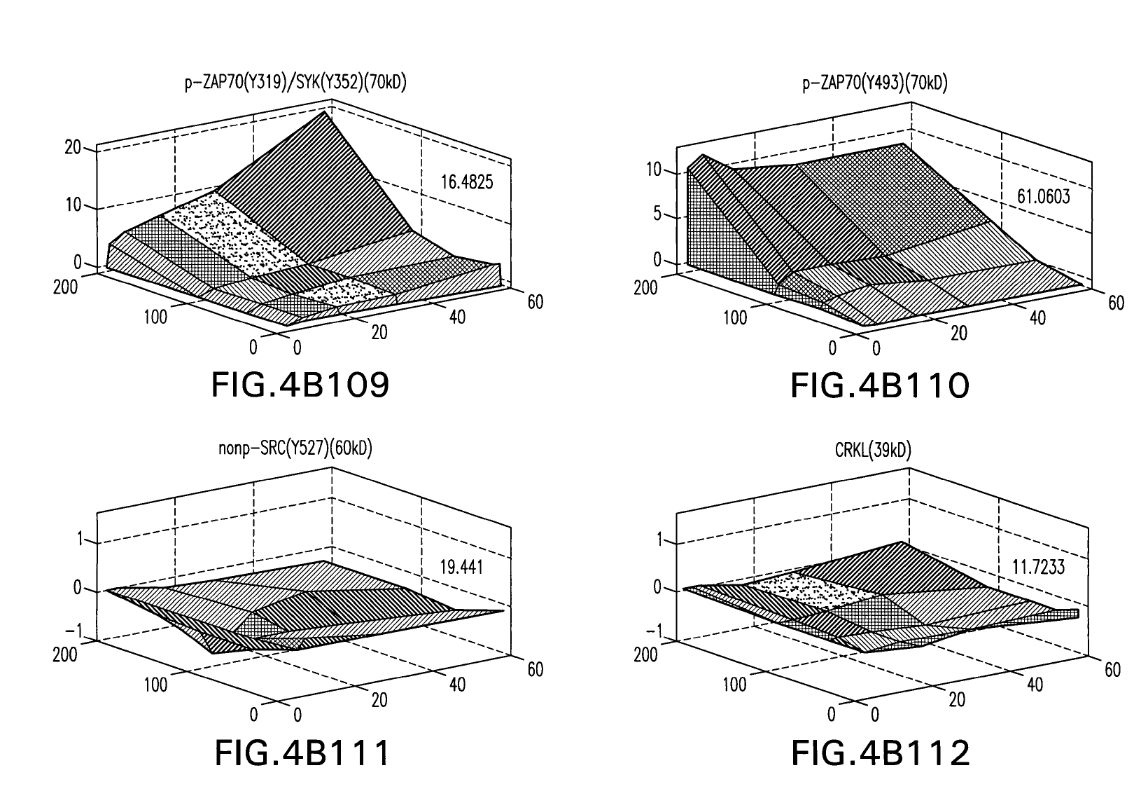

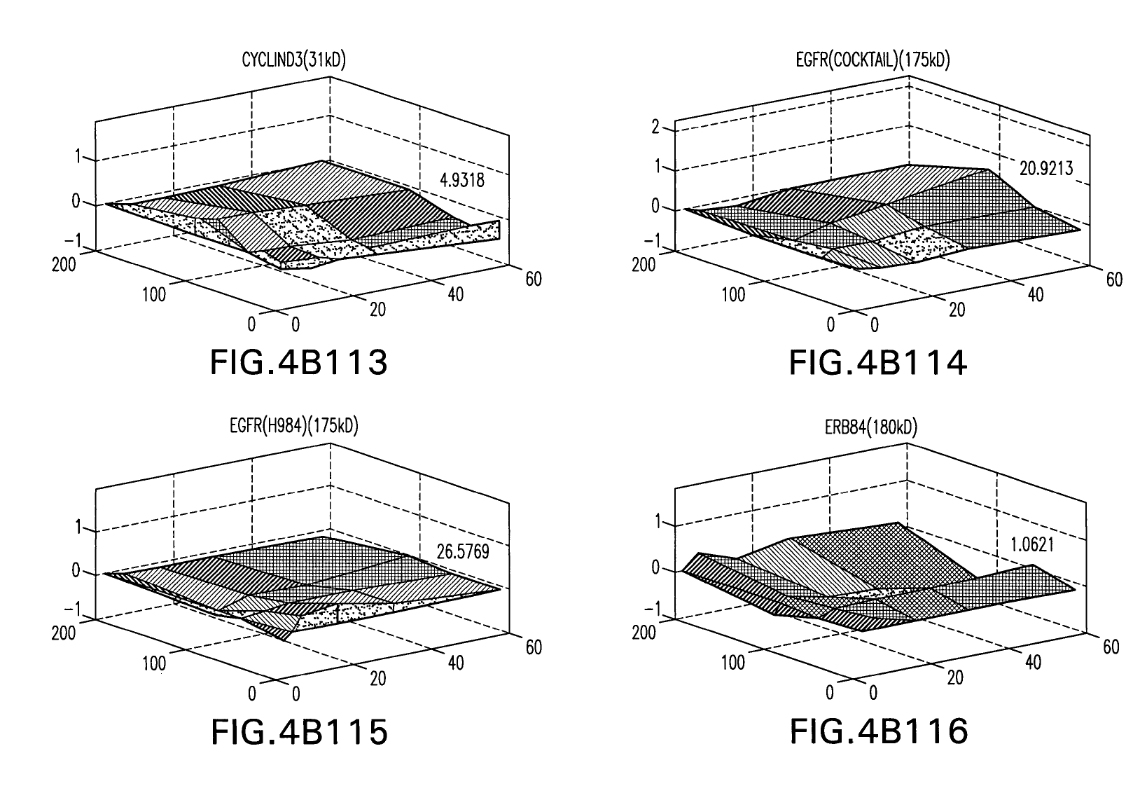

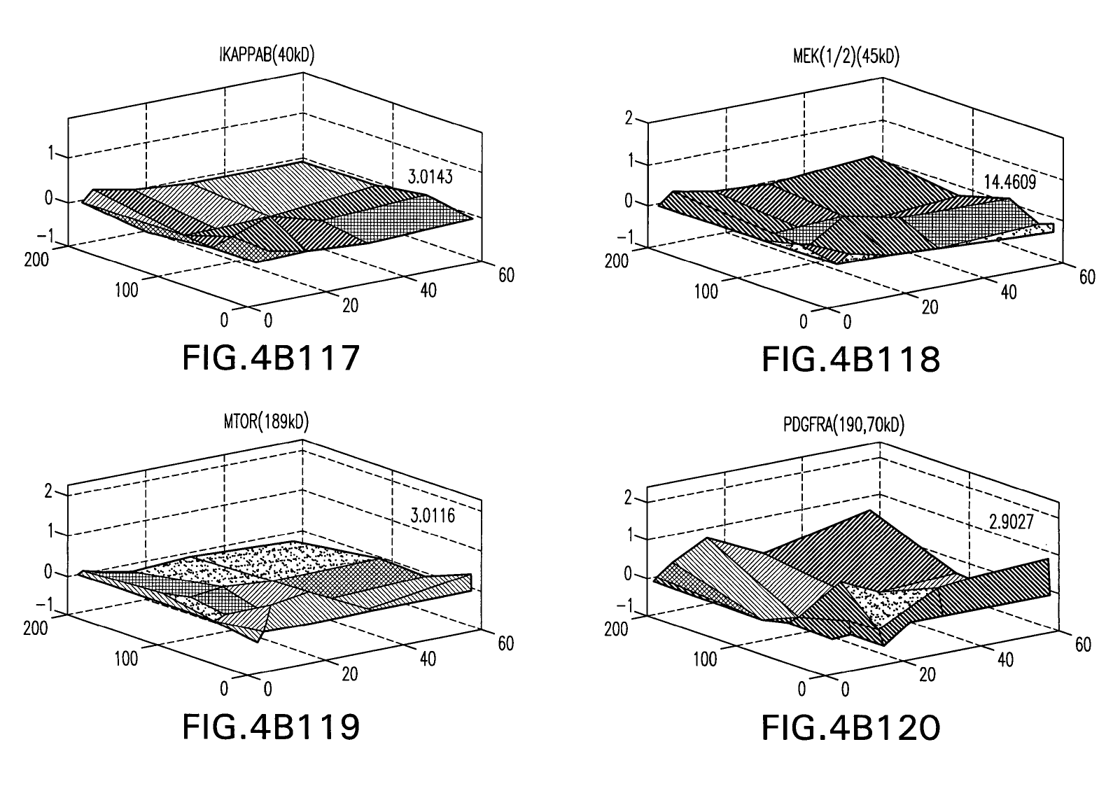

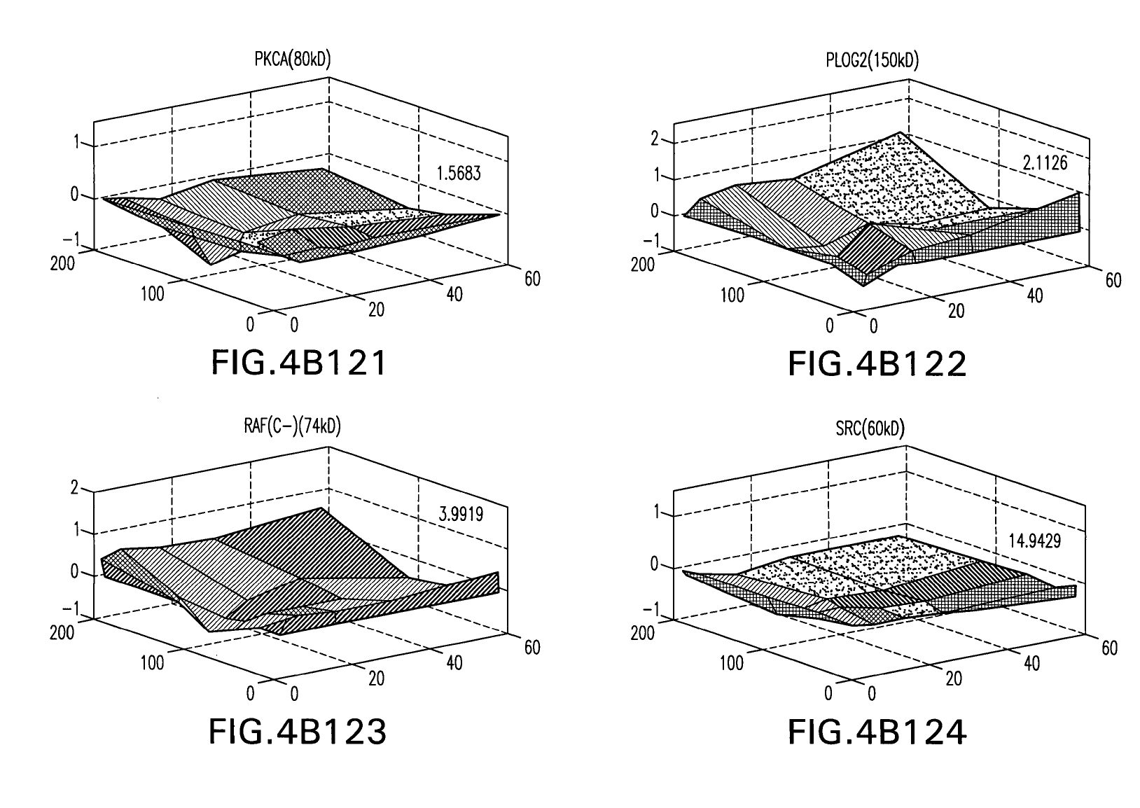

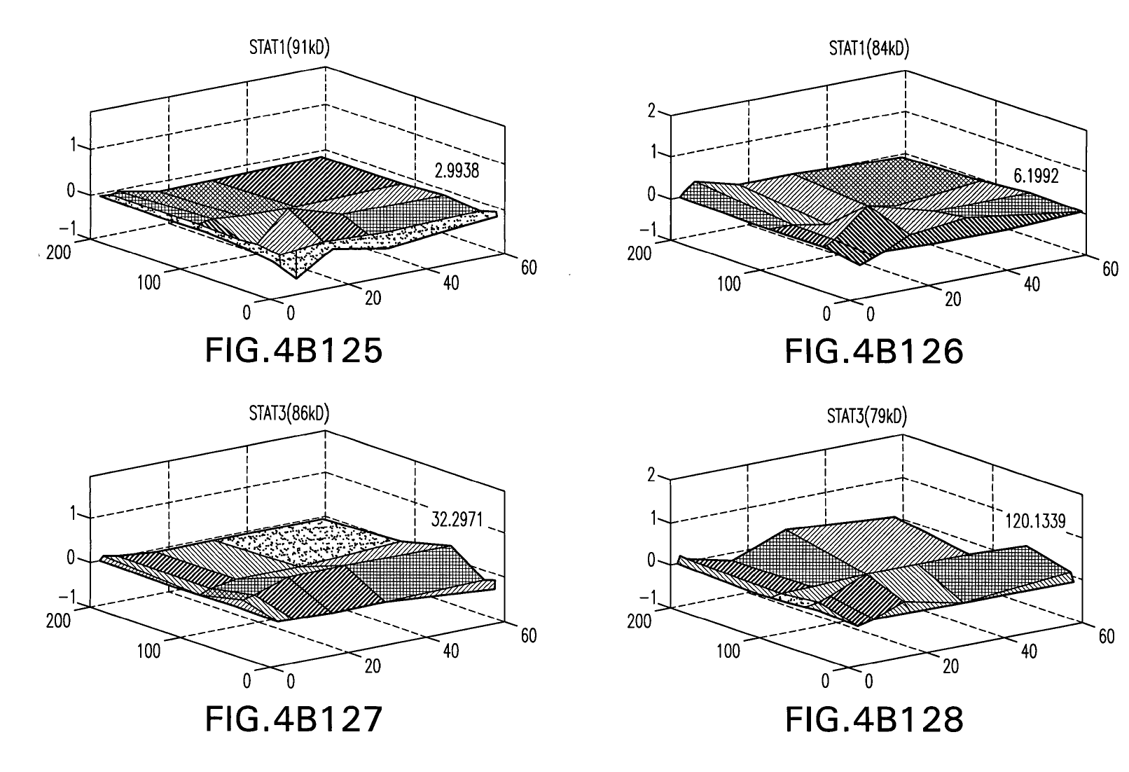

### DETAILED DESCRIPTION OF THE INVENTION

In one embodiment, a lysate microarray platform has been developed for separating protein and other components following the arraying or spotting of samples on a substrate, such as an ultra-thin polyacrylamide gel. This separation step means that any binding moiety useful for a western blot or other ligand interaction study will also be useful for this microblot approach. Typically, tens of nanoliters are printed in an array of spots (e.g., 100 droplets at 350 picoliters/droplets). As used herein, the term “array” refers to an arrangement of entities (e.g., spots of sample) in a pattern on a substrate. The pattern is typically a two-dimensional pattern. The array can be an ordered array where the spots are aligned in at least one direction or an unordered array. In a protein array, the entities are samples comprising at least one protein. In a nucleic acid array, the entities are samples comprising either synthetic or isolated RNA or mRNA, or synthetic or isolated DNA or genomic DNA, typically genomic DNA is restricted or prepared for separation. This method can be at least 100 times as sensitive as the normal lysate array approach and requires no signal amplification step for quantification of most proteins. In certain aspects, a semi-dry horizontal electrophoretic separation is performed followed by a transfer. The transferred material can then be analyzed using binding moieties, such as but not limited to antibodies. Detection and/or visualization can be carried out in a modified multiplexed, microtiter-based format and quantified using any of a variety of detectors or scanners, such as the LI-COR Odyssey™. In certain aspects, a microtiter mask and/or gasket can be used to form wells that allow for multiplexing. Proteins and modification states of proteins from different sample conditions can be analyzed on a single microwestern.

This approach allows for, but is not limited to any particular aspect of, the reduction in complexity of samples via spotting directly onto gels and electrophoretic separation with the multiplexing power of microrarrays; ultra-low reagent usage for both sample (e.g., 400 ng) and binding moiety, such as an antibody (e.g., 250 ng); quantitative scanning of membranes such as infrared-based LI-COR Odyssey™ scanning at a resolution of at least 20 microns, which also may enable two-color imaging of sample and internal control antibodies; allowing quantification of the abundance of any component, nucleic acid, or protein or modification thereof that binds a binding moiety. The microwestern, in effect, abstracts all of the quantitative information from a spot that is normally obtained from a band in a conventional western blot. The inventors have thus far, for example, validated over 60 antibodies for use in the microwestern approach. Following analysis of the abundance and/or modification of components or proteins in one or more signaling networks, molecules or drugs that perturb the networks can be assessed for a response to signal inhibition. It is contemplated that each tissue, cell, or cell line will have common and distinct components and that such perturbations will reveal the relative dependence and/or independence of parallel signaling pathways within the network.

### I. SMALL SCALE BLOTS OR WESTERN BLOTS (MICROWESTERN BLOTS)

In certain aspects the methods and compositions can be used to assess at least, at most, or about 1, 2, 3, 4, 5, 10, 15, 20, 25, 30, 35, 40, 45, 50, 55, 60, 65, 70, 75, 80, 85, 90, 95, 100 or more binding moieties, including all values and ranges there between, that can be applied individually or in various combinations to an electrophoretically separated sample on a substrate. Sample blocks (groupings of sample lanes) can comprise at least, at most or about 1, 2, 3, 4, 5, 6, 7, 8, 9, 10 or more samples within a sample block. In certain aspects, samples can be spotted linearly at a density of at least, at most, or about 10, 15, 20, 25 or more spots, including all values and ranges there between, per centimeter.

Gels and blots of the invention may be used to compare various biological states, samples or protein samples. For instance, the presence, absence, and/or amount of one or more ligands of a binding moiety can be evaluated by detecting the level and/or differences in binding when a gel or blot is exposed to one or more binding moieties. In certain aspects, the size(s), level of expression of a protein and/or the level of post-translational modification can be assessed.

Another embodiment of the invention relates to the use of two or more sample blocks or sample lanes within a sample block for comparing the presence, absence and/or amount of one or more ligand or target molecule in a first and a second sample when the source of the first sample block or sample has been differentially exposed to a molecule, treatment, and/or condition relative to the source of the second sample.

In an aspect of the invention, multiple binding moieties applied to the same sample block may be differentially detected with different first, second, third, fourth or more reporters, or as many different reporters or reporter combinations as there are binding moieties employed.

The first biological sample or sample source may be from a diseased, abnormal, or pathologic (generally referred to as diseased) cell type and the second biological sample may be from a corresponding cell type unaffected by the disease; or the first and second samples may be from a similar sample type with the first sample being derived from a sample at rest or non-stimulated and a second sample being derived from a sample that is activated or stimulated, making the uses of the invention advantageous in methods of studying protein expression and activation.

Labeling of a binding moiety or a ligand with detectable labels other than infrared labels is also possible and well within the knowledge of skilled persons. The use of any detectable labels is intended to fall within the scope of the invention. In addition, the invention is intended to embrace other systems for detecting binding, including systems based on changes in electrical conductivity or plasmon resonance, using for example nanoelectrodes (WO 99/24823) or biosensors.

A. Preparation of Microwestern Blots

In one aspect a polyacrylamide gel can be used. In certain embodiments of the invention the PAGE gel is capable of separating at least, at most, or about 48, 50, 60, 70, 80, 90, 100, 1,000, 10,000 or more samples per gel. In certain aspects, a 24 cm×11 cm 10% tris-acetate gel (0.24 M Tris-Acetate pH 6.8, 0.1% SDS, and 20% v/v glycerol) for SDS-PAGE having a thickness of 0.4 mm can be used. In a further aspect, a nylon mesh fabric with an acryl-linker can be incorporated into the gel matrix during polymerization (Net-Fix® for PAG, Serva 42775) to provide tensile strength. In a further aspect, after polymerization the gel can be divided in two and a single 12 cm×11 cm gel loaded on to the arraying platform such as the GeSim Noncontact Arrayer.

In one aspect of the invention multiple samples may be loaded or spotted at once. For example, a chamber of the arraying device can be held at a constant humidity (e.g., at least, at most, or about 70, 75, 80, 85, 90, 95% humidity, including all values and ranges there between) throughout printing at about 10, 15, 20, 25, or 30° C., including all values and ranges there between. In a further aspect, lysate samples can be transferred from a multiwell plate or container, e.g., a 384 well plate, to the gel with an automated transfer file (e.g., Software: GeSim NPC16) using a microfluid handler. Samples can be arrayed in a variety of formats, such as an 8×12 block format with up to 12 unique samples loaded per block with a separation of 0.75 mm between each sample. In certain aspects, the transfer file can specify at least, at most, or about 5, 10, 15, or 20 consecutive droplets of lysate per location per run with each drop having approximately 100, 200, 300 or 400 pL of sample, including all values and ranges there between. The transfer file can be run a number times (e.g., 2, 3, 4, 5, 6, 7, 8, 9, or more times), causing the spots to be overlayed on the gel, thereby increasing the local density of protein per area, for example giving a total volume of lysate of 54 mL per block and 5.2 μL, for a 96-block microwestern.

After printing, a gel can be incubated in rehydration buffer (such as 0.40 M Tris-acetate pH 6.8, 20% Glycerol, 0.1% SDS, 1:20 DTT, 1:20 Sodium Bisulfite) for a specified time period (1, 2, 3, 4, 5, 6, 7, 8, 9, 10 or more minutes). After rehydration, a printed gel can be placed on an electrophoresis system, such as the GenePhor™ Horizontal Electrophoresis System by Pharmacia, on a plastic backing (e.g., Gel-fix® for Covers, Serva 42957), typically with a thin coat of kerosene or other material beneath the sheet to provide a uniform temperature transfer between the gel and the cooling plate. Contact between the lateral edges of the gel and the electrodes can be maintained with a stack of thick blotting paper wetted in electrode buffer. The gel can be run at a constant voltage and wattage until the dye front of the lysate has migrated an appropriate distance (e.g., 0.5, 0.6, 0.7, 0.8, 0.9, 1, 1.1, 1.2 cm or more).

In certain aspects, a gel or a blot comprises at least 10, 20, 25, or 50 samples/cm as aligned along a first direction that is typically perpendicular to the direction of separation. Additional samples can be stacked parallel to a first row of samples, e.g., vertically stacked. Furthermore, the gel or blot can include, in certain illustrative examples, at least 100, 250, 500, 1000, 2500, 5000, or 10,000 different samples.

In certain aspects the samples can be bound non-covalently to a substrate (e.g., by adsorption). Components that are non-covalently bound to the substrate can be attached to the surface of the substrate by a variety of molecular interactions such as, for example, hydrogen bonding, van der Waals bonding, electrostatic, or metal-chelate coordinate bonding. In a particular embodiment, proteins are bound to a poly-lysine coated surface of the solid support. In addition, proteins can be bound to a silane (e.g., sianosilane, thiosilane, aminosilane, etc.) coated surface of substrate. In addition, crosslinking compounds commonly known in the art, e.g., homo- or heterofunctional crosslinking compounds (e.g., bis[sulfosuccinimidyl]suberate, N-[gamma-maleimidobutyryloxy]succinimide ester, or 1-ethyl-3-[3-dimethylaminopropyl]carbodiimide), may be used to attach proteins to the substrate via covalent or non-covalent interactions. In other aspects, the sample components can be immobilized within the substrate, e.g., a dehydrated gel.

B. Probing and Detection

In certain aspects of the invention, a microwestern blot can be used to detect as little as 5 fg. The microwestern blot can also be use to detect at least, at most, or about 0.01, 0.1, 0.5, 1, 5, 10, 20, 30, 40, 50, 60, 70, 80, 90, 100 pg, μg, or ng of protein per lane, including all values and ranges there between.

Samples are typically transferred to a substrate (e.g., nitrocellulose membrane) using a transfer tank, such as the BioRad Criterion transfer tank. A blot can be blocked using an appropriate protein solution such as 100% LI-COR Odyssey Blocking Buffer (LI-COR 927-40000), caesin, or non-fat dry milk, for a designated period of time. A substrate is typically placed or operably coupled to a gasket to form sample wells, for example a 96-well sealed gasket (The Gel Company AHT96-01) can be used. Typically, each transferred block is aligned with a gasket well. Primary antibody or other binding moiety is diluted in an appropriate buffer and placed in a well of the gasket. The substrate is typically incubated without agitation at a reduced temperature (2, 4, 6, or 8° C.) for a period of time (at least, at most, or about 1, 2, 4, 8, 12, 24, 48, 56 or more hours, including all values and ranges there between). The substrate is washed. Typically, after washing the primary antibody or binding moiety is detected, if detectable or contains a detectable label. In certain examples, a binding moiety is labeled with a detectable label, or the binding moiety interacts with a second binding moiety that is labeled, or the binding moiety is directly detectable.

Examples of a binding moiety include any reagent such as, but not limited to, an antibody, a protein, a nucleic acid (e.g., DNA, RNA, an oligonucleotide, a polynucleotide), small molecule, substrate, inhibitor, drug or drug candidate, receptor, antigen, hormone, steroid, lipid, phospholipid, liposome, antibody, cofactor, cytokine, glutathione, immunoglobulin domain, carbohydrate, nickel, biotin, lectin, and heavy metal that can be applied to a gel or a blot of the invention to assay for interaction with a component of a sample. If a binding moiety is not detectable a secondary reagent is applied to enable detection of the binding moiety, e.g., Anti-mouse Invitrogen Alexa-fluor 680 (1:5000) and/or Anti-rabbit Invitrogen Alexa-fluor 680 (1:5000) fluorescent conjugated secondary antibody diluted in a binding buffer. The secondary reagent is added to each well depending on the identity of the binding moiety. The substrate is typically washed to remove any non-specifically bound primary or secondary reagents. In certain aspects, the substrate is dehydrated before scanning.

A “binding moiety” is a molecule or macromolecule that binds selectively (bind a first moiety to a detectably different degree than a second) or specifically (binds a first moiety and has no detectable binding to other moieties) to another moiety, such as another molecule, macromolecule, cell, tissue, etc. A binding moiety can include, but is not limited to small molecules (drugs, enzymatic substrates, modulators of protein function, hormones, steroids, metabolites, etc.), antibodies (including monoclonal and polyclonal), antibody fragments (e.g., single chain antibodies and F(ab′)₂, Fab′ and Fab fragments), peptides, polypeptides, nucleic acids (e.g., aptamers), proteins, synthetic polymers, lipids, lectins, avidin, ligands, receptors, and carbohydrates.

Detection of binding moieties can be done by interrogating a reporter molecule associated with a binding moiety. The reporter can be directly or indirectly associated with a binding moiety and may be covalently or non-covalently coupled to the target to be detected. In certain aspects, the reporter is detectable by interrogation with infrared light, i.e., an infrared reporter. In certain embodiments, the label itself provides a signal (e.g., if the label is a fluorophore) or the label is capable of catalyzing a reaction that generates a detectable signal, in other specific embodiments, the label is detected using a detectably labeled molecule that binds to the label. The detectable label of the molecule that binds to the label can be a fluorophore or a molecule that catalyzes a reaction, wherein the reaction generates a detectable signal (e.g., a colorimetric reaction). In an illustrative embodiment, the label is biotin and the biotin is detected using streptavidin, wherein the streptavidin is labeled with a fluorophore.

A number of infrared reporters are known in the art and include infrared (IR) and near-infrared (NIR) fluorescent dyes. These reporters include, but are not limited to, naphthalocyanine dyes; cyanine dyes (e.g., Cy3, Cy5, Cy5.5, Cy7); tricarbocyanine dyes (e.g., 1,1′,3,3,3′,3′-Hexamethylindo-tricarbocyanine iodide (HITCI)); heavy-atom-modified tricarbocyanine dyes; near-infrared quantum dots; DY-630; DY-635; DY-680; Atto 565; long-wavelength excitation dyes commercially available from Molecular Probes (Alexa Fluor 633, Alexa Fluor 635, Alexa Fluor 647, Alexa Fluor 660, Alexa Fluor 680, Alexa Fluor 700 and Alexa Fluor 750); long-wavelength excitation dyes commercially available from LI-COR Biosciences (IRDye 680, IRDye 700, IRDye 800); and long-wavelength excitation dyes commercially available from American Dye Source (ADS775 (2-[2-[2-chloro-3-[(1,3-dihydro-1,3,3-trimethyl-2H-indol-2-ylidene)-ethylidene]-1-cyclohexen-1-yl]ethenyl]-1,3,3-trimethylindolium iodide]); ADS780 (2-[2-[2-Chloro-3-[(1,3-dihydro-3,3-dimethyl-1-(2-hydroxy)-ethyl-2H-Indol-2-ylidene)ethylidene]-1-cyclohexen-1-yl]ethenyl]-3,3-dimethyl-1-(2-hydroxy)ethyl-1H-idolium perchlorate); ADS785 (C43H47N2O6S2Na); ADS790 (C44 H52 N3 O6 S3 Na); ADS795 (2-[2-[2-Chloro-3-[2-(3-(4-sulfobutyl)-3H-benzthiazol-2-ylidene)ethylidene]-1-cyclo-hexen-1-yl]-ethenyl]-3-(4-sulfobutyl) enzthiazonium, inner salt, triethylammonium salt); ADS 800 (2-[2-[2-(4-Methylbenzeneoxy)-3-[2-(1,3-dihydro-1,1,3-trimethyl-2H-benz[e]-indol-2-ylidene)ethylidene]-1-cyclohexen-1-yl]-ethenyl]-1,1,3-trimethyl-1H-benz[e]indolium 4-methylbenzenesulfonate); ADS 815 (2-[2-[2-chloro-3-[2-(1,3-dihydro-3,3-dimethyl-1-ethyl-2H-benz[e] indol-2-ylidene)ethylidene]-1-cyclohexen-1-yl]-ethenyl]-3,3-dimethyl-1-ethyl-1H-benz[e]indolium iodide); ADS 830 (2-[2-[2-Chloro-3-[2-(1,3-dihydro-1,1,3-trimethyl-2H-benzo[e]-indol-2-ylidene)-ethylidene]-1-cyclohexen-1-yl]-ethenyl]-1,1,3-trimethyl-1H-benzo[e]indolium-4-methylbenzenesulfonate); ADS 830 (2-[2-[2-Chloro-3-[2-(1,3-dihydro-3,3-dimethyl-1-(4-sulfobutyl)-2H-benz[e]-indol-2-ylidene)-ethylidene]-1-cyclohexen-1-yl]-ethenyl]-3,3-dimethyl-1-(4-sulfobutyl)-1H-benz[e]indolium); ADS 832 (2-[2-[2-(4-aminothiophenyl)-3-[[1,3-dihydro-1,1-dimethyl-3-(4-sulfobutyl)-2H-benz[e]-indol-2-ylidene]ethylidene]-1-cyclohexen-1-yl]ethenyl]-1,1-dimethyl-3-(4-sulfonyl)-, inner salt, sodium salt); ADS845 (Tetrabutylammonium bis(3,6-dichloro-1,2-benzene-dithiolato) nickelate)); ADS870 (Tetrabutylammonium bis(3,4,6-trichloro-1,2-benzene-dithiolato)nickelate); ADS 890 (Tetrabutylammonium bis(4-methyl-1,2-benzenedithiolato)nickelate); ADS900 (C62H96N6SbF6); ADS920 (Bis(4,4′-dimethoxydithiobenzil) nickel); ADS1065 (N,N,N.,N.-Tetrakis(4-dibutylaminophenyl)-p-benzoquinone bis(iminium hexafluoroantimonate)); and/or ADS1075 (C57H48N4SbF6).

In certain aspects, primary antibodies can be used as binding moieties to a microwestern blot. Primary antibodies can include, but are not limited to anti-MEK (Nventa, Ann Arbor, Mich.), anti-ERIK (BD Biosciences, San Jose, Calif.), anti-phospho-ERK, anti-phospho-MEK (Cell Signaling Technology, Danvers, Mass.), anti-Raf-1 (BD Biosciences), anti-HER2, anti-AKT, anti-phospho-AKT, anti-phospho-ERK (Cell Signaling Technology), β-actin (Sigma), anti-CDK4 (Santa Cruz Biotechnology, Santa Cruz, Calif.) and the like. In a further aspect, antibodies directed to a variety of proteins or modified proteins is contemplated, such antibodies include those directed to Abl, Actin, AKT1/2/3, c-jun, c-Raf, CrkII, Crk1, EGFR, Erbb2, ErbB3, ErbB4, Erk(1/2), FAK, GSK3Beta, IkappaB, MEK(1/2), P38alpha Kinase, P70 S6 Kinase, Paxillin, PDK1, p-B-Raf (S445), phospho PKC Beta II, phospho-Abl, phospho-Akt (Ser473), phospho-AKT1/2/3 (T308), phospho-c-Abl, phospho-c-Raf (S259), phospho-c-jun(S63), phospho-CrkII (Y221), phospho-Crk1, phospho-ErbB1(Y845), phospho-ErbB1 (Y992), phospho-ErbB1(Y1068), phospho-ErbB1 (Y1173), phospho-ErbB1(Y1148), phospho-ErbB2 (Y1139), phospho-ErbB2 (1221/1222), phospho-ErbB2 (Y1248), phospho-ErbB3 (Y1289), phospho-ErbB4 (Y1284), phospho-Erk1/2 (P42/44), phospho-Erk6 (P38), phospho-FAK (y925), phospho-GSK3beta (Ser9), phospho-IRS1 (pY1179), phospho-IRS1 (pY896), phospho-Mek(1/2) (s217/221), phospho-NFkB (S536), phospho-p38 MAPK, phospho-p70 S6 Kinase (Thr389), phospho-p90RSK (S380), phospho-Paxillin, phospho-PDK1 (S241), phospho-PI3K(p85), phospho-PKC delta (Ser643)), phospho-PKC epsilon (Ser729), phospho-PKC theta (Thr538), phospho-PKCalpha/betaII (T638/641), phospho-PKCdelta, phospho-PKCdelta (Ser643), phospho-PKCdelta (Y505), phospho-PKCpan (gammaT514), phospho-PKCtheta (T538), phospho-PKCzeta/lambda, phospho-PKD/PKCmu (Ser744), phospho-PKD/PKCmu (Ser916), phospho-PLCgamma1, phospho-PLCgamma2, phospho-PLCgamma2 (Y759), phospho-PTEN (S380), phospho-RSK3 (T356/S360), phospho-SAPK/JNK (T183/Y185), phospho-Shc (Y317), phospho-Src (Y527), phospho-Src (Y239, 240), phospho-Stat1 (Y701), phospho-Stat2 (Y690), phospho-Stat3 (S727), phospho-Stat3 (Tyr705), phospho-Stat5 (Y694), phospho-Stat6 (Y641), phospho-syk (Y323), phospho-syk (Y525), phospho-Zap-70 (Y319)/Syk, phospho-Zap-70 (Y493), PI3K(p85), PKC alpha (C-20), PKC beta I (C-16), PKC beta II (C-18), PKC delta (C-15), PKC epsilon (C-15), PKC eta (C-15), PKC gamma (C-19), PKC iota (N-20), PKC theta (C-18), PKC zeta (C-20), PKCmu, PLCgamma1, PLCgamma2, Raf, SAPK/JNK, Src, Stat 1, Stat3, Stat5, Stat6, and ZAP-70.

Secondary antibodies—Secondary antibodies may be used in the detection of primary antibodies or other binding moieties, such secondary antibodies are typically labeled. In one aspect of the invention the secondary antibodies are labeled with a dye that is queried by laser. Such secondary antibodies include but are not limited to IRDye™ 800 antirabbit IgG, IRDye™ 800 antimouse IgG (Rockland, Gilbertsville, Pa.), Alexa Fluor 680 antimouse IgG, and Alexa Fluoro 680 antirabbit IgG (Invitrogen).

Scanning and Analysis. Typically, as illustrated in the Examples herein, image analysis is performed by scanning a desired area of the gel or blot using a scanner after setting or confirming various parameters. Parameters that are set or confirmed can include, for example, wavelength (e.g., 635 nm), laser power (e.g., 100), pixels size (e.g., 10 μm), lines to average (e.g., 1.0), or focus position. Upon scanning of the gel or blot, an image or a digital representation of the scan is generated and the intensity of spot fluorescence is calculated. One or more targets can be identified by identifying position (i.e., spots) or the presence of binding. A substrate (i.e., a gel or blot) can be scanned using a number of commercially available scanning devices, such as the LI-COR Odyssey Infrared Imaging system. Spot intensity can be quantified using commercially available software packages such as GenePix Pro 8.0.

C. Preparation of Samples

The compositions of the invention can also be used to evaluate sample prepared from different cell types (either morphological or functional), for example, samples derived from cells or cell extracts representing different populations of cells, and comparing the patterns of target-binding moiety interactions. The binding pattern can be compared to known interactions for various different samples. This approach also can be used to characterize, for example, different stages of the cell cycle, disease states, altered physiologic states (e.g., hypoxia), physiological state before or after treatment (e.g., drug treatment), metabolic state, stage of differentiation, developmental stage, response to environmental stimuli (e.g., light, heat), response to environmental toxins (e.g., pesticides, herbicides, pollution), cell-cell interactions, cell-specific protein expression, and disease-specific protein expression or protein modification. Developmental profiles of protein abundance and modification states can be used to characterize signal transduction pathways, metabolic pathways and the like involved at every development stage and elucidate transitions between developmental stages. The information provided by such studies can be used to identify drug targets and/or tailor treatment regimens during the course of a disease.

The compositions and methods of the invention can be used to characterize any cell type, response to a stimulus, or physiological state. Accordingly, in exemplary embodiments, a sample can be prepared from cells treated with a compound (e.g., a drug), or from cells at a particular stage of cell differentiation (e.g., pluripotent), or from cells in a particular metabolic state (e.g., mitotic), and assayed for kinase, protease, glycosidase, actetylase, phosphatase, ubiquitination, prenylation, geranylation, sumoylation, and/or other transferase activity using the appropriate binding moieties. The pattern of target-binding moiety interaction on the gel or blot can provide a “signature” or “fingerprint” characteristic of the biological state. For example, the results obtained from such assays, comparing for example, cells in the presence or absence of a drug, or cells at several differentiation stages, or cells in different metabolic states, can provide a signature of each condition, and can provide information regarding the physiologic changes in the cells under the different conditions or following different perturbations. Such information can be useful for diagnosis, prognosis, drug testing, and drug discovery, for example. Accordingly, the compositions of the invention can be used to determine a drug's interactions with various molecular pathways including those associated with drug toxicity.

Alternatively, compositions of the invention can be used to characterize a drug's effects on complex protein mixtures such as, for example, whole cells, cell extracts, clinical samples (blood, fluid, lymph, sputum, urine, etc.) or tissue homogenates. For example, a gel or blot can be contacted with one or more binding moiety and compared in the presence or absence of drug. The net effect of a drug can thereby be analyzed by evaluating the binding moiety signature of drug-treated cells, tissues, or extracts, which then can provide a baseline for the drug-treated state, and when compared with the signature of the untreated state, can be of predictive value with respect to potency, toxicity, and side effects.

In certain aspects nucleic acids can be separated and analyzed. For example, methods and compositions of the invention can be used to characterize a drug's effects on the activity of proteins in complex mixtures such as, for example, whole cells, cell extracts, clinical samples (blood, fluid, lymph, sputum, urine, etc.) or tissue homogenates. A naturally occurring or a synthetic RNA or DNA molecule can be detected or labeled with an appropriate dye (e.g. an infrared dye) and subsequently incubated with cell lysates corresponding to treatment or no treatment with a drug. A change in migration characteristics of the nucleic acid could then be used to infer a change in activity of a protein in the complex mixture in response to the drug treatment. The net effect of a drug can thereby be analyzed by evaluating the migration characteristics of the nucleic acid from drug-treated cells, tissues, or extracts, which then can provide a baseline for the drug-treated state, and when compared with the signature of the untreated state, can be of predictive value with respect to potency, toxicity, and side effects.

### II. METHODS OF USING MICROBLOTS

A variety of samples can be evaluated using the current invention. Typically, a protein sample is derived or obtained from an organ, a tissue, a cell, a clinical sample, or a cell culture sample. Cells can be prokaryotic or eukaryotic or a mixture thereof. In certain aspect the cells are animal cells, including mammalian cells and human cells. Cells can be from cell lines or primary cells. Primary cells can be isolated directly from a subject, such as from a tissue or fluid sample, such as a biopsy, surgical resection, blood, saliva, urine, etc. The sample may be, but not necessarily, subjected to some level of purification or isolation, each of which are methods well known in the art. Purification or isolation can include, but is not limited to filtration, centrifugation, selective precipitation, dissection (e.g., laser capture microdissection), affinity separation, etc.

Cell fractionation can be used to investigate components of subcellular fractions such as cytosol, nucleus, mitochondria, membranes, cytoskeleton, etc. Fractionation methods include, but are not limited to zonal or gradient centrifugation, selective lysis, filtration, etc.

Compositions of the invention can be used to assay for abundance of essentially all macromolecules, proteins or essentially all protein or other modifications in a cell, tissue, organ, system, or organism (e.g., protein-protein interactions and phosphorylation status). Biological activity can be determined using compositions and methods of the invention include, but are not limited to, enzymatic activity (e.g., kinase activity, protease activity, phosphatase activity, glycosidase activity, glycosylation activity, acetylase activity, methylation activity, prenylation activity, geranylation activity, ubiquitination activity, sumolyation activity, and other chemical group transferring enzymatic activity), nucleic acid binding, hormone binding, etc. High density and small volume reactions can be advantageous. Upon contacting the components of a gel or blot with one or more binding moieties, target-binding moiety interactions can be evaluated.

In certain embodiments, samples from similar or different organisms can be prepared, as well as comparison of samples from different disease states or conditions.

A. Methods for Determining Binding

The invention provides a method for evaluating and/or assessing the binding of a binding moiety to a target protein, including one or more of the following steps: contacting the binding moiety with the target, wherein the target is immobilized on an interrogatable gel or blot as described herein; measuring the signal generated from binding moiety bound to the target; retrieving information associated with the target including the identity, quantity and/or quality information of the target if known; and qualifying and/quantifying the binding of the binding moiety to the target. In certain embodiments, an array may be constructed that is positionally addressable and is screened with a labeled binding moiety under conditions conducive to the binding between the binding moiety and a target. Typically, a sample is associated with information such as identity, location and concentration of the target(s). Binding of the labeled binding moiety to a component on the gel or blot can be detected by any method known to the skilled artisan. Based on the binding, the identity or characteristic of the target can be obtained. Information regarding the identity and quantity of targets on the gel or blot can be retrieved using the information associated with the samples and/or the binding moiety.

A further aspect includes a method for determining the strength, the specificity, and/or the selectivity of an interaction between a target and a binding moiety, or the presence or absence of modification of the target, or characterization of a binding moiety, comprising (a) performing an assay by contacting sample(s) on a gel or blot of the invention with one or more binding moiety to identify or bind a target on the gel or blot; (b) obtaining information regarding the identity, quality and/or quantity of targets on the gel or blot; (c) identifying the target associated with the positive signal using the positional information obtained by comparing the migration distance of a target with that of a known protein molecular weight standard as is common in the art, (d) identifying the abundance and different molecular weights of targets; and (e) evaluating or assessing the interaction of the binding moiety with the target or evaluating the modification state of the target or binding moiety using the identity and characteristics of the samples on the gel or blot.

Methods of the invention include, but are not limited to antibody characterization, drug screening, clinical sample analysis, far-western analysis (i.e., probe target with a binding protein, following by an antibody to the binding protein to detect a protein:protein interaction), evaluating binding of nucleic acid to a target protein and vice versa. In certain embodiments, the sample need not be limited to protein but may include other molecules able to be separated and immobilized in or on a gel or substrate, nucleic acids etc.

### III. KITS

Certain embodiments of the invention provide for kits that can be used to evaluate various protein samples, for example to determine, detect, compare, characterize, etc. the protein composition, activity, or post-translational status of a number of cellular proteins. Such kits allow one to determine if a sample has a different protein level, status, or activity as compared to at least a second protein sample. In certain aspects, a kit can contain components for the preparation of a microwestern blot or a corresponding protein array gel.

The kits may include a protein sample array in the form of a gel and/or a microwestern blot membrane, and/or one or more binding molecules that selectively hybridizes or binds to a molecule of interest. The binding molecules will typically be supplied in an appropriate form, such as at appropriate concentrations, etc. In particular examples, the protein samples are attached to a substrate. In one example, the kit includes probes that recognize modifications of a molecule of interest or abundance of protein(s) of interest, and/or a set of samples for the characterization of one or more binding moiety.

The kit can further include one or more buffer solution, a conjugating solution for developing the signal of interest, or a detection reagent or reporter molecule for detecting target of interest. Each component may be in separate packaging, such as a container. In another example, the kit includes a plurality of binding moieties to serve as positive and/or negative controls.

In another aspect, a kit may include a blot or gel including one or more samples, the blot or gel can include at least 1, 2, 3, 4, 5, 6, 7, 8, 9, 10, 11, 12, 13, 14, 15, 16, 17, 18, 19, 20 or more electrophoretically separated samples, which may include a control protein sample that is different than the test protein samples. The control protein sample may include or exclude a known target that binds to a detectable control binding moiety. In certain aspects, the test protein microarray includes at least 25, 50, 75, 100, 1000, 5000, 10,000, or 20,000 different samples. In certain examples, a binding moiety is labeled with a detectable label, interacts with a second binding moiety that is labeled, or may even be directly detectable. In one illustrative aspect, a kit may include gels or blots comprising electrophoretically separated samples, or materials to produce such a gel or blot, and a variety of reagents to evaluate one or more biological pathways or proteins. The reagents can include a variety of binding moieties and/or detection labels or molecules as well as any buffers or solution necessary for evaluating or producing an array of the current invention.

### IV. EXAMPLES

The following examples are given for the purpose of illustrating various embodiments of the invention and are not meant to limit the present invention in any fashion. One skilled in the art will appreciate readily that the present invention is well adapted to carry out the objects and obtain the ends and advantages mentioned, as well as those objects, ends and advantages inherent herein. The present examples, along with the methods described herein are presently representative of preferred embodiments, are exemplary, and are not intended as limitations on the scope of the invention. Changes therein and other uses which are encompassed within the spirit of the invention as defined by the scope of the claims will occur to those skilled in the art.

### Example 1

Cell culture. A431 cells are a gift from Dr. Shutsung Liao. A431 were maintained and cultured in Dulbecco's Modified Eagle Medium (DMEM) (Mediatech, Herndon, Va.) supplemented with 8% fetal bovine serum (FBS) (Atlas, Fort Collins, Colo.), 50 I.U. penicillin, and 50 μg/ml streptomycin (Cellgro, Mediatech). Cells were grown to 50% confluent, trypsinized, and seeded, 5×10⁵ cells per 10 cm plate, in DMEM+8% FBS medium on Day 1. On Day 2, medium was removed, washed with cold PBS, and then changed to DMEM without serum for a 48 hr serum starvation. On Day 4, media was replaced with serum-free DMEM containing 200 ng/ml human recombinant Epidermal Growth Factor (EGF) (Upstate, Temecula, Calif.) and lysates collected at minutes 0, 1, 5, 10, 30, and 60. Plates were then washed with cold PBS twice and lysed with 0.4 ml of 2% SDS lysis buffer (240 mM Tris-acetate, 2% SDS, 5% glycerol, 5 mM EDTA pH 8.0, 10 mM β-GP, 1 mM PMSF, 1 mM Na3VO4, 1 mM aprotinin, and 1 mM leupeptin) on nutator in cold room for 30 min. Cell lysates were then denatured with 200 mM DTT, boiled for 8 min and stored in −20° C. Cell lysate was spun down before use.

EGF stimulation. A431, HeLa, HMEC A1-1, and HMEC A1-HER2 cells were grown to 50% confluent, trypsinized, and seeded at 3×10⁵ cells per 6 cm plate in regular medium on Day 1. On Day 2, medium was removed, washed with cold PBS, and then changed to medium containing no serum (DMEM or Medium 171) for a 24 hr serum starvation. On Day 3, medium was removed and replaced with medium (DMEM or Medium 171) containing 200 ng/ml human recombinant Epidermal Growth Factor (EGF) (Upstate, Temecula, Calif.) but without serum for 0, 1, 5, 10, 30, 60, 120, or 240 min for EGF stimulation. Plates were then quickly washed with cold PBS twice and lysed with 0.4 ml of 2% SDS lysis buffer (50 mM Tris-HCL, 2% SDS, 5% glycerol, 5 mM EDTA, 1 mM NaF, 10 mM β-GP, 1 mM PMSF, 1 mM Na3VO4, 1 mM aprotinin, and 1 mM leupeptin) on ice for 30 min. Before MicroWestern blotting, cell lysates were add with 1 mM DTT, boiled for 10 min, and spun down.

Polyacrylamide Gels. A 24 cm×11 cm 10% tris-acetate gel (0.24 M Tris-Acetate pH 6.8, 0.1% SDS, and 20% v/v glycerol) for SDS-PAGE was poured at a thickness of 0.4 mm. A nylon mesh fabric with an acryl-linker was incorporated into the gel matrix during polymerization (Net-Fix® for PAG, Serva 42775). After polymerization, the gel was divided into two, and a single 12 cm×11 cm gel was loaded on to the arraying platform of the GeSim Noncontact Arrayer.

Lysate Printing. The chamber of the Arrayer was held at a constant 80% humidity during printing. Lysate samples were transferred from a 386 well plate to the gel with an automated transfer file (Software: GeSim NPC16). Samples were arrayed in an 8×12 block format with up to 12 unique samples loaded per block with a separation of 1.0 mm between each sample. The transfer file specified 20 consecutive drops of lysate per location per run with each drop having approximately 300 pL of sample. The transfer configuration was repeated nine times, causing the spots to be overlayed on the gel, increasing the local density of protein per area, giving a total volume of lysate of 54 mL per block and 5.2 μL for the entire 96-block microwestern. Total printing per gel took approximately 4 hours.

Electrophoresis. After completion of printing, the gel was incubated in Rehydration Buffer (0.40 M Tris-acetate pH 6.8, 20% Glycerol, 0.1% SDS, 1:20 DTT, 1:20 Sodium Bisulfite) for five minutes. After rehydration, the gel was placed on the Genephor Horizontal Electrophoresis System (GE Healthcare) on a plastic backing (Gel-fix® for Covers, Serva 42957) for support. Contact between the lateral edges of the gel and the electrodes were maintained with blotting paper wetted in electrode buffer (0.480 M Tris-acetate buffer pH 6.8, 0.1% SDS). Electrophoresis was run at a constant 350V and 30 W until loading dye had migrated a net 0.9 cm (approximately 15 min).

Probing. The lysates were transferred for 1 hr onto nitrocellulose membrane using the Biorad Criterion transfer tank. The blot was blocked in 100% Li-cor Odyssey Blocking Buffer (Li-cor 927-40000) for more than two hours. The membrane was then placed in a 96-well sealed gasket (The Gel Company AHT96-01) with each transferred block aligned within a single gasket well. 200 μL of each pre-diluted primary antibody (using Licor Buffer with 0.1% Tween-20) was placed in a defined well of the 96 well gasketing device. The plate was incubated at 4° C. overnight. The primary antibody was washed five times with TBST for five minutes within the gasket using a multichannel pipetter. Anti-mouse Invitrogen Alexa-fluor 680 (1:5000) and/or Anti-rabbit Invitrogen Alexa-fluor 680 (1:5000) fluorescent conjugated secondary antibody diluted in Licor Buffer was added to each well depending on the identity of the primary antibody. The blot was incubated with secondary for 1 hr with minimal agitation. The blot was washed with TBST four times with the gasket attached and once in TBS with the gasket removed. The blot was thoroughly dehydrated before scanning.

Scanning and Analysis. The blot was scanned with the Licor Odyssey Infrared Imaging system at 42 μm resolution and High Quality at a Laser Intensity of 1.5. Spot intensity was quantified with GenePix Pro 8.0. Total Intensity of Bands was subtracted from the background intensity value of each microwestern block. Median fluorescent intensities were normalized by dividing by the median intensity of the average of GADPH, beta-actin, and alpha-tubulin control spots. The normalized intensities were divided by the normalized intensity at time zero and subtracted by one to give fold change. Single graphs were generated using Origin 7.5 and serial graphs, heatmaps, and clustergrams were generated using Matlab 2006a. Clustering was performed using the k-means algorithm with a predefined bin number of 13 and the distance measured as the squared Euclidean distance between activation profiles. Activation profiles were normalized prior to clustering by dividing by the standard deviation of all point fold changes along time and concentration dimensions of a single antibody band to compare shape of activation kinetics while minimizing clustering based on amplitudes.

1. A microwestern blot comprising one or more samples electrophoretically resolved to a resolution of 5 kDa per 200 μm.

2. The microwestern blot of claim 1, wherein the sample is a protein sample.

3. The blot of claim 2, wherein the microwestern blot comprises at least 20 protein samples.

4. (canceled)

5. The blot of claim 2, wherein two or more protein samples are grouped in a sample block.

6. (canceled)

7. (canceled)

8. The blot of claim 1, wherein the samples are arranged linearly in a direction perpendicular to the direction of electrophoresis at a density of 9 protein samples per centimeter.

9.-12. (canceled)

13. The blot of claim 1, further comprising a gasket dividing the microwestern blot into discrete wells.

14.-16. (canceled)

17. A substrate having an arrangement of samples comprising at least a first sample forming a first sample row and second sample forming a second sample row, wherein the first sample row and second sample row are parallel with respect to each other and perpendicular with respect to electrophoretic separation.

18. The substrate of claim 17, wherein the sample is a protein sample.

19. The substrate of claim 17, wherein the samples are operably coupled to the substrate.

20. The substrate of claim 19, wherein the substrate is a membrane.

21. The substrate of claim 20, further comprising a device fluidically isolating one or more samples on the substrate.

22. The substrate of claim 19, wherein the substrate is an electrophoretic gel.

23. The substrate of claim 17, wherein the sample is replicated at least 12, 24, 48, or 96 times.

24. The substrate of claim 17, wherein proteins are electrophoretically resolved to a resolution of 5 kDa per 200 μm.

25.-27. (canceled)

28. The substrate of claim 17, further comprising a gasket dividing the substrate into discrete wells.

29. The substrate of claim 28, wherein one well defines a block of sample lanes.

30. (canceled)

31. An electrophoretic gel comprising at least one protein sample electrophoretically separated in a first direction at a resolution of 5 kDa per 200 μm.

32. An electrophoretic gel comprising at least two protein samples electrophoretically separated in a first direction, wherein a first sample is positioned above the second sample with respect to the direction of electrophoretic migration.

33. A method of evaluating a protein sample comprising the steps of:
(a) obtaining a substrate having at least one protein sample electrophoretically resolved to a resolution of 5 kDa per 200 μm;
(b) dividing the substrate into discrete wells;
(c) contacting a portion of the substrate defined by a well with a binding moiety of interest; and
(d) analyzing the binding of the binding moiety to the protein sample.

34. The method of claim 33, wherein the binding moiety is an antibody.

35. (canceled)

36. (canceled)

37. The method of claim 33, further comprising selecting one or more binding moieties having an appropriate binding profile or specificity.

38. A method of preparing a microgel comprising the steps of
(a) obtaining a protein sample;
(b) spotting at least 300 pL of the protein sample on a separation medium; and
(c) separating the protein sample in a first direction to a resolution of at least 5 kDa per 200 μm forming a microgel.

39. The method of claim 38, further comprising transferring the separated sample to a second substrate producing a microwestern blot.

40. The method of claim 38, wherein spotting is performed at 70 to 90% humidity.

41. (canceled)

42. The method of claim 38, wherein spotting comprises applying 2 to 20 drops of protein sample at a first location on the separation medium.

43. The method of claim 42, wherein the spotting is repeated 2, 3, 4, 5, 6, 7, 8, 9 or more times.

44. (canceled)

45. (canceled)
